(19) United States
(12) Patent Application Publication
(10) Pub. No.: US 2026/0009140 A1
(43) Pub. Date: Jan. 8, 2026

(54) DEVICE FOR COATING A CARRIER SUBSTRATE WITH A POWDERED MATERIAL

(71) Applicant: KOENIG & BAUER AG, Würzburg (DE)

(72) Inventors: Stefan BAUER, Thüngersheim (DE); Björn KRIEGE, Veitshöchheim (DE); Stefan MEINING, Birkenfeld (DE)

(21) Appl. No.: 19/117,199

(22) PCT Filed: Oct. 24, 2023
(86) PCT No.: PCT/EP2023/079568

§ 371 Date: Mar. 31, 2025

(30) Foreign Application Priority Data
Jan. 13, 2023 (DE) 10 2023 100 771.8
Mar. 7, 2023 (DE) 10 2023 105 523.2
Sep. 1, 2023 (WO) PCT/EP2023/073992

(51) Int. Cl. C23C 24/06

(52) U.S. Cl. CPC C23C 24/06

(57) ABSTRACT

Examples relate to a device including an application unit having a first roller and second roller forming, in a nip thereof, a first roller gap through which powdered material can be conveyed to form a dry film. A counter-pressure roller together with the second roller, or a further roller downstream from the second roller, forms a second roller gap. A substrate path leads through the second roller gap for guiding a carrier substrate web through the second gap for applying the dry film thereto. At least one drawing device including a drive means for adjusting the first or second roller gap between two adjacent rollers that are movable relative to one another is provided on each frame side, enabling the two rollers to be moved toward one another in an adjustment direction, or be tensioned, and to be moved away from one another again, or at least be relaxed.

### CROSS-REFERENCES TO RELATED APPLICATIONS

This application is the US national phase, under 35 USC § 371, of PCT/EP2023/079568, filed on Oct. 24, 2023, published as WO 2024/149484 A1 on Jul. 18, 2024, and claiming priority to DE 10 2023 100 771.8 filed on Jan. 13, 2023, DE 10 2023 105 523.2 filed on Mar. 7, 2023, and PCT/EP2023/073992 filed on Sep. 1, 2023, and all of which are incorporated by reference herein in their entireties.

### TECHNICAL FIELD

Some examples herein relate to a device for coating, in particular dry coating, a carrier substrate with a powdered material. For example, the device may include at least one application unit, which comprises a first roller and a second roller forming, in the nip between the outer cylindrical surfaces thereof, a first roller gap used for forming the film, through which powdered material can be conveyed so as to form a first dry film. Additionally a roller that is effective as a counter-pressure roller, which, together with the second roller or a further roller following directly or indirectly downstream from the second roller, viewed in the direction of the material stream, forms a second roller gap, with a substrate path that leads through the second roller gap being provided, on which, during operation, a carrier substrate web to be coated can be guided and have the dry film formed in the first roller gap applied thereto on a first side.

### BACKGROUND

In WO 2020/150254 A1 and WO 2020/148410 A2 relating to the same family, a film is generated by calendering a powder mixture and is wound onto a reel so as to be supplied as such to a further process in which it can be laminated onto a collector. In one embodiment, the powder mixture is deposited onto a belt and is compressed thereon, in a first roller gap between a first and a second roller, to form a dry film, and this dry film is then applied to a carrier substrate in a second roller gap between the second and a further roller. Additionally, an embodiment of a laminator comprising two rollers forming a laminating gap between one another is disclosed, which in one variant of the aforementioned embodiment can replace the two inner rollers forming the roller gap. The laminator comprises lamination actuators, designed as pressure cylinders, for pressing the rollers against one another and gap control actuators designed as pressure cylinders, which apply a force that is equally as high, but opposes the pressing force so as to maintain the gap width when non-coated areas are being processed.

A device for dry coating a current collector web with an active material layer is disclosed by KR 102359521 B1, wherein a first roller and a second roller are provided for each side of the web, between which an active material layer is formed, and wherein the respective active material layer is applied onto the current collector web at a nip point between the two second rollers. A first and a second unit for setting the roller spacing are provided, by which the respective distances between the first and second rollers can be set. The first and second units comprise a mechanical cylinder that is driven by a servo motor. Furthermore, a third unit for adjusting the roller nip formed between the second rollers is provided. It is stated that, in this way, the thickness of the electrode can be easily controlled by way of the gap width. In one embodiment, furthermore an air cylinder can be provided between the second rollers, the air cylinder keeping the spacing constant.

DE 10 2008 009 341 A1 relates to grinding, mixing, dispersing, homogenizing or the like liquid to paste-like masses in a roller train comprising multiple rollers that are each supported on two end faces in bearing seats, wherein the mass is successively transported from a first roller to a last roller, this being a removal roller, and there is removed by a scraper. The distance or the engagement of two outer rollers of three rollers with respect to a center roller can be varied by pivoting of the bearing seats. The bearing seats at the end faces of at least one of the rollers are designed so as to be adjustable transversely to the roller axis independently of one another by respective eccentric bearings in such a way that a position that is in a crossed arrangement in relation to the other roller can be set by deflecting the eccentrics in opposite directions.

### SUMMARY

It is an object of examples herein to create a device for coating, in particular dry coating, a carrier substrate with a powdered material.

The object is achieved in some examples by the device described above, and in which at least one drawing device comprising a drive means is provided on each frame side for adjusting the roller gap between the adjacent first and second rollers arranged so as to be movable relative to one another, by way of which the two rollers can be moved toward one another in the adjustment direction, or be tensioned, and can be moved away from one another again, or at least be relaxed again. The drawing device comprising the drive means engages with the two active ends thereof on the first and second rollers so as to apply adjustment forces that are directed toward one another to the first and second rollers for adjusting the gap between the same. The first gap between the first and second rollers can be adjusted by the drawing device in a position-based manner, that is, toward a constant and/or defined gap width.

The advantages achievable by the invention are in particular that a coated carrier substrate, comprising an active material layer that is as even as possible and/or defined, can be reliably produced by the device.

In an embodiment that is particularly suitable for the invention for such a device for coating, in particular dry coating, a carrier substrate with a powdered material, this device comprises at least one first application unit, which comprises a first roller and a second roller forming, in the nip between the outer cylindrical surfaces thereof, a first gap used for forming the film, through which powdered material can be conveyed so as to form a first dry film, and a roller that is effective as a counter-pressure roller, which, together with the second roller or a further roller of the first application unit following directly or indirectly downstream from the second roller, viewed in the direction of the material stream, forms a second gap through which a carrier substrate to be coated can be guided and can have the dry film that is formed in the first gap and in particular transported via the second roller, and optionally the further roller, to the second gap applied thereto.

According to the invention, at least one drawing device comprising a drive means for adjusting the roller gap between two adjacent rollers, which are arranged so as to be movable relative to one another, is provided on each frame side, by way of which the two rollers can be moved toward one another in the adjustment direction or be tensioned, and can be moved away from one another again or at least be relaxed again.

The adjustment device comprising the drive means preferably engages with the two active ends thereof on the first and second rollers so as to apply adjustment forces that are directed toward one another thereto for adjusting the gap between the first and second rollers.

In a preferred embodiment, a cylinder-piston system that can be acted on by pressurized fluid is provided as the drive means. In an advantageous embodiment, this system is supplied or can be supplied with pressurized fluid via a positioning means that is fluidically connected to the cylinder-piston system from a pressurized fluid source that, on the input side, is connected to the positioning means, the pressurized fluid source providing and/or being able to provide pressurized fluid having a pressure of at least 100 bar or 10 MPa.

In an advantageous embodiment, means for an emergency shutdown are provided, by way of which a depressurization of the pressurized medium supply of the cylinder-piston system or a switching to an operating mode that effectuates a shut-off is or can be effectuated.

The first gap between the first and second rollers can preferably be adjusted in a position-based manner, that is, can be adjusted toward a constant and/or defined gap width, by an adjustment device.

In an advantageous refinement, the rollers forming the respective or relevant gap between one another are each mounted on both sides in frame walls of differing frame sections, wherein each of the adjustment devices engages on the frame walls of the two rollers forming the relevant gap between one another.

In an advantageous embodiment, the roller that is effective as a counter-pressure roller, serving as a laminating roller, is at the same time designed as part of a second application unit located on the other side of the substrate path, which comprises a first roller of the second application unit that, together with the laminating roller effective as a counter-pressure roller or with a further roller of the second application unit located therebetween, forms a first roller gap of the second application unit through which powdered material can be conveyed so as to form a second dry film, which, in the second roller gap, can be applied to the second side of the carrier substrate, which during operation is guided through the second gap via the transport path, via the laminating roller of the second application unit.

Further advantageous embodiments and refinements can be derived individually or in combinations from the claims and the following description.

### BRIEF DESCRIPTION OF THE DRAWINGS

Exemplary embodiments of the invention are illustrated in the drawings and will be described in greater detail below. The figures show:

FIG. 1 a schematic representation of a product to be produced;

FIG. 2 a schematic diagram for the generation and the application of a dry film;

FIG. 3 an exemplary embodiment of a machine for producing a multi-layer product including a dry film that is applied to a carrier substrate with an application stage according to one embodiment of a first group of exemplary embodiments;

FIG. 4 an enlarged view of the application stage of the first embodiment from FIG. 3;

FIG. 5 an alternative embodiment of one embodiment of the first group of exemplary embodiments;

FIG. 6 a further alternative embodiment of the embodiment of a first group of exemplary embodiments;

FIG. 7 a further alternative embodiment of the embodiment of a first group of exemplary embodiments;

FIG. 8 a schematic diagram of one embodiment of a second group of exemplary embodiments;

FIG. 9 a schematic diagram of a further embodiment of a second group of exemplary embodiments;

FIG. 10 an exemplary embodiment of a machine for producing a multi-layer product including a dry film that is applied to a carrier substrate with an application stage according to one embodiment of the second group of exemplary embodiments;

FIG. 11 an enlarged view of the application stage from FIG. 10 with the coupling of two rollers in pairs in a first design;

FIG. 12 an enlarged view of the application stage from FIG. 10 with the coupling of two rollers in pairs in a second design;

FIG. 13 a representation obliquely from beneath with removal devices;

FIG. 14 an oblique view of a product section having a slight lateral primer protrusion;

FIG. 15 another exemplary embodiment of a machine for producing a multi-layer product including a dry film that is applied to a carrier substrate with an application stage according to one embodiment of the second group of exemplary embodiments;

FIG. 16 another exemplary embodiment of a machine for producing a multi-layer product including a dry film that is applied to a carrier substrate with an application stage according to one embodiment of the second group of exemplary embodiments;

FIG. 17 another exemplary embodiment of a machine for producing a multi-layer product including a dry film that is applied to a carrier substrate with an application stage according to one embodiment of the second group of exemplary embodiments;

FIG. 18 a perspective representation of an exemplary embodiment of an application unit, in particular double application unit, comprising a multi-piece frame;

FIG. 19 a sectional illustration of an exemplary embodiment of an application unit according to FIG. 18, in particular double application unit, comprising a multi-piece frame;

FIG. 20 a sectional illustration through a frame section of a multi-piece frame;

FIG. 21 a schematic sectional illustration through a bearing region of a frame section;

FIG. 22 a sectional illustration through a frame section comprising stop means for delimiting the throw-on movement;

FIG. 23 a schematic diagram of two rollers having axes of rotation that are inclined with respect to one another;

FIG. 24 a front view of a frame section having a mount that allows pivoting;

FIG. 25 a sectional illustration of an alternative embodiment of an application unit, in particular double application unit, comprising a multi-piece frame;

FIG. 26 a schematic representation of an exemplary embodiment of a closed control loop controlling the gap width of the film-forming gap, comprising a final control element formed by a multi-way valve a) in a side view and b) in a top view onto a part of the application unit;

FIG. 27 a schematic representation of a multi-way valve;

FIG. 28 a schematic representation of an exemplary embodiment of a closed control loop controlling the gap width of the film forming gap, comprising a positioning means formed by a pump a) in a side view and b) in a top view onto a part of the application unit;

FIG. 29 a schematic representation of an application unit comprising a closed control loop for controlling the gap width;

FIG. 30 a schematic representation of an application unit comprising a closed control loop for control based on the layer thickness;

FIG. 31 a schematic representation of an application unit comprising an alternative closed control loop for control based on the layer thickness;

FIG. 32 a schematic representation of an application unit comprising a further alternative closed control loop for control based on the layer thickness;

FIG. 33 a schematic representation of an application unit comprising a closed control loop for control based on the grammage; and

FIG. 34 a schematic representation of an application unit comprising an alternative closed control loop for control based on the grammage.

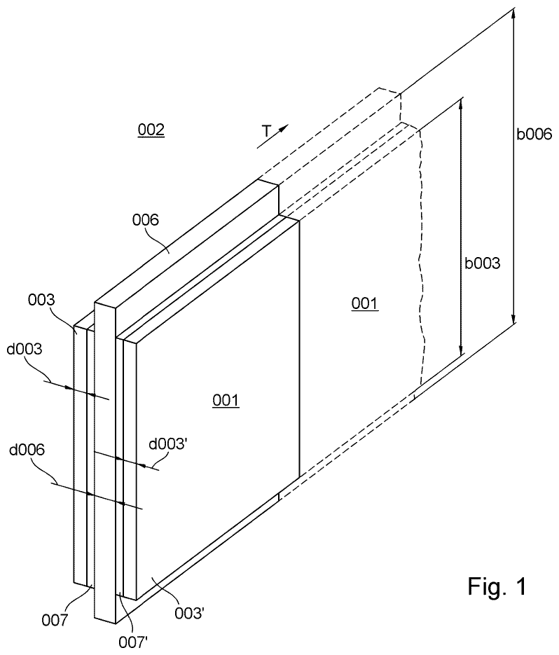

### DETAILED DESCRIPTION

The devices or machines described hereafter relate to the production of electrode units 001 of electrochemical storage systems as they are used, in particular, in batteries or rechargeable batteries, such as lithium-sulfur, sodium-ion or in particular lithium-ion batteries, as well as in solid-state batteries.

A product 001; 002 to be produced by a machine described below can, for example, be formed by a, for example web-format, intermediate product 002 that is still to be cut, for example a product strand 002 designed as an electrode strand 002, or by sheet-format end products 001 that have already been cut in the machine, for example as product sections 001 formed as electrode units 001, electrodes 001 for short.

For producing such products 001; 002 having a material layer 003; 003′, in particular active material layer 003; 003′, which is applied to one side or both sides of a carrier substrate 006, preferably a carrier substrate web 006, for example a current collector substrate 006 formed by, for example, a current collector foil 006, preferably applied in the form of a dry film 003; 003′, a device 100; 100* for coating, coating device 100; 100* for short, in particular for dry coating an, in particular web-format, for example above-described, carrier substrate 006 with an above-described material layer 003; 003′, preferably a dry film 003; 003′, in particular a powder composite film 003, is provided, which comprises at least one first application unit 101, by which powdered, preferably dry, material 004; 004′, in particular a preferably solvent-free and/or dry powder mixture 004; 004′ can first be processed to a dry film 003, in particular by way of compression and/or using a compression force, and thereafter this dry film 003; 003′ can be applied to a first side of the carrier substrate 006, in particular by way of pressing and/or using a contact pressure force. A dry film 003; 003′ to be applied is to have, for example, a thickness of 20 μm to 240 μm, preferably of 40 μm to 100 μm, for example after the application and compression.

An above-described powder mixture 004; 004′, which is in particular present as dry powder, comprises, in particular for the production of electrode units 001 for lithium-ion batteries or rechargeable batteries, for example more than ninety percent by weight of an active material, such as one or more of the lithium compounds: lithium iron phosphate, lithium manganese oxide, nickel-rich lithium nickel manganese cobalt oxide, lithium nickel cobalt aluminum oxide, lithium cobalt oxide, lithium manganese nickel oxide and/or lithium titanate, few, for example three, percent by weight of a conductive additive, for example graphite or so-called CNTs, that is, multi-walled carbon nanotubes, and few, for example two, percent by weight of a plastic that is effective as binding agent in the later powder composite, for example polytetrafluoroethylene (PTFE).

The carrier substrate 006 at the same time, for example, represents the current-collecting layer of the electrode unit 001 and is formed, for example, by electrically conductive material, for example a metal, designed in the form of a film, non-woven fabric or woven fabric. It is made, for example, of aluminum or copper, in particular for the production of electrode units 001 for lithium-ion batteries or rechargeable batteries, and/or, for example, has a thickness d006 of 5 to 16 μm. If an anode is produced, it is made in particular of copper having, for example, a thickness d006, for example, in the range of 5 to 13 μm, and if a cathode is produced, it is made in particular of aluminum having, for example, a thickness d006 in the range of 7 to 16 μm.

In a preferred embodiment, the carrier substrate 006, at least in the surface region to be coated with the dry film 003; 003′, has a superficial coating with a cohesion-supporting or cohesion-inducing agent 007; 007′, for example a binder 007; 007′, a primer 007; 007′ or an adhesive 007; 007′. Such an agent 007; 007′ can be formed by a thermoplastic or reactive binder or primer and can, for example, comprise a thermoplastic component and/or have a thickness d007 of only few μm, for example no more than 5 μm, in particular no more than 3 μm.

A thickness d003; d003′ of the active material layer 003; 003′ of the product 001; 002, that is, of the electrode unit 001 or of the electrode strand 002, is, for example, no more than 240 μm, in particular no more than 150 μm, preferably at most 100 μm, and/or is, for example, at least 20 μm, in particular at least 30 μm, preferably at least 40 μm. For example, after passing through a calendering process that follows the application or coating of the carrier substrate 006 with the dry film 003, 003′ inline or in a further machine, an overall thickness of the product 001; 002 coated, for example, on both sides, is, for example, up to 500 μm, in particular up to 320 μm, preferably up to 220 μm and/or at least 50 μm, in particular at least 70 μm, preferably at least 90 μm. A density of the applied material 004, 004′ is, for example, greater than 3000 kg/m³, preferably greater than 3500 kg/m³. An intermediate product 002, which is also referred to here, for example, as a pre-product, leaving the machine for pure coating, that is, without subsequent calendering, can optionally have a lesser density, however, for example, of at least 2000 kg/m³, preferably of at least 2500 kg/m², in particular of at least 2900 kg/m³. When only one side is coated, the overall thickness of the finished product 001; 002, which is optionally further compacted by at least one calendering process, is, for example, up to 255 μm, in particular up to 165 μm, preferably up to 65 μm and/or at least 30 μm, in particular at least 40 μm, preferably at least 50 μm.

If sufficiently large forces are available during the coating process or simultaneously with the application of the dry film 003, 003′ or if such forces can be applied in the laminating gap, the above-described values for the total thickness and/or the density of the end product 001 or of the intermediate product 002 only to still be cut transversely, for example, can also be achieved without subsequent calendering provided downstream from the coating process.

To ensure an effective manufacturing process, preferably web-format carrier material 006 is processed to an above-described end or intermediate product which, for example, has a width b006 of at least 300 mm, advantageously at least 500 mm, in particular at least 550 mm, or even 600 mm and more, in an advantageous embodiment even up to 1,200 mm. The carrier material 006 is, for example, not coated over the entire width with the dry film 003; 003′, but only up to an omitted edge region in which the surface of the metallic conducting carrier material 006 remains clear and accessible, for example for the purpose of being connected to cables. Such a width b003 of the coating is, for example, at least 200 mm, advantageously at least 230 mm, or even 300 mm and more.

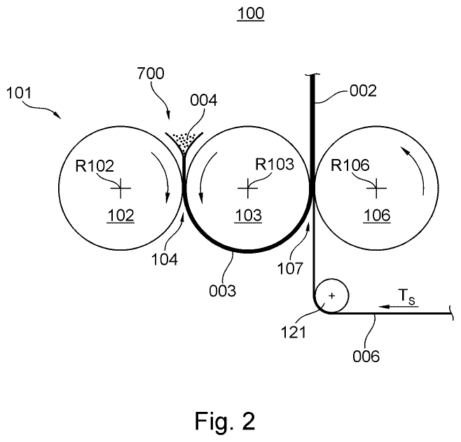

For the above-described production of a dry film 003, a first roller 102, in particular a metering roller 102, and a second roller 103, in particular a laminating roller 103 of the first application unit 101, are provided so as to form, in the nip between the outer cylindrical surfaces thereof, a first gap 104, in particular a first film-forming gap 104, through which, for the purpose of forming the dry film 003, the powder mixture 004 which is conveyed into the nip, for example by a device for feeding powdered material 700, a powder feed device 700 for short, can be conveyed (see, for example, FIG. 2). An inside width of the first gap 104 at the narrowest point thereof determines the thickness of the dry film 003, which may still be larger compared to the thickness in the later product 001; 002, even before the same passes an application point at which it is applied, in particular under pressure, to the carrier substrate 006.

The application point here is preferably formed directly by a nip of the second roller 103, which in this case is effective as a laminating roller 103, with a roller 106; 103 that is effective as a counter-pressure roller 106; 103′ or by a roller which cooperates with the second roller directly or indirectly via one or more further rollers and which is effective as a laminating roller, with a roller 106; 103 that is effective as a counter-pressure roller 106; 103′ (not shown here). The second or further roller effective as the laminating roller 003 and the roller 106; 103 effective as the counter-pressure roller 106; 103 form, in the nip between the outer cylindrical surfaces thereof, a second gap 107, in particular an application gap 107, hereafter also, for example, referred to as a laminating gap 107, through which the carrier substrate 006 can be guided, to which, in particular from the side facing away from the counter-pressure roller 106; 103, the dry film 003 which is formed via the first film-forming gap 104 and, for example, is at least 40 μm thick, for example between 50 μm and 200 μm, in particular 60 to 120 μm thick, can be applied.

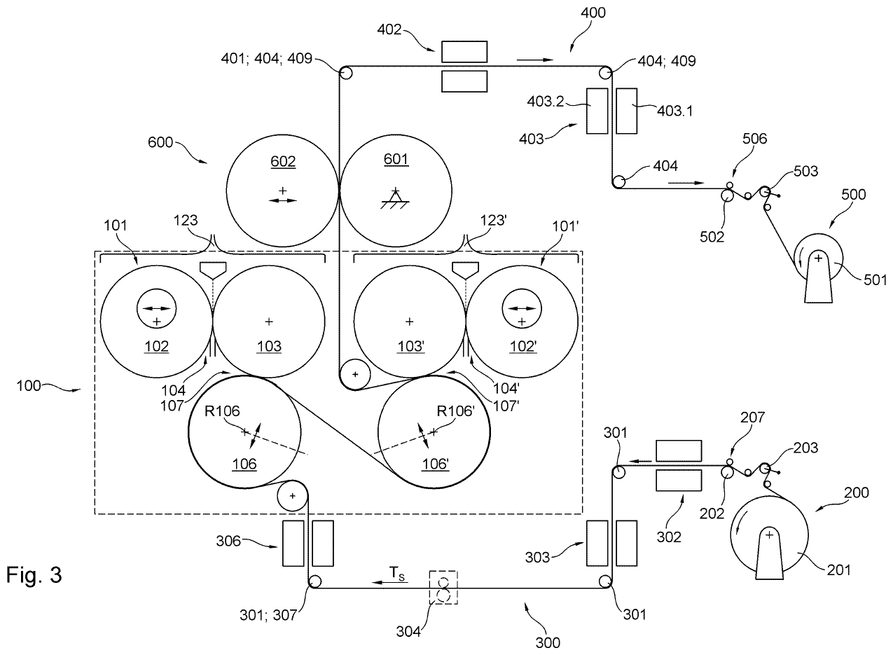

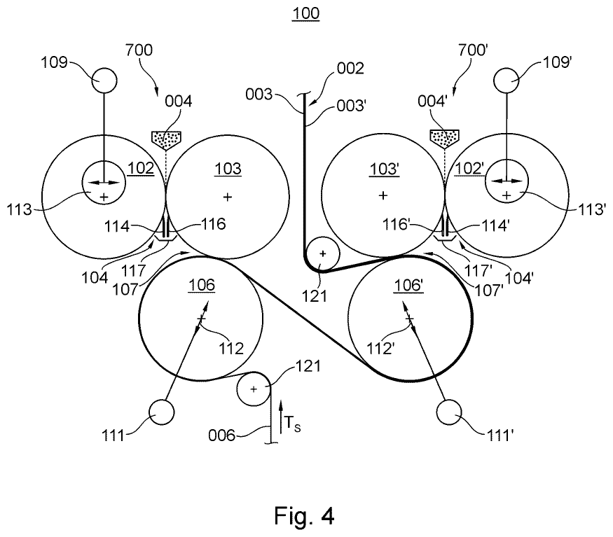

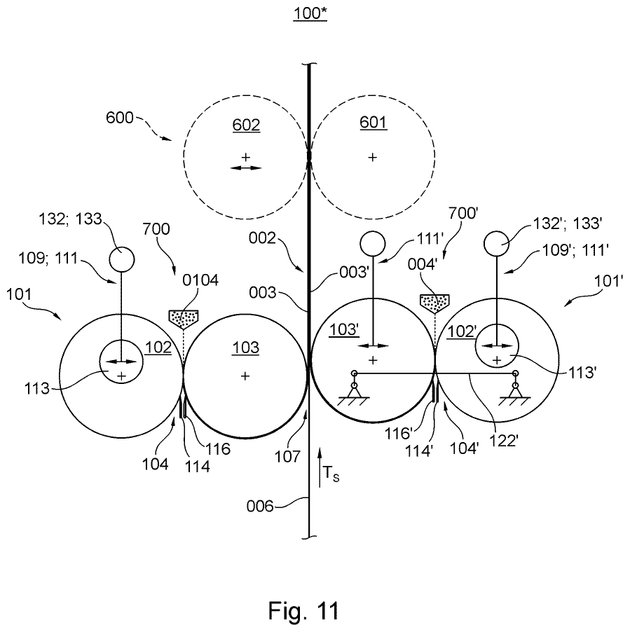

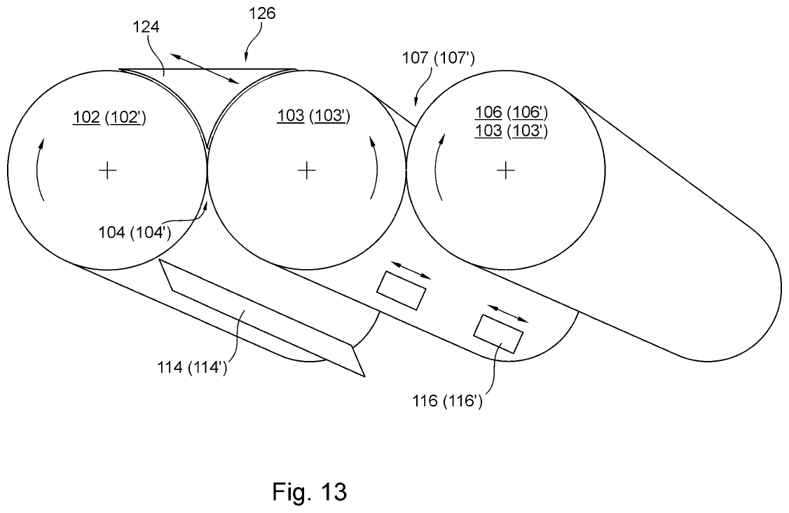

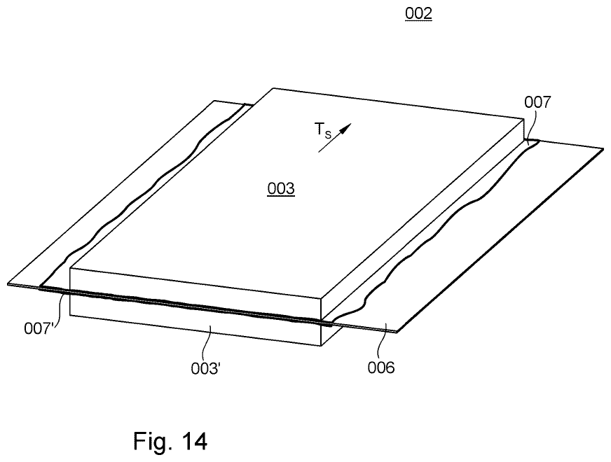

In a preferred embodiment, the application stage 100; 100* comprises a second application unit 101′ (see, for example, FIG. 3 to FIG. 13), by which likewise an, in particular solvent-free and/or dry, powder mixture 004′, which is conveyed, for example, by a second device for feeding powdered material 700′, powder feed device 700′ for short, into the nip, can first be processed to a second dry film 003′; 003, in particular by way of compression and/or using a compression force, and thereafter this second dry film 003′; 003 can be applied to the other, second side of the carrier substrate 006, in particular by way of pressing and/or using a contact pressure force. This can generally be the same powder mixture 004′ or a powder mixture that differs from the first powder mixture 004′.

A first roller 102′, in particular metering roller 102′, and a second roller 103′, in particular laminating roller 103′, are also preferably provided in the second application unit 101′ so as to form, in the nip between the outer cylindrical surfaces thereof, a first gap 104′, in particular a second film-forming gap 104′, through which the powder mixture 004′ can be conveyed for forming the second dry film 003′.

Here as well, the second roller 003′ of the second application unit 101′ directly, or a roller (not shown here) which cooperates with the second roller 103′ directly or indirectly via one or more further rollers and is effective as a laminating roller, in the nip between the outer cylindrical surfaces, can form a gap 107′; gap 107 with a roller 106′; 103 that is effective as the counter-pressure roller 106′; 103, through which the carrier substrate 006 can be guided and have the second dry film 003′ formed via the second film-forming gap 104′; 104 applied thereto, in particular on the second side facing away from the second counter-pressure roller 106′; 103.

In a first group of exemplary embodiments for the coating device 100 (see, for example, FIG. 3 to FIG. 7), a second gap 107′ is formed by a second application gap 107′, for example laminating gap 107′, which differs from the first application or laminating gap 107′, with a second roller 106′, which is in particular effective as a counter-pressure roller 106 and effective second counter-pressure roller 106′ that differs from the first counter-pressure roller 106 and/or from the laminating roller 103 of the first application unit 101, through which the carrier substrate 006 can be guided and have the second dry film 003′ formed via the second film-forming gap 104′ applied thereto, in particular on the second side facing away from the second counter-pressure roller 106′. In this embodiment, two independent application units 101; 101′ are provided for the two sides of the carrier substrate 106. It is thus possible to set conditions in the relevant laminating gap 107; 107′ for the particular job which independently differ from one another. For example, a different compression force or linear force and/or possibly temperature can be set.

For such an embodiment, it is possible, for example with respect to a large wrap, for the metering roller 102; 102′, the laminating roller 103; 103′ and the counter-pressure roller 106; 106′ forming the laminating gap 107; 107′ with the latter to be arranged in the respective application unit 101; 101′ in a first variant embodiment with respect to one another in such a way that the planes connecting the axes of rotation R102; R103; R106; R102′; R103′ of the respective adjacent rollers 102; 103; 106; 102′; 103′; 106″ intersect at an angle α, which is, for example, between 40° and 130°, in particular between 70° and 110°, preferably between 80° and 100°. A large wrap can cause a better heat transfer from a possibly temperature-controlled counter-pressure roller 106; 106′ and/or improved, for example flutter-free, run-up and run-off (see, for example, FIG. 3 to FIG. 5).

The particular counter-pressure roller 106; 106′ can thus, for example, be arranged beneath the laminating roller 103; 103′ in such a way that the plane connecting the axes of rotation R103; R106; R103′ of the two rollers 103; 103′; 106; 106′ deviates from the vertical by no more than ±30°, in particular no more than ±15°. In the process, the compression force in the laminating gap and gravitation act predominantly in the same direction.

In a second variant embodiment, which is advantageous, for example, with respect to the effective forces and load directions, the metering roller 102; 102, the laminating roller 103; 103′ and the counter-pressure roller 106; 106′ forming the laminating gap 107; 107′ with the latter are arranged, for example, in such a way with respect to one another in the respective application unit 101; 101′ that the planes connecting the axes of rotation R102; R103; R106; R102′; R103′ of the rollers 102; 103; 106; 102′; 103′; 106′, which are in each case adjacent in pairs, intersect at the most at an acute angle α that is no more than 20°, in particular 0°, so that the axes of rotation R102; R103; R106; R102′; R103′ of the three rollers 102; 103; 106; 102′; 103′; 106′ of the same application unit 101; 101′ are located in the same plane. This makes the arrangement very rigid since the forces and counter-forces are at least predominantly directed against one another. With such an arrangement of the three rollers 102; 103; 106; 102′; 103′; 106′, for example, also referred to as a “planar arrangement”, the three rollers are arranged in a row one behind the other in such a way that the axes of rotation R102; R103; R106; R102′; R103′ thereof intersect at least the same straight line extending perpendicular to the respective axes of rotation R102; R103; R106; R102′; R103′. If necessary, they may be slightly inclined or inclinable with respect to one another, as is described below.

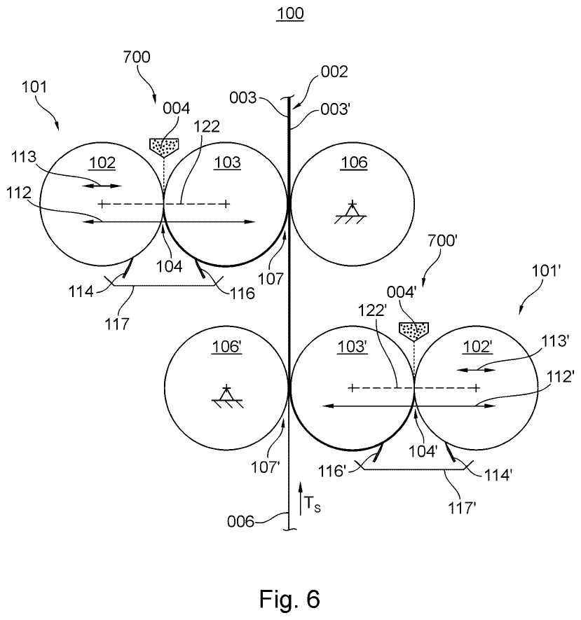

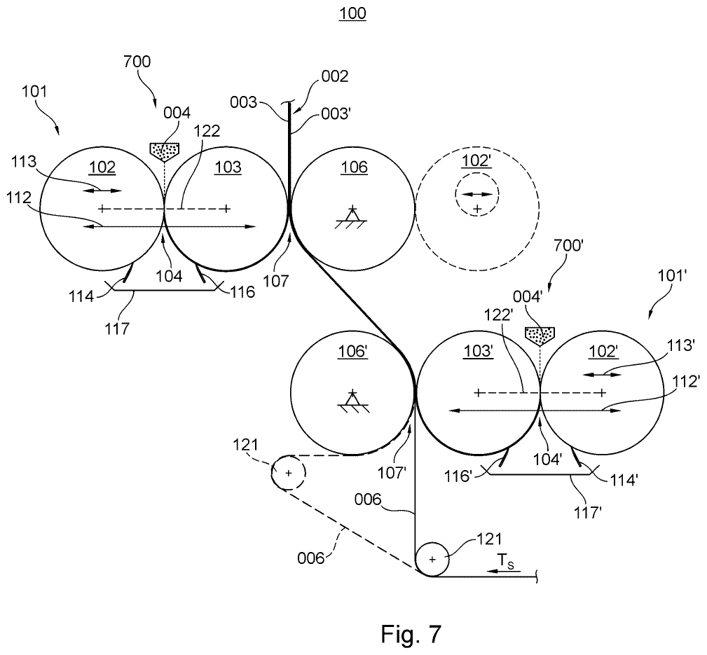

The two application units 101; 101′ are located with the laminating rollers 103; 103′ thereof on different sides of the substrate path and can be arranged on top of one another in such a way that the two laminating gaps 107; 107′ in one embodiment are located vertically directly on top of one another (see, for example, FIG. 6) or in another embodiment are horizontally offset from one another, in particular by at least half a laminating roller diameter and no more than one and a half laminating roller diameter (see, for example, FIG. 7). Based on FIG. 7, a substrate guidance that can also be applied to other embodiments is indicated by way of example by a dotted line, by way of which a larger wrap angle, and thus better heat transfer and/or more stable run-up, can be implemented. For this purpose, the substrate path is or is being deflected by an additional substrate guide element 121 in such a way that the transport direction Ts during the run-up on the succeeding roller 106; 106′ runs at least 45° inclined with respect to the transport direction Ts of the exiting substrate 006.

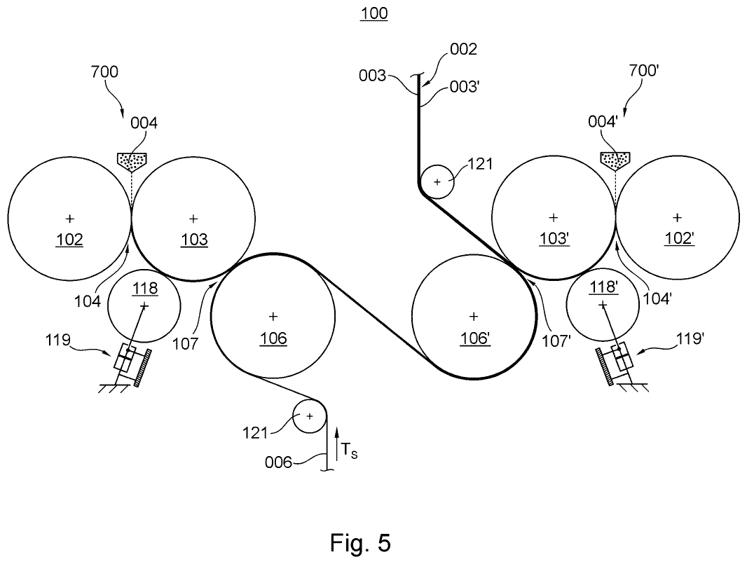

In addition to the metering roller 102; 102′, the second roller 103; 103′ or a roller that cooperates with the second roller directly or indirectly via one or more further rollers and is effective as a laminating roller, a further roller 118; 118′ (see, for example, by way of example for all embodiments of the first group in FIG. 5) can be provided in an advantageous refinement, which in a circumferential section, which during normal operation, that is, during production operation, guides the dry film 003; 003′, between the metering gap 104; 104′ and laminating gap 107; 107′, the laminating roller 103; 103′ in the form of a calendering roller 118; 118′ can be placed against a dry film 003; 003′ that is to be guided or is guided on the laminating roller 103; 103′.

For the above-described embodiments, variant embodiments and specific embodiments, it is possible, in a first configuration of the roller mount, for the laminating roller 103; 103′ of the respective application unit 101; 101′ to be mounted so as to be stationary, during normal operation, with the axis of rotation R103; R103′ thereof, even though it may be adjustable in the position thereof, and for the metering roller 102; 102′ and the counter-pressure roller 106; 106′ in each case to be mounted so as to be adjustable in a direction having at least one movement component toward the assigned laminating roller 103; 103′ and/or away therefrom by way of respective positioning drives 109; 109′; 111; 111′. Here and hereafter, the term of a positioning drive 109; 109′; 111; 111′ shall be understood to mean the entirety of the means that effectuate and/or enable the direct or indirect adjustment of a roller 102; 102′; 103; 103′; 106; 106′, which hereafter are also referred to as positioning means 109; 109′; 111; 111′, and encompasses at least one positioning mechanism 112; 112′; 113; 113′ guiding the roller 102; 102′; 103; 103′; 106; 106′ along an adjustment movement as well as one or more drive means 132; 132′; 133; 133′ effectuating the adjustment.

For placing the respective metering roller 102; 102′ against the second roller 103; 103′, a position-based positioning drive 109; 109′ or positioning means 109; 109′ is provided in a first design for a position-based adjustment, that is, a positioning drive 109; 109′ or positioning means 109; 109′ by way of which the component to be adjusted can be moved into a defined position. A position-based positioning drive 109; 109′ or position-based positioning means 109; 109′ can, for example, be positioned with respect to a predefined and/or defined position or can be operated or adjusted so as to be position-controlled by closed loop control or even position-controlled by open loop control.

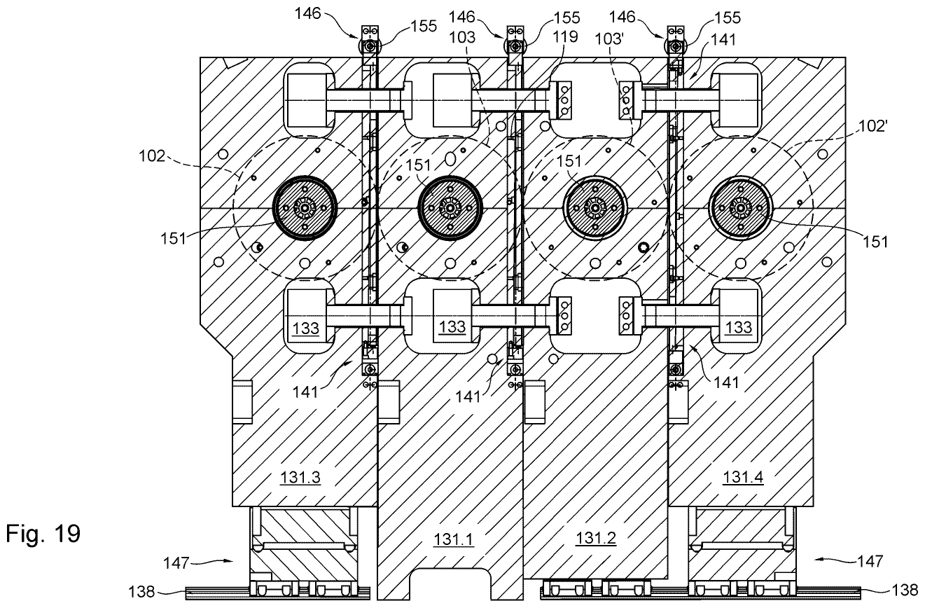

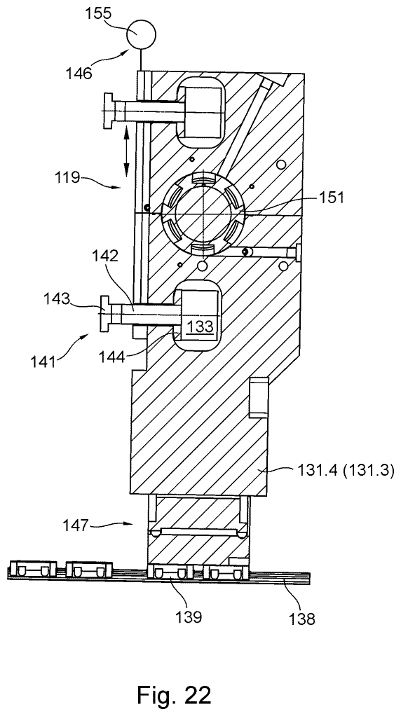

Such a position-based positioning drive 109; 109′ can be implemented, for example, by a drive means 132; 133, for example drive motor, itself being able to assume a defined and specifiable position, such as is possible, for example, for a closed loop position-controlled servo drive or motor (see, for example, an embodiment described below of the drive means 132 as a hydraulically actuated cylinder-piston system 132 that can be controlled by open loop control or closed loop control with respect to the piston position), or by an adjustment path, at least toward the relevant side, being delimited, for example, by stop means 119 that can be adjusted by positioning and/or drive means 146, for example an adjustable stop 119, which defines the end position and against which the component to be adjusted in terms of the position is set or can be set by means of a, for example, force-based or not positionally accurate drive means (see, for example, comments with regard to FIG. 19 or FIG. 22). The roller 102; 102′ is mounted, for example, in or at a positioning mechanism 112; 112′; 113; 113′ which is formed by a bearing mechanism 112; 112′; 113; 113′ implementing the adjustment path, for example, in a positionally accurate manner. Such a mechanism is advantageously provided, for example, by a bearing 113; 113′ comprising an eccentric, for example a triple ring bearing 113; 113′, in particular for small adjustment paths at large forces. With respect to, for example, a position that is parallel to the adjustment direction and thus more direct in terms of the adjustment path, however, a linear bearing 112; 112′ extending in the adjustment direction may also be advantageous instead.

For adjusting the respective counter-pressure roller 103′; 106; 106′, a force-based positioning drive 111; 111′ or positioning means 111; 111′ is or are provided in this first advantageous design for a force-based adjustment, that is, a positioning drive 111; 111′ or positioning means 111 by way of which a throwing-on with a defined force against the abutment can be implemented. A force-based positioning drive 111; 111′ or force-based positioning means 111; 111′ can, for example, be adjustable with respect to a predefined and/or defined force or can be operated or adjusted so as to be force-controlled by open loop control or even force-controlled by closed loop control.

Such a force-based positioning drive 111; 111′, which is in particular provided on at least one side, can be implemented, for example, in that a drive means 132, for example a drive motor 132, itself can apply a defined and specifiable force, such as is possible, for example, for a closed loop moment-controllable or open loop moment-controllable, in particular closed loop torque-controllable or open-loop torque-controllable servo drive or motor, or in that the roller to be adjusted can be placed against the other roller 103; 103′ with an adjustment force toward the relevant side by a drive means actuatable by means of a pressurized medium, for example by a pneumatically or hydraulically actuated cylinder-piston system 132; 133, wherein the pressure of the drive means 132; 133 is preferably settable. The counter-pressure roller 106; 106′ is mounted, for example, in or at a positioning mechanism 112; 112′; 113; 113′, which is formed by a bearing mechanism 112; 112′ that implements the adjustment force in a force-based manner, that is, without additional mechanical delimitation of the adjustment path. This can advantageously be formed, for example, by a bearing mechanism 112; 112′ designed as a linear bearing 112; 112′, at least on one side, but preferably on both sides.

In a second design, however, the metering roller 102; 102′ can conversely be adjustable in a force-based manner, and the counter-pressure roller 106; 106′ can be adjustable in a position-based manner. For this purpose, what was described above must be appropriately transferred and applied.

In a third design, however, both rollers 102; 102′; 106; 106′ can be adjustable in a force-based manner, and in a fourth design both rollers 102; 102′; 106; 106′ can be adjustable in a position-based manner. For this purpose, what was described above must be appropriately transferred and applied.

In a particularly advantageous fifth design, a combined positioning mechanism 112; 113; 112′; 113′ and/or a combined positioning drive 109; 109′; 111; 111′ or combined positioning means 109; 109′; 111; 111′ are provided for adjusting at least the metering roller 102; 102′ and/or at least for adjusting the counter-pressure roller 106; 106′, which selectively allows a position-based adjustment of the relevant roller 102; 102′; 106; 106′ or a force-based adjustment.

Such a combined positioning drive 109; 109′; 111; 111′ is formed, for example, by a positioning drive 109; 111; 109′; 111′ or positioning means 109, 111; 109′, 111′ comprising a positioning mechanism 112; 112′; 113; 113′, in the adjustment path of which selectively a stop 119, which can be positioned, for example, by drive and/or positioning means, can be introduced for limiting the position. As an alternative, a positioning drive 109, 111; 109′, 111′ which comprises, as drive means 132, 133; 132′, 133′, a selectively closed loop position-controlled or open loop position-controlled or closed loop moment-controlled or open loop moment-controlled motor 132, 132′; 133, 133′, in particular servo motor, is also advantageous.

In a second configuration for the roller mounting, the counter-pressure roller 106; 106′ of the respective application unit 101; 101′ can be mounted so as to be stationary, during normal operation, with the axis of rotation R106; R106′ thereof, even though it may be adjustable, and the laminating rollers 103; 103′, with the respective assigned metering roller 102; 102′, can be mounted so as to be adjustable in pairs in a direction having at least one movement component toward the assigned counter-pressure roller 106; 106′ and/or away therefrom by way of respective shared bearing mechanisms 112; 112′ and/or positioning drives 111; 111′, and additionally the respective metering rollers 102; 102′ can be mounted so as to be adjustable in a direction having at least one movement component toward the respective assigned laminating roller 103; 103′ and/or away therefrom by way of bearing mechanisms 112; 112′; 113; 113′ and/or positioning drives 109; 109′; 111; 111′.

In a first advantageous design, a position-based positioning drive 109; 109′ within the above meaning, for example a bearing mechanism 112; 112′; 113; 113′ formed by a triple ring bearing 113; 113′ or by a linear bearing 112; 112′; 113; 113′ can be provided for this purpose, for example on one side or both sides, for adjusting the respective metering roller 102; 102′. A force-based positioning drive 111; 111′ within the above meaning can be provided for adjusting the laminating rollers 103; 103; in pairs with the respective assigned metering roller 102; 102′.

In a second design, however, the metering roller 102; 102′ can conversely be adjustable in a force-based manner, and the roller pair 103, 102; 103′, 102′ can be adjustable in a position-based manner. For this purpose, what was described above must be appropriately transferred and applied.

In a third design, however, the metering roller 102; 102′ and the roller pair 103, 102; 103′, 102′ can be adjustable in a force-based manner, and in a fourth design the metering roller 102; 102′ and the roller pair 103, 102; 103′, 102′ can be adjustable in a position-based manner. For this purpose, what was described above must be appropriately transferred and applied.

In a particularly advantageous fifth design, a combined positioning mechanism 112; 113; 112′; 113′ is provided for adjusting at least the metering roller 102; 102′ and/or at least for adjusting the roller pair 103; 102; 103′, 102′ within the above meaning and/or in the above design, which selectively allows a position-based or force-based adjustment of the pair toward the counter-pressure roller 106; 106′; 103′; 103.

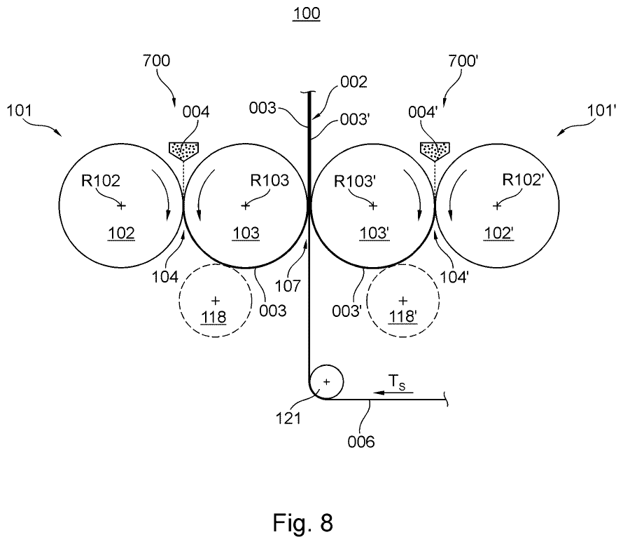

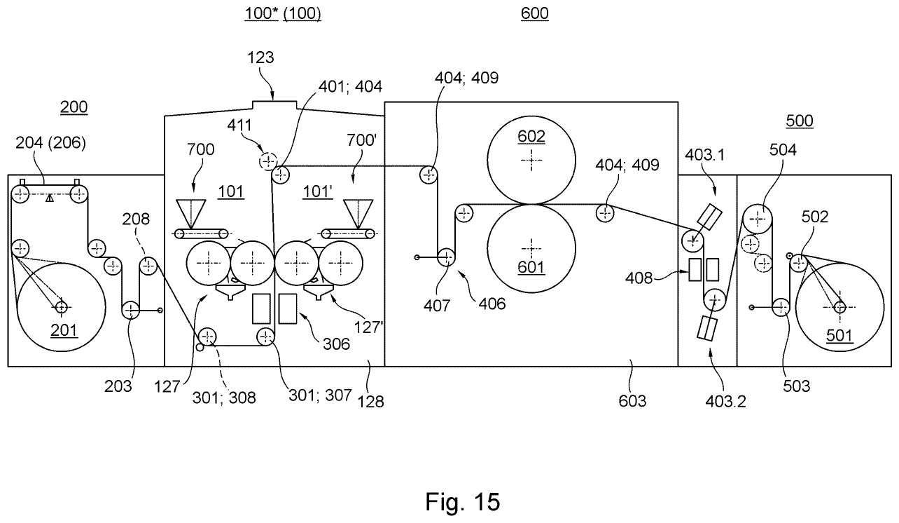

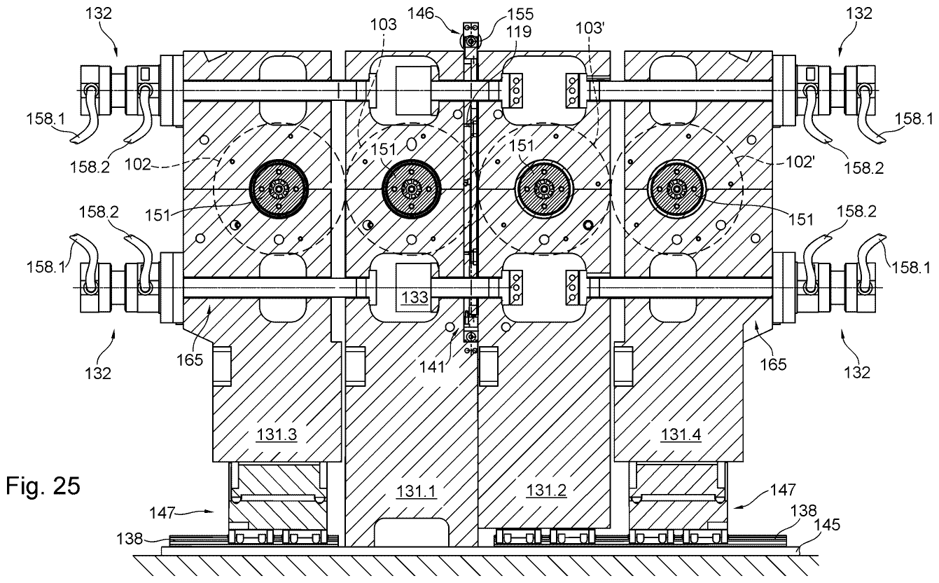

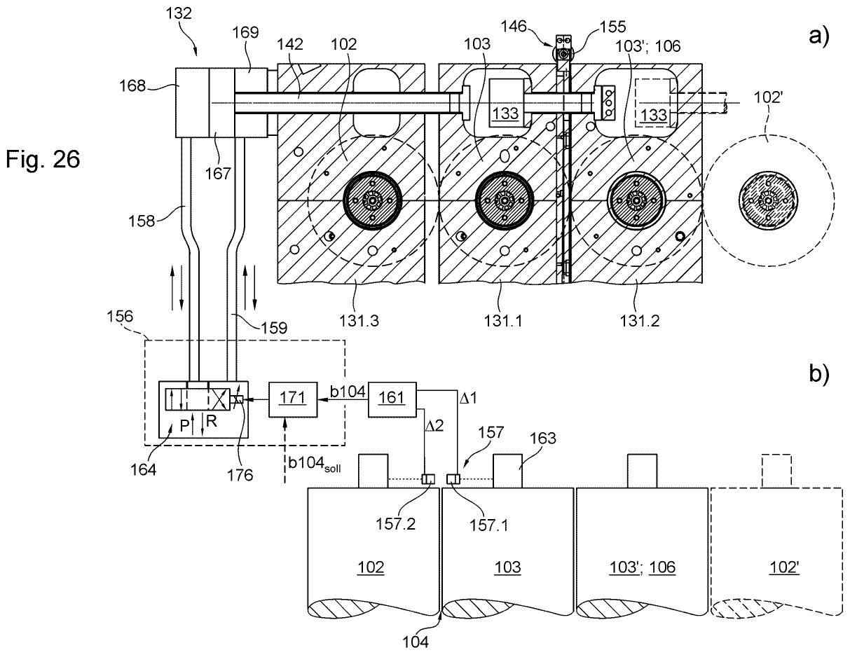

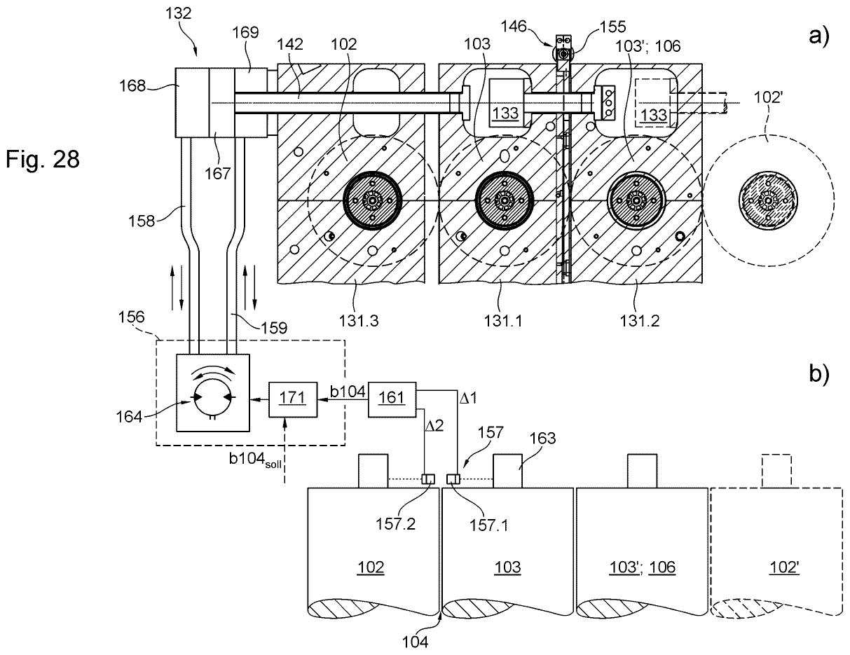

In a second group of exemplary embodiments for the coating device 100* (see, for example, shown in FIG. 8 to FIG. 12, FIG. 15 to FIG. 19, FIG. 25, FIG. 26, and FIG. 28), the second roller 003′ of the second application unit 101′ or a roller of the second application unit 101′ cooperating with the second roller 103′ directly or indirectly via one or more further rollers, together with the second or further roller 103 of the first application unit 101 effective as the laminating roller 103, in a nip between the outer cylindrical surfaces thereof, form a shared gap 107 that is effective as a two-sided laminating gap 107, wherein the two laminating rollers 103; 103′ forming the gap 107 between each other are effective with respect to one another as counter-pressure rollers 103′; 103. The carrier substrate 006 can be guided through the latter and has the respective dry film 003′; 003′ formed via the first and second film-forming gaps 104; 104′ applied thereto, in particular on both sides. Such an arrangement of two application units 101; 101′ cooperating for the simultaneous two-sided application is also referred to hereafter as a double application unit 101; 101′.

The planes formed in the respective application unit 101; 101′ by the axes of rotation R102; R103; R102′; R103′ of the metering roller 102; 102′ and the laminating roller 103; 103′, for example, intersect at the most at an acute angle α, which, for example, is no more than 20°, advantageously no more than 5°, in particular 0°, so that in the latter case the axes of rotation R102; R103; R106; R102′; R103′ of the rollers 102; 103; 106; 102′; 103′; 106′ of the two application units 101; 101′ cooperating in a two-sided laminating gap 107 are located in the same plane or extend parallel to, but vertically offset from one another.

In a first variant embodiment, the two planes extend in a shared horizontal plane or horizontally, but vertically offset from one another (see, for example, FIG. 8).

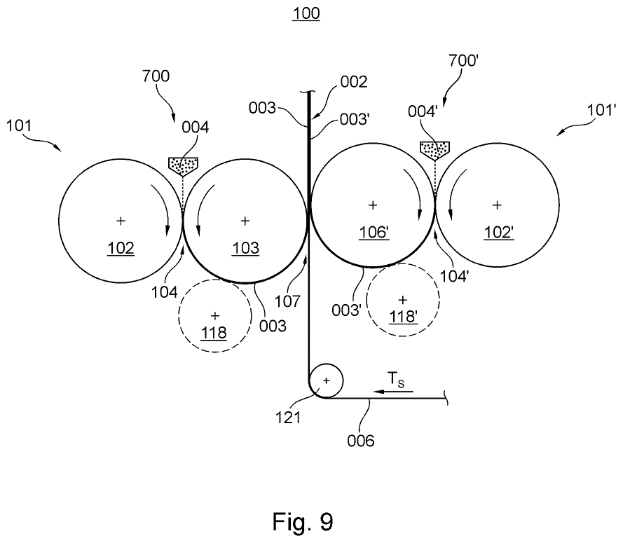

In a second advantageous variant embodiment, for example with respect to a smaller wrap, the two planes extend in a shared plane that is inclined with respect to the horizontal or in two planes that are inclined with respect to the horizontal, but are offset vertically from one another. The shared plane is, or the two offset planes are, for example, inclined with respect to the horizontal by an acute angle β of 2° to 15°, in particular 3° to 10° (see, for example, FIG. 9). With such an arrangement of all, in particular all four rollers 102; 103; 106; 102′; 103′ of a double application unit 101; 101′ in one plane, for example, also referred to as a “planar arrangement”, the rollers 102; 103; 106; 102′; 103′ are arranged in a row one behind the other in such a way that the axes of rotation R102; R103; R106; R102′ thereof intersect at least the same straight line extending perpendicular to the respective axes of rotation R102; R103; R106; R102′. If necessary, they may be slightly inclined or inclinable with respect to one another, as is described below.

In addition to the respective metering roller 102; 102′ and the second roller 103; 103′, in an advantageous refinement a further roller 118; 118′ in the above-described form of a calendering roller 118; 118′ can also be provided here (see, for example, by way of example dotted for all embodiments of the second group in FIG. 8 and FIG. 9).

For the above-described variant embodiments and specific embodiments, in a first configuration of the roller mount, a first of the two laminating rollers 103 or a further roller, effective as a laminating roller, of a first of the two application units 101 can be mounted so as to be stationary, during normal operation, with the axis of rotation R103 thereof, even though it may be adjustable, while the second of the laminating rollers 103′ or a further roller, effective as a second laminating roller, together with the assigned metering roller 102; 102′, are mounted so as to be adjustable in pairs in a direction having at least one movement component toward the assigned counter-pressure roller 106; 106′ and/or away therefrom by way of a shared bearing mechanism 112; 112′ and/or a shared positioning drive 109; 109′; 111; 111′, and additionally the respective metering rollers 102; 102′ are mounted so as to be adjustable in a direction having at least one movement component toward the respective assigned laminating roller 103; 103′ or further roller and/or away therefrom by way of bearing mechanisms 112; 112′; 113; 113′ and/or positioning drives 109; 109′; 111; 111′. If one or more further rollers are present between the metering roller 102; 102′ and the roller effective as a laminating roller, these are, for example, also adjustable together in a direction having at least one movement component toward the assigned counter-pressure roller 106; 106′ and/or away therefrom by way of the shared bearing mechanism 112; 112′ and/or the shared positioning drive 109; 109′; 111; 111′.

For the adjustment of the respective metering roller 102; 102′, a position-based positioning drive 109; 109′ within the above meaning and/or in an above-described embodiment is provided in a first advantageous design. For the adjustment of the second laminating roller 103′ in pairs with the assigned metering roller 102′, a force-based positioning drive 111; 111′ can be provided for a force-based adjustment within the above meaning and/or in an above-described embodiment.

In a second design, however, the metering roller 102; 102′ can conversely be adjustable in a force-based manner, and the roller pair 103, 102; 103′, 102′ can be adjustable in a position-based manner. For this purpose as well, what was described above must be appropriately transferred and applied.

In a third design, however, both rollers 102; 102′; 106; 106′ can be adjustable in a force-based manner, and in a fourth design both rollers 102; 102′; 106; 106′ can be adjustable in a position-based manner. For this purpose, what was described above must be appropriately transferred and applied.

In an advantageous fifth design, a combined positioning mechanism 112; 113; 112′; 113′ is provided for adjusting at least the metering roller 102; 102′ and/or at least for adjusting the roller pair 103; 102; 103′, 102′ within the above meaning and/or in the above embodiment, which selectively allows a position-based adjustment of the pair against the laminating roller 103′; 103 effective as a counter-pressure roller 103′; 103 via a position-based positioning drive 109; 109′ and a force-based adjustment via a force-based positioning drive 111; 111′.

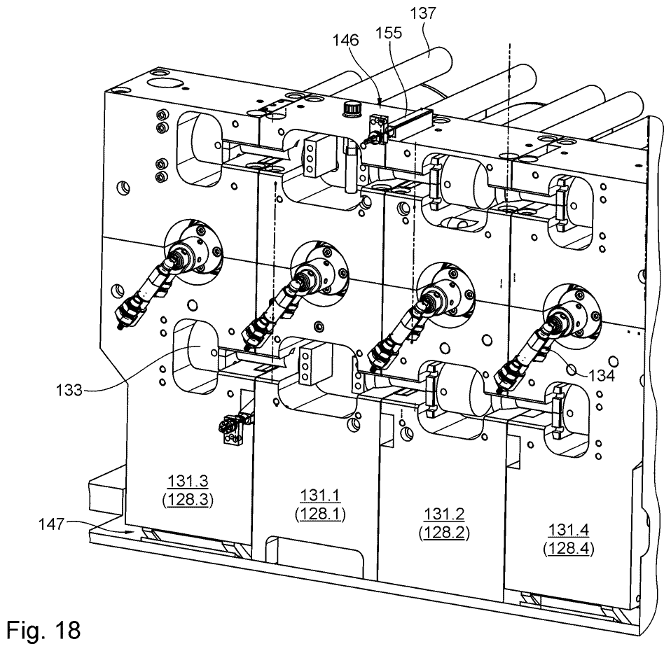

In an advantageous sixth design, which will be described in greater detail below, for example, in connection with FIG. 18 and FIG. 19, or FIG. 25 to FIG. 28, a position-based positioning drive 109; 109′ within the above meaning and/or in an above-described embodiment is provided for adjusting the first gap 104; 104′ or the particular metering roller 102; 102′, and a force-based positioning drive 111; 111′ for a force-based adjustment within the above meaning is provided for adjusting the second gap 107 or for adjusting the counter-pressure roller 103′, wherein the two metering rollers 102; 102′ as well as the counter-pressure roller 103; 103′ to be adjusted can each be adjusted alone, that is, without coupling in pairs. In a particularly advantageous refinement of this embodiment, a combined positioning mechanism 112; 113; 112′; 113′ within the above meaning and/or in the above embodiment is provided for adjusting at least the metering roller 102; 102′ and/or for adjusting the second gap 107 or for adjusting the counter-pressure roller 103′.

For all embodiments of the two groups of exemplary embodiments comprising jointly adjustable rollers 103′; 102′; 103; 102, these can be mounted on both sides in carriers 122′; 122, in particular in side parts of a subframe, which, in turn, are mounted by way of bearing mechanisms 112′; 112; 113′; 113 formed by linear bearings 112′; 112; 113′; 113 in a frame receiving the application units 101; 101′.

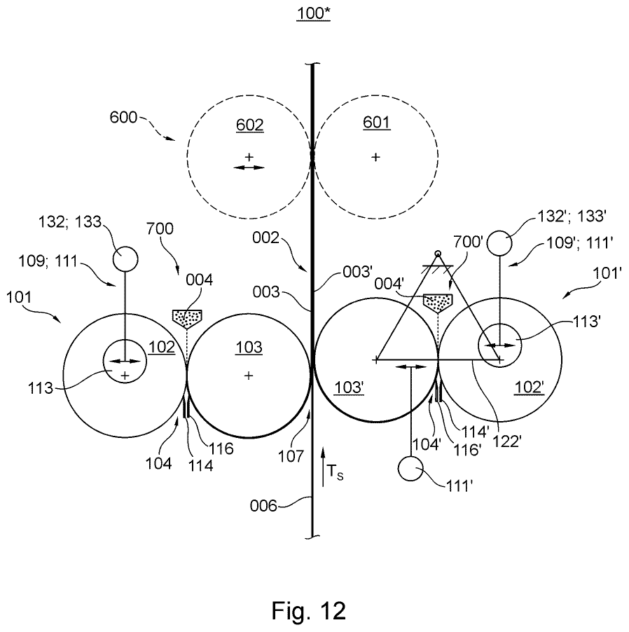

As an alternative, the two jointly adjustable rollers 102; 103; 102′; 103′, however, can be mounted on both sides in carriers, in particular in side parts of a subframe, which, in turn, are mounted so as to be pivotable about a pivot axis that is parallel to the axis of rotation of the first laminating roller 103; 103′ mounted in a stationary manner (see, for example, FIG. 12).

As was already mentioned, at least one further roller, which is effective as a laminating roller and, together with the counter-pressure roller 106; 103′, forms the laminating gap 107; 107′, can be provided in a respective application unit 101; 101′ between the second roller 103; 103′ and the nip point for the counter-pressure roller 106; 103′.

For all embodiments of the two groups of exemplary embodiments, in a particularly advantageous refinement a removal device 114; 114′, which is comprised, for example, by a material removal unit 127; 127′ and, for cleaning purposes, can be selectively placed against and be removed from the outer cylindrical surface of the first roller 102; 102′, in particular a cleaning squeegee 114; 114′, is provided in the respective application unit 101; 101′. This removal device extends, for example, at least over the width of the cylindrical roller surface which is effective for forming the film.

Instead or advantageously in addition, the material removal unit 127; 127′ in the respective application unit 101; 101′, viewed axially parallel to the second roller 103; 103′, comprises spaced apart from one another two axially parallel adjustable removal devices 116; 116′, which can be placed against or removed from the second roller 103; 103′, in particular a side edge squeegee 116; 116′, by which a dry film 003; 003′ that is conveyed over the second roller 103; 103′ can be removed in the region of the lateral edges thereof and, for example, be transferred into a collecting device 117; 117′. This removal serves, for example, as a so-called trimming of the edge, to preserve a straight edge and/or a desired width b003; b003′ of the dry film 003; 003. The collected amount can, for example, be returned to the infeed of the powder mixture 004; 004′. Such a removal device 116; 116′ can also be used to remove an edge strip 008; 008′, which is used, for example, during the determination of a density of the material layer 003; 003′.

For cleaning purposes, a removal device 129; 129′ that can be placed against and removed from the outer cylindrical surface of the second roller 103; 103′, in particular a cleaning squeegee 129; 129′, can also advantageously be provided, which, for example, extends at least over the width of the cylindrical roller surface which is effective for forming the film, and possibly an extraction or collecting device, which is not shown.

For feeding or introducing the powder mixture 004; 004′ into the first gap 004; 004, an above-described powder feed device 700; 700′ for feeding a powdered material is provided, wherein a filling and/or supply chamber 126 having a width extending in the axial direction of the second roller 103; 103′ is formed and/or provided in the region of the wedge-shaped space above the gap 104; 104′, that is, in the space that is formed above the gap 104; 104′ between the outer cylindrical surfaces of the two rollers 102; 103; 102′; 103′ and has an in particular wedge-shaped or triangular profile.

In a particularly advantageous design, two boundaries 124, which are spaced apart from one another axially parallel to the first roller 102; 102′ and, for example, are adjustable in the axially parallel direction, in particular side shields 124, are provided in the application unit 101; 101′ above the first gap 104; 104′, which each seal off a region of the upper wedge-shaped space formed between the outer cylindrical surfaces of the first and second rollers 102; 103; 102′; 103′ toward the two end faces of the application unit 101; 101′, and in this way form an interposed filling and/or supply chamber 126, which preferably can be varied in terms of the width, for receiving the powder mixture 004; 004′. Depending on the desired width and/or position of the dry film 003; 003′, the filling and/or supply chamber 126 can thus be varied or be variable on at least one side, preferably on both sides, in terms of the position of the lateral boundary 124 thereof. As an alternative to a filling and/or supply chamber 126 that is directly delimited by the outer cylindrical surfaces in the lower region, generally a filling and/or supply chamber 126 in the form of a filling or supply hopper could also be provided, at least where this does not contradict other design features of the application unit 101; 101′ or of the powder feed unit 700; 700′, for example in a manner comparable to an insertion aid described below, directly in or above the wedge-shaped space.

For all above-described embodiments, variants, configurations, specific embodiments or designs, the bearing mechanism 112; 112′; 113; 113′ and/or the positioning drive 109; 109′; 111; 111′ of the first roller 102; 102′ is preferably designed in such a way that a gap width b104 for the first gap 104; 104′, during normal operation, can be set to a variable inside width at the narrowest point of at least 15 μm, advantageously of at least 30 μm, in particular of at least 50 μm, and/or that the gap width b104 of the first gap 104; 104′ can at least be set by way of above-described position-based drive means 132; 132′ and/or by way of at least one-sided stop means 119 which delimit a throw-on position toward the nip point and the positions of which are adjustable, that is, for example an above-described in particular adjustable or positionable stop 119.

As an alternative or in addition, the bearing mechanism 112; 112′; 113; 113′ and/or the positioning drive 109; 109′; 111; 111′ are advantageously designed to set and/or apply, in the first gap 104; 104′ at least in the region of the width thereof contributing to the film formation, a linear force of, for example, at least 500 N/mm, advantageously at least 700 N/mm, preferably a linear force ranging between 500 N/mm and 3000 N/mm, between the rollers 102; 102′; 103; 103′ forming the first gap 104; 104′.

As mentioned above, a combined positioning mechanism 112; 113; 112′; 113′ can be provided for throwing the metering roller 102; 102′ on the second roller 103; 103′, for example in an above embodiment and/or within the above meaning, which selectively, for example in one operating mode, allows a position-based adjustment by way of a position-based positioning drive 109; 109′ and, for example in a second operating mode, allows a force-based adjustment by way of a force-based positioning drive 111; 111′.

For all above-described embodiments, variants, configurations, specific embodiments or designs and, for example, independently of the above-described implementation of the coating device 100; 100* comprising individual application units 101; 101′ with respective counter-pressure rollers 106; 106 or comprising combined application units 101; 101′ with counter-pressure rollers 103′; 103 that are effective with respect to one another, in a particularly advantageous embodiment the metering gap 104; 104′ between the first and second rollers 102; 102′; 103; 103′ can be adjusted based on a position-based positioning drive 109; 109′ within the above meaning, which can be positioned, for example, with respect to a predefined position or is position-controlled by open loop control or position-controlled by closed loop control, for example can be positioned with respect to the gap width b104, can be controlled by open loop control, for example, via an open loop control system S_{b}; S_{d}; S″_{d}; S_{F} or can be controlled by closed loop control, for example, via a closed loop control circuit R_{b}; R_{d}; R″_{d}; R_{F}, that is, for example, can be set to a constant and/or defined gap width b104; b104′, for example can be positioned, controlled by open loop control or controlled by closed loop control, wherein the position-based adjustment is directed at a relative position or gap width 104 of the two rollers 102; 103; 102′ 103′, which is to be defined and maintained at a constant level, in the working positions thereof, and/or the laminating gap 107; 107′ between the second roller 103; 103′ and the counter-pressure roller 106; 106′; 103′; 103 can be adjusted within the above meaning based on a force-based, for example, force-controlled by open loop control or force-controlled by closed loop controlled, positioning drive 111; 111′, for example can be controlled by open loop control with respect to the adjustment force via, for example, a pressure control valve or, for example, a controlled system comprising, for example, such a pressure control valve or, for example, can be controlled by closed loop control via, for example, a controlled system comprising such a pressure control valve, that is, can be set, for example, to a constant and/or defined contact force or linear force, for example can be controlled by open loop control or controlled by close loop control, wherein the force-based adjustment is in particular directed at a contact force or linear force, which is defined and/or to be maintained at a constant level, between the two rollers 106; 106′; 103′; 103 involved in the second gap 107; 107′ in the working position thereof. It shall be noted only for clarification purposes that the linear force or contact force effective between the two rollers 106; 106′; 103′; 103 involved in the second gap 107; 107′, in particular, does not act directly, but via the material that is guided through the gap, in the case of the film-forming gap 104; 104′, for example, via the powdered material 004; 004′, and in the case of the laminating gap 107; 107′ via the product strand 002 comprising the dry film 007 on one side or both sides.

Without limiting the above-described specific exemplary embodiments, generally any of the two rollers 102; 102′; 103; 103′; 106; 106′ involved in the relevant gap 104; 104′; 107; 107′ can be mounted so as to be adjustable by the corresponding positioning drive 109; 109′; 111; 111′ and/or at corresponding positioning mechanisms 112; 112′; 113; 113′ within the above meaning. This also applies to embodiments in which one of the rollers 102; 102′; 103; 103′; 106; 106′ that is involved in the relevant gap 104; 104′; 107; 107′, together with another roller 102; 102′; 103; 103′; 106; 106′ that is not involved in this gap 104; 104′; 107; 107′, are mounted so as to be jointly adjustable in this manner.

Likewise, for example, independently of the above-described implementation of the coating device 100; 100* comprising individual application units 101; 101′ with respective counter-pressure rollers 106; 106 or comprising combined application units 101; 101′ with counter-pressure rollers 103′; 103 that are effective with respect to one another, in a particularly advantageous embodiment with respect to the optimal adjustability the metering gap 104; 104′ between the first and second rollers 102; 102′; 103; 103′ of the same application unit 101; 101′ and/or the laminating gap 107; 107′ between the second roller 103; 103′ and the cooperating counter-pressure roller 106; 106′; 103′; 103, is designed so as to be adjustable, for example not just merely in a position-based or force-based manner but, based on a combined positioning drive 109; 109′; 111; 111′ selectively, in particular within the above meaning, in a position-based manner, for example so as to be positionable in terms of the gap width b104, so as to be controllable by, for example, open loop control via an open loop control system S_{b}; S_{d}; S″_{d}; S_{F} or so as to be controllable, for example, by closed loop control via a closed loop control circuit R_{b}; R_{d}; R″_{d}; R_{F}, that is, so as to be adjustable in, for example, one operating mode to a constant and/or defined relative position of the two rollers and/or a constant and/or defined gap width b104, for example positionable or controllable by open loop control or controllable by closed loop control, or so as to be adjustable in, for example, another operating mode in a force-based manner, for example so as to be controllable by open loop control in terms of the adjustment force via, for example, a pressure control valve or, for example, a controlled system comprising, for example, such a pressure control valve or, for example, so as to be controllable by closed loop control via a controlled system comprising such a pressure control valve, that is, is designed so as to be settable in, for example, another operating mode to a defined and/or constant contact force or linear force, for example, so as to be controllable by open loop control or controllable by closed loop control. In particular a roller 102; 102′; 103; 103′; 106; 106′ that is involved in the relevant gap 104; 104′; 107; 107′ is mounted in a combined positioning mechanism 112; 113; 112′; 113′ so as to be selectively adjustable in a position-based or force-based manner and/or the relevant gap 104; 104′; 107; 107′ can be selectively set within the above meaning to a constant and/or defined gap width or to a constant and/or defined contact force or linear force, in particular controlled by open loop control or controlled by closed loop control within the above meaning. Without limiting the above-described specific exemplary embodiments, here as well generally any of the two rollers 102; 102′; 103; 103′; 106; 106′ involved in the relevant gap 104; 104′; 107; 107′ can be adjustable by the corresponding combined positioning drive 109; 109′; 111; 111′ and/or can be accordingly mounted at corresponding combined positioning mechanisms 112; 112′; 113; 113′ within the above meaning. This also applies to embodiments in which a roller 102; 102′; 103; 103′; 106; 106′ that is involved in the relevant gap 104; 104′; 107; 107′, together with another roller 102; 102′; 103; 103′; 106; 106′ that is not involved in this gap 104; 104′; 107; 107′, are mounted so as to be jointly adjustable in this manner.

In an advantageous embodiment, the combined positioning drive 109; 109′; 111; 111′ is formed by a force-based, in particular force-controllable by open loop control or force-controllable by closed loop control, positioning drive 111; 111′ comprising a positioning mechanism 113; 113′; 112; 112′, in the adjustment path of which selectively a stop 119, which can be positioned, for example, by way of drive and/or positioning means 145; 146, can be introduced for limiting the position. Preferably, a cylinder-piston system 133 actuatable using pressurized medium, in particular hydraulically, is provided as the drive means 133.

For the adjustment, the first roller 102; 102′ can be mounted so as to be adjustable in a direction having at least one movement component toward the respective assigned second roller 103; 103′ and/or away therefrom by way of a bearing mechanism 113; 113′; 112; 112′ and/or a, for example position-based or force-based or selectively position-based or force-based positioning drive 109; 109′; 111; 111′. In addition or instead, the counter-pressure roller 106; 106′; 103′; 103 can be mounted so as to be adjustable in a direction having at least one movement component toward the second or an interposed further roller 103; 103′ and/or away therefrom by way of a bearing mechanism 113; 113′; 112; 112′ and/or a, for example position-based or force-based or selectively position-based or force-based positioning drive 109; 109′; 111; 111′.

As an alternative, the first roller 103; 103′, together with the assigned second roller 102; 102′, can be mounted so as to be movable in pairs in a direction having at least one movement component toward the assigned counter-pressure roller 106; 106′ and/or away therefrom by way of a shared bearing mechanism 112; 112′; 113; 113′ and/or a shared, for example, position-based or force-based or selectively position-based or force-based positioning drive 109; 109′; 111; 111′, and additionally the respective first roller 102; 102′ can be mounted so as to be adjustable in a direction having at least one movement component toward the respective assigned second roller 103; 103′ and/or away therefrom by way of a bearing mechanism 113; 113′; 112; 112′ and/or a, for example, position-based or force-based or selectively position-based or force-based positioning drive 109; 109′; 111; 111′.

For all above-described embodiments, variants, configurations, specific embodiments or designs, the first roller 102; 102′ and the second roller 103; 103′ forming the first gap 104; 104′ therewith can be rotationally driven or are rotationally driven mechanically independently of one another during normal operation in opposite directions and at differing circumferential speeds and/or by differing drive means 148; 149, for example drive motors 148; 149, in particular at least speed-controllable, by closed-loop or open-loop control, servo motors.

In the process, the first roller 102; 102′ is operated at a lower speed, wherein the first roller 102; 102′, in particular the metering roller 102; 102′, and the assigned second roller 103; 103′, in particular the laminating roller 103; 103′, during normal operation, can be operated or are operated, for example, at a ratio V102(102′): V103(103′) of the circumferential speed of the first to the second roller 102, 102′; 103; 103′ which is in a range of 1:5 to 3:5, in particular 1:4.

During normal operation, the rollers 103; 106; 106′; 103′ forming the second gap 107; 107′ with one another are preferably drivable or driven mechanically independently of one another at the same circumferential speed by a shared drive motor 148, in particular servo motor, or preferably by differing drive motors 148, in particular servo motors 148.

In an advantageous embodiment, the drive motors 148; 149 that are mechanically independent of one another can be operated via an electronic, in particular virtual master axis by a drive controller.

Of particular advantage is a refinement in which the first roller 102; 102′, in the region of the outer cylindrical surface thereof contributing to the film formation, has a stronger material-repellent surface with respect to the powder mixture and/or a less strongly adhesively acting outer cylindrical surface than the second roller 103; 103′ in the region of the outer cylindrical surface contributing to the film formation.

At least the second roller 102; 102′; 103; 103′ can have a polished and/or chrome-plated or ceramic-coated surface, at least in the region of the outer cylindrical surface contributing to the film formation. The first roller 102; 102′ can have a structured or material-repellent surface, at least in the region of the outer cylindrical surface contributing to the film formation.

For all above-described embodiments, variants, configurations, specific embodiments or designs, the first and/or the second rollers 102; 102′; 103; 103′ can be temperature-controlled, in particular heated, preferably in such a way that the outer cylindrical surface thereof can be heated, for example at an ambient temperature of 25° C., to at least 80° C., advantageously to at least 100° C., preferably to at least 120° C.

Instead or preferably in addition, the roller 106; 106′ of the first group of exemplary embodiments which is only effective as a counter-pressure roller 106; 106′; 103; 103′ is temperature-controllable, in particular heatable, preferably in such a way that the outer cylindrical surface thereof can be heated, for example at an ambient temperature of 25° C., to at least 80° C., advantageously to at least 100° C., preferably to at least 120° C.

The temperature control or heating can generally be carried out electrically, however in an advantageous embodiment is implemented by conducting a temperature-control or heating fluid through the roller 102; 102′; 103; 103′; 106; 106′ of which the temperature is to be controlled. In the process, the temperature control fluid, for example accordingly temperature-controlled water, is supplied to and removed from the roller 102; 102′; 103; 103′; 106; 106′ of which the temperature is to be controlled via a temperature-control fluid line 134 and, for example, a rotary union in the relevant roller 102; 102′; 103; 103′; 106; 106′.

For all above-described embodiments, variants, configurations, specific embodiments or designs, the two application units 101; 101′ are mounted together with one or more substrate guide elements 121, which may be arranged directly upstream, downstream or therebetween, in a shared or possibly multi-piece frame 128, for example, two end-face frame walls 131 of the same or possibly multi-piece frame 128. In the case of a shared frame 128 having one-piece frame walls 131, a particularly rigid arrangement of the application units 101; 101′ can be provided in a laminating unit 100; 100* designed as a subassembly 100; 100*, for example laminating subassembly 100:100*.

If, for example, a calendering unit 600; 600*, which is described below, for example, and also referred to as a calender 600; 600*, is provided in the substrate path, for example directly, downstream from the laminating unit 100; 100*, in an advantageous refinement rollers 601; 601′; 602; 602* comprised by the calendering unit 600; 600* can likewise be mounted in this frame 603 or, in an advantageous variant, for example, as a separate subassembly 600; 600*, for example calendering subassembly 600; 600*, in side walls of a dedicated frame 603 that is arranged directly on and/or above the frame 128 carrying the application units 101; 101′.

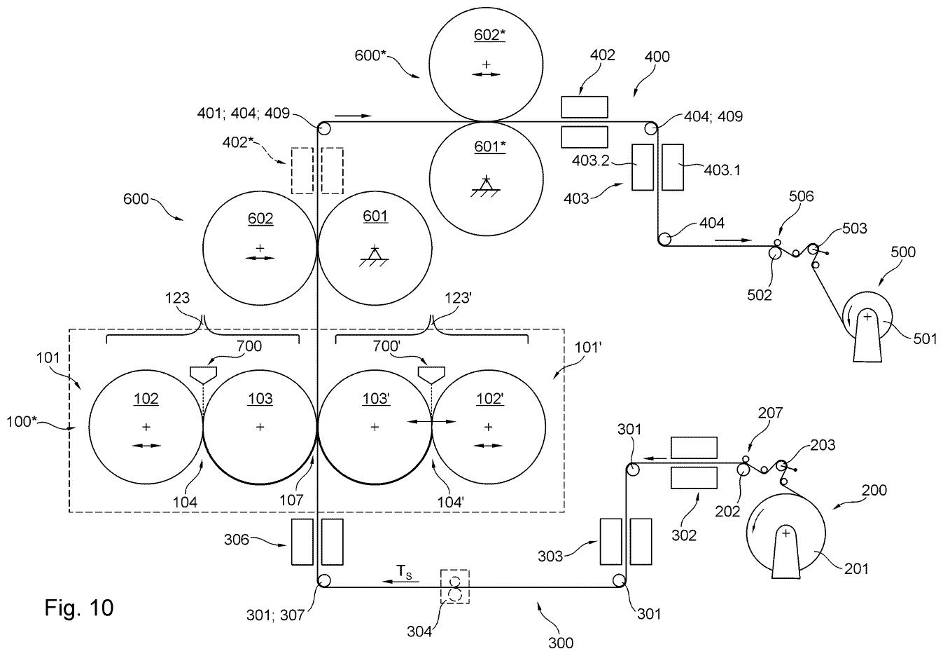

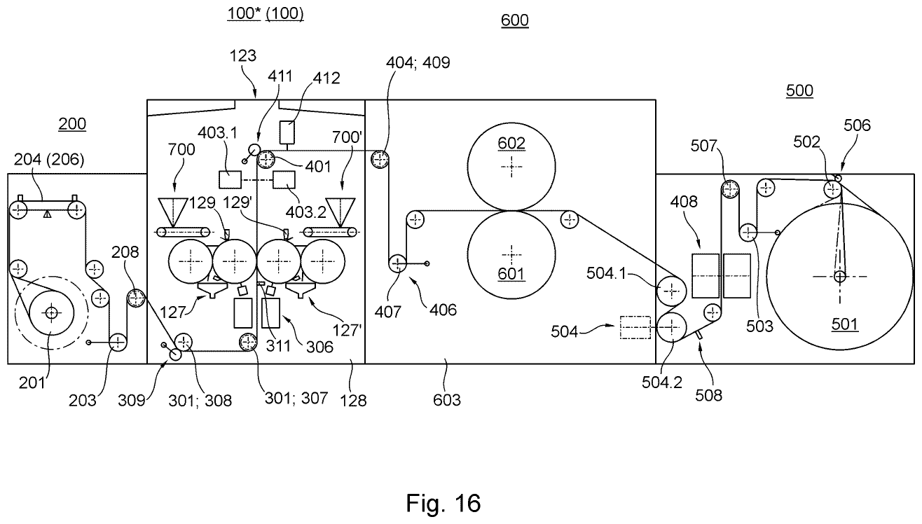

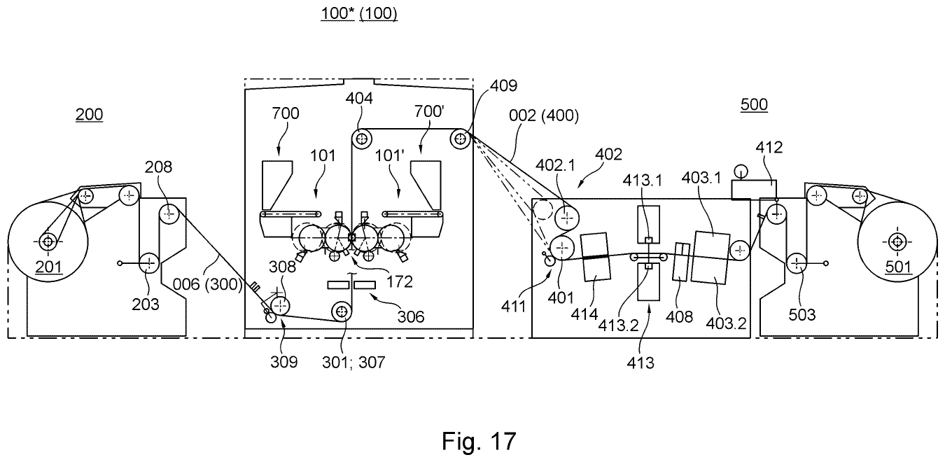

In an embodiment of the machine shown, for example, in FIG. 15 and FIG. 16, which may have a slightly longer design, in which, however, the risk of transmitting vibrations between the subassemblies 100; 100*; 600; 600*, in particular at least the laminating subassembly 100; 100* and the calendering subassembly 600; 600*, for example, is decreased, the laminating subassembly 100; 100* and the calendering subassembly 600 provided there are provided horizontally next to one another, preferably even in dedicated frames 128; 603, which, for example, are separated from one another in terms of vibration. In a variant of FIG. 3, FIG. 10, FIG. 15 and/or FIG. 16, which is not shown, the calendering subassembly 600; 600* can also be dispensed with. An advantageous embodiment of such a machine without a calendering subassembly being additionally provided in the substrate path is shown in FIG. 17, for example, and described in more detail below.

A calendering subassembly 600; 600* shown, for example, in FIG. 15 and FIG. 16 or a calendering step additionally provided downstream from the application of the dry film 003; 003*, however, is not mandatory and may also be entirely dispensed with in another embodiment of the machine for coating. In the latter case, a calendering step may then be entirely dispensed with or be performed or performable in a separate process and/or a separate, for example second, machine. The second machine comprises, for example on the input-side, a substrate unwinder, from which the web-format intermediate product 002 can be unwound and guided along a substrate path through at least one calendering unit 600 up to an output-side roll winder or via a cross-cutting device to a delivery unit.

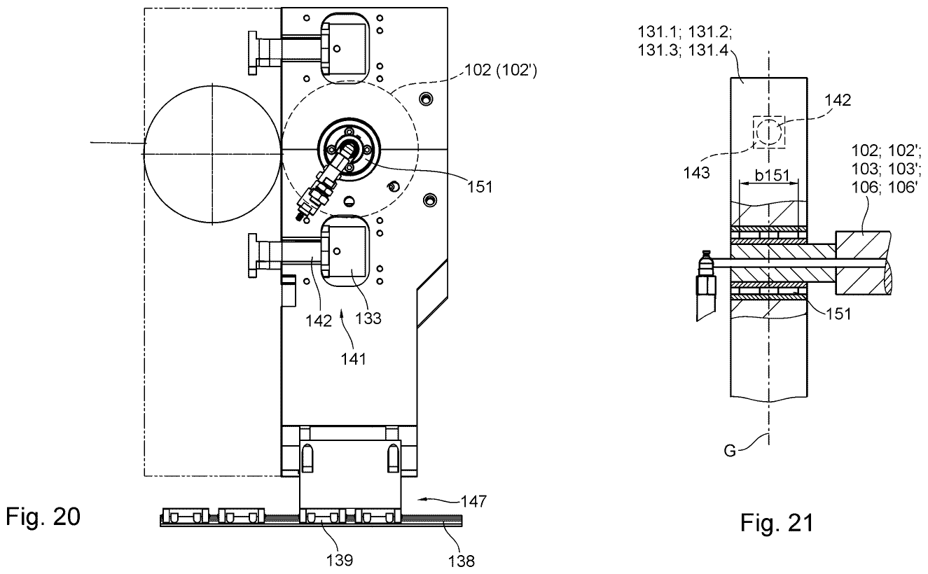

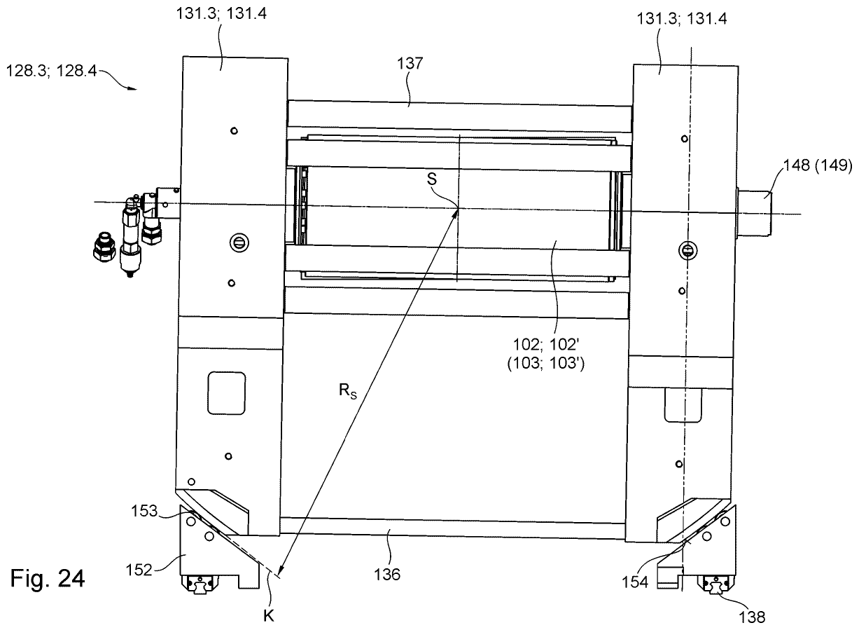

Generally independently of, but advantageously in conjunction with one of the above-described embodiments, variants, configurations, specific embodiments or designs of the application units 101; 101′ and/or coating devices 100; 100* and/or machine configurations, the frame 128 of the device for coating device for coating 100; 100 has a multi-piece design in a particularly advantageous embodiment (see, for example, FIG. 18, FIG. 19, FIG. 20, FIG. 21, FIG. 22, FIG. 24, FIG. 25, FIG. 26, and FIG. 28). At least two adjacent rollers 102; 102′; 103; 103′; 106 of the application unit 101; 101′, in an advantageous embodiment at least the two rollers 103; 103′; 106 that form the laminating gap 107; 107′ with one another and/or are effective as counter-pressure rollers 103; 103′; 106 are mounted on both sides in, in particular rigidly connected, frame walls 131.1; 131.2; 131.3; 131.4 of two different frame sections 128.1; 128.2; 128.3; 128.4, which in the relative position thereof are arranged so as to be able to vary the position thereof relative to one another along an adjustment direction extending perpendicular to the axis of rotation R102; R103; R102′; R103′; R106; R106′ of at least one of the two adjacent rollers 102; 102′; 103; 103′; 106 in such a way that a distance between the outer cylindrical surfaces thereof or axis of rotation R102; R103; R102′; R103′; R106; R106′ and/or a contact force that is effective between the outer cylindrical surfaces of two adjacent rollers 102; 102′; 103; 103′; 106, for example, via a carrier substrate 006 that is acted-on or coated on at least one side or via the powdered material 004; 004′, can be varied or adjusted. In a preferred variant, one of the two frame sections 128.1; 128.2; 128.3; 128.4 can be arranged in a spatially fixed manner, for example, on a platform of the coating device 100; 100* or in or on a higher-level frame structure 145, for example a base plate 145, fixed to the frame, and the other of the at least two frame sections 128.1; 128.2; 128.3; 128.4 can be adjustable via a bearing mechanism 112; 113 within at least one adjustment range along the relevant adjustment direction, and in another variant, both the one and the other of the adjacent frame sections 128.1; 128.2; 128.3; 128.4 can be adjustable along the adjustment direction. The frame sections 128.1; 128.2; 128.3; 128.4 each comprise in particular two frame walls 131.1; 131.2; 131.3; 131.4, which are rigidly, even though possibly detachably, connected to one another via one or more cross-connections, for example one or more crossbars 136; 137. A movement of a frame section 128.1; 128.2; 128.3; 128.4 that is adjustable in the above manner can thus take place as a whole, including the roller 102; 102′; 103; 103′; 106 or rollers 102; 102′; 103; 103′; 106 carried by the same.

In an above-described embodiment of an application unit 101 for only a one-sided application, that is, comprising a first roller 102, for example the metering roller 102, a second roller 103, for example the laminating roller 103, and a pure counter-pressure roller 106, it is possible in a first variant embodiment, which, however, is not shown, for example, for the first and second rollers 102; 103 to be mounted together in or on frame walls 131.1 of a first frame section 128.1, and the counter-pressure roller 106 can be mounted in or on frame walls 131.2 of a second frame section 128.2. For this purpose, for example, the first roller 102 is mounted in or on the first frame section 128.1 so as to be adjustable in the contact force thereof via above-described positioning means 109; 111 in a force-based manner, for example within the above meaning force-based, force-controlled by open loop control or force-controlled by closed loop control, and/or in the distance thereof with respect to the second roller 103 in a position-based manner, for example within the above meaning positionable, position-controlled by open loop control or position-controlled by closed loop control (with the “and” variant in the ‘and/or’ expression here denoting a selectively force-based or position-based adjustable combined positioning drive). In an alternative variant, for example, the second roller 102; 103 and the counter-pressure roller 106 are mounted in or on frame walls 131.1 of a first frame section 128.1 and the first roller 102, for example metering roller 102, is mounted on frame walls 131.3 of a separate frame section 128.3. For this purpose, for example, the counter-pressure roller 106 is mounted in or on the first frame section 128.1 so as to be adjustable in the distance thereof with respect to the second roller 103 via above-described positioning means 109; 111 in a force-based manner, for example, force-defined, force-controlled by open loop control or force-controlled by closed loop control, and/or in a position-based manner, for example, positionable, position-controlled by open loop control or position-controlled by closed loop control.

In a preferred variant of an above-described embodiment of an application unit 101 for only a one-sided application, the first, the second and the counter-pressure rollers 102; 103; 106 are mounted in or on frame walls 131.1; 131.2; 131.3 of a respective dedicated frame section 128.1; 128.2; 128.3. For example, one of the frame sections 128.1; 128.2; 128.3, preferably the frame section 128.2 carrying the second roller 103, is arranged so as to be fixed in space or fixed to the frame, and the two other frame sections 128.1, 128.2, 128.3 are mounted so as to be movable relative thereto along the adjustment direction. For example in FIG. 18, for example the right frame section 128.4 including a frame wall 131.4 and the roller 102′ may be dispensed with for this embodiment, wherein the roller 103′ is then designed as a pure counter-pressure roller 106.

In a preferred embodiment of the application unit 101; 101′ in the form of a double application unit 101; 101′ for the simultaneous two-sided application, which is shown, for example, in FIGS. 8 to 12 and FIG. 15, FIG. 16 and FIG. 17, in a first variant, which is not shown, the two roller pairs made up of metering and laminating rollers 102; 103; 102′; 103′ can be mounted in pairs in a respective frame section 128.1, 128.2, wherein the two frame sections 128.1, 128.2 are able to vary the position thereof with respect to one another in the above-described manner in such a way that a distance between the axes of rotation R103; R103′ of the two rollers 103; 103′ forming the laminating gap 107 with one another and/or a contact force that is indirectly or directly effective between the outer cylindrical surfaces can be varied. One of the frame sections 128.1; 128.2 can be fixed in space or fixed to the frame, and the other can be mounted so as to be movable in the adjustment direction. The metering rollers 102; 102′ are, for example, mounted in the particular frame section 128.1; 128.2 via above-described positioning means 109; 111 in a force-based manner, for example, force-defined, force-controlled by open loop control or force-controlled by closed loop control, and/or in a position-based manner, for example, positionable, position-controlled by open loop control or position-controlled by closed loop control, so as to be adjustable in the distance with respect to the respective adjacent laminating roller 103. In an alternative variant, which is likewise not shown, the roller pair 103; 103′ forming the laminating gap 107; 107′ can be mounted in a first, shared frame section 128.1, and the two metering rollers 102; 102′ can each be mounted in a dedicated frame section 128.3; 128.4, wherein the first frame section 128.2 is, for example, fixed in space or fixed to the frame, and the two other frame sections 128.3; 128.4 are movable relative to the first frame section 128.1 in such a way that, in the above-described manner, a distance between the axes of rotation R102; R103; R102′; R103′ in each case between the first and second rollers 102; 103; 102′; 103′ and/or a contact force that is indirectly or directly effective between the outer cylindrical surfaces can be varied. One of the laminating rollers 103; 103′ can be mounted so as to be adjustable via above-described positioning means 109; 111 in a force-based manner, for example, force-defined, force-controlled by open loop control or force-controlled by closed loop control, and/or in a position-based manner, for example, positionable, position-controlled by open loop control or position-controlled by closed loop control, in the distance with respect to the other laminating roller 103.

In a preferred embodiment of the application unit 101; 101′ in the form of a double application unit 101; 101′ for the simultaneous two-sided application, however, all four or, in the case of, for example, further intermediate rollers, all rollers 102; 103; 102′; 103′ are mounted in frame walls 131.1; 131.2; 131.3; 131.4 of respective dedicated frame sections 128.1; 128.2; 128.3; 128.4. For example, one of the frame sections 128.1; 128.2; 128.3; 128.4, preferably a frame section 128.1 carrying a second or laminating roller 103, in particular the laminating roller 103 of the first application unit 101, is arranged so as to be fixed in space or fixed to the frame, and the remaining frame sections 128.2; 128.3; 128.4 are mounted so as to be adjustable along an adjustment direction that preferably extends perpendicular to an axis of rotation R103; 103′ of a laminating roller 103; 103′, in particular the laminating roller 103 that is mounted so as to be fixed in space or fixed to the frame, and/or rectilinearly, in particular along an adjustment direction that extends horizontally.

Preferably, at least the roller 102 of the first application unit 101 which is the first roller and/or follows upstream, with respect to the material stream, from the roller 103 of the first application unit 101 that is involved in the formation of the second gap 107; 107′ is mounted in or on a third frame section 128.3, which can be displaced along an adjustment direction extending perpendicular to the axis of rotation R102; R103; R102′; R103′; R106; R106′ of at least the roller 103 of the first application unit 101 that is involved in the formation of the second gap 107. If a double application unit 101; 101′ is present, in an advantageous embodiment additionally the roller 102 of the second application unit 101′ which follows upstream, with respect to the material stream, from laminating roller 103′ of the second application unit 101′ that is involved in the formation of the second gap 107; 107, in particular the first roller, is mounted in or on a fourth frame section 128.4, which can be displaced along an adjustment direction extending perpendicular at least to the axis of rotation R103 of the roller 103 mounted in or on the frame section 128.1 that is fixed in space or fixed to the frame.

For all described embodiments comprising movable frame sections 128.2; 128.3; 128.4, these can preferably be moved on linear guides 112; 112′, wherein dedicated guide sections 138, for example rail portions 138, can be provided for each of the movable frame sections 128.2; 128.3; 128.4, or continuous guides 138 or rails 138 can be provided for two or more displaceable adjacent frame sections 128.2; 128.4. The frame sections 128.2; 128.3; 128.4 can comprise support feet 139 on the bottom side, which are designed so as to correspond to the guide sections 138 or guides 138 and, for example, comprise sliding or roller bodies.

The rollers 102; 102′; 103; 103′; 106 can generally be mounted so as to be rotatable on a respective axis that is rotationally fixed in the frame walls 131.1; 131.2; 131.3; 131.4 of the respective frame sections 128.1; 128.2; 128.3; 128.4 via corresponding bearings 151 or, advantageously, as is apparent in FIG. 18 to FIG. 22 as well as FIG. 25, FIG. 26 and FIG. 28, by way of end-face roller journals in bearings 151, in particular radial bearings 151, which in turn are arranged in or on the relevant frame walls 131.1; 131.2; 131.3; 131.4.

The mutually adjacent frame sections 128.1; 128.2; 128.3; 128.4 arranged so as to be movable relative to one another, in the preferred embodiment here, can be moved toward one another, in particular can be tensioned, and moved away from one another again or at least be relaxed again on each frame side by at least one drive means 132; 132′; 133; 133′, in particular by at least one adjustment device 141; 165 comprising a drive means 132; 132′; 133; 133′, and possibly via further means transmitting the adjusting movement or force, on each frame side, preferably by two or at least two adjustment devices 141, in particular drawing devices 141, for example in the manner of tensioning devices 141, on each frame side in the adjustment direction. The drawing devices 141 can be designed so as to be able apply not only an above-described tensile force, but, if needed, also a force that is directed in the opposite direction and/or moves the frame sections 128.1; 128.2; 128.3; 128.4 away from one another, for example, a pressure force that is effective between the frame sections 128.1; 128.2; 128.3; 128.4. The mutually facing sides of the adjacent frame sections 128.1; 128.2; 128.3; 128.4 that are arranged so as to be movable relative to one another are, for example, designed to correspond to one another in such a way that the adjacent rollers 102; 102′; 103; 103′; 106 carried by the frame sections 128.1; 128.2; 128.3; 128.4, for example with accordingly placed stop means 119, can be brought with the effective outer cylindrical surfaces thereof into a relative position desired for operation, possibly having a desired gap width b104; b104′ or a gap width b104; b104′ arising as a result of the load. What was said here with respect to the first gap 104; 104′ is to be applied accordingly for the case of a second gap 107 that can be adjusted in a position-based manner to the adjustment of the second gap 107 or the gap width b107 thereof.

In an advantageous embodiment of such an application unit 101; 101′ comprising a multi-piece frame 128, at least one positioning drive 109; 109′ effectuating the adjustment, for example, the variation of the position and/or of the contact force between the first and second rollers 102; 103; 102′; 103′ and comprising a drive means 132; 133 is designed in a position-based manner, for example, positionable, position-controlled by open loop control or position-controlled by closed loop control, or, in a particularly advantageous embodiment, can selectively be operated in a position-based manner, for example force-defined, force-controlled by open loop control or force-controlled by closed loop control, or in a position-based manner, for example, positionable, position-controlled by open loop control or position-controlled by closed loop control.

In a first variant embodiment (see, for example, FIG. 18 to FIG. 22), for example, the drive means 133 that is provided is a drive means 133 that engages on the frame section 128.3; 128.4 carrying the first roller 102; 102′ and on the frame section 128.1; 128.2 carrying the second roller 103; 103′; 106 and can be operated or is operated in a force-based manner, in particular can be operated or is operated force-controlled by open loop control or force-controlled by closed loop control, in particular a piston-cylinder system 133 that can be acted on by pressurized fluid, in particular hydraulically, as well as at least one stop means 119 that is effective between the frame section 128.3; 128.4 carrying the first roller 102; 102′ and the frame section 128.1; 128.2 carrying the second roller 103; 103′; 106 and, for example, can be set or adjusted via positioning and/or drive means 146 and/or by a servo motor 155, and possibly, for example, can be controlled by open loop control or controlled by closed loop control in the stop action thereof, which can, for example, be introduced into the adjustment path selectively and/or so as to be substantially path-limiting. The stop means 119 that is provided can generally be an arbitrary, preferably settable stop means 119, by way of which a throwing-on movement between the two relevant frame sections 128.1; 128.2; 128.3; 128.4 can be limited and preferably be set in terms of the end position. These can be, for example, one or more stops 119 based on a particular screw thread, which can be brought into a desired position, in particular can be rotated, manually or by way of a remotely actuatable positioning and/or drive means 146, possibly by way of a gear and/or by a servo motor 155. In an embodiment that is preferred here, stop means 119 that are based on a wedge gear are provided as stop means 119, for example, bars having a wedge-shaped design in opposite directions are, for example, provided as stops 119, which cooperate in pairs with mutually opposing sides and have a thickness that varies in opposite directions. For the adjustment, it is sufficient when, for example, one of the wedge-shaped bars can be displaced by a suitable positioning and/or drive means 146, for example a motor-driven positioning drive 146 that is formed, for example, by a screw drive, or a motor-driven toothed rack that is displaced or can be displaced in the longitudinal direction of the bar pair against the other. If the length of the cooperating sides is large and there is a small gradient in the thickness, it is possible to achieve a very fine variation of the end position to be defined by the stop means 119 when using such stop means 119.

In an advantageous embodiment, at least one positioning drive 109; 109′ that effectuates the variation and/or the contact force between the two rollers 103; 103′; 106; 106′ forming the second nip 107; 107′ between each other and that comprises a drive means 132; 133 is designed to be force-based or, in a particularly advantageous embodiment, can selectively be operated in a force-based or position-based manner. For example, the drive means 133 that is provided is a drive means 133 that indirectly or directly engages on the two frame sections 128.1; 128.2, which carry the rollers 103; 103′; 106; 105′ that form the second nip 107; 107′ between each other, and can be operated or is operated in a force-based manner, in particular can be operated or is operated force-controlled by open loop control or force-controlled by closed loop control, in particular a piston-cylinder system 133 that can be acted on by pressurized fluid, preferably hydraulically, as well as at least one stop means 119 that is effective between these two frame sections 128.1; 128.2 and can be set via positioning and/or drive means 146. The stop means 119 can be designed in a manner described above, or deviating therefrom, but at least so as to be adjustable, for example controllable by open loop control or controllable by closed loop control, in the stop action thereof.

The drive means 133 can engage indirectly or directly on the relevant two adjacent frame sections 128.1, 128.2; 128.3, 128.4 or rollers 102; 103; 102′; 103′ in that in each case an active-side end of the drive means 132; 133, for example the piston or the piston rod 142 extending the same, for example of a cylinder-piston system 132; 133 that can be acted on by pressurized fluid, in particular hydraulically, for example can be operated or is operated in a force-controlled or closed loop position-controlled manner, on the one hand and/or an end of the cylinder 166 on the other hand is connected, for example directly, to the particular frame section 128.1; 128.2; 128.3; 128.4 or the respective rollers 102; 103; 102′; 103′. However, a connection can also be implemented indirectly, for example via further means transmitting the adjustment movement and/or the adjustment force, for example a one-piece or multi-piece transmitting member, for example in the manner of a pull and/or push rod, which can be subjected to tensile stress and/or compressive stress and extends or continues the piston 167 or the piston rod 142 on the one hand and/or possibly the cylinder 166 on the other hand. The respective connection of the adjustment device 141 comprising the drive means 133 or directly of the drive means 133 themselves, for example via compression and/or tension plates 143; 144, within the present meaning determines an engagement surface for the action of the drive means 132; 133. The two active-side ends of the adjustment device 141 or of the drive means 133 comprised thereby are preferably connected to the respective frame sections 128.1; 128.2; 128.3; 128.4, viewed in the adjustment direction, not only in a tension-proof, but also compression-proof manner. In addition to enabling a movement toward one another, this also enables an active movement away from one another.

In a preferred embodiment, at least one adjustment device 141; 165 which comprises a drive means 132; 133 and effectuates a relative adjustment movement and/or tensile force between the two frame sections 128.2; 128.3, 128.4, in particular an above-described drawing device 141; 165, for example in the manner of a tensioning device 141; 165, engages between two or two respective frame sections 128.1, 128.2; 128.3, 128.4 on the frame sections 128.1, 128.2; 128.3, 128.4 so as bring the two rollers 102; 103; 102′; 103′ or the mutually adjacent frame sections 128.1, 128.2; 128.3, 128.4 into a relative position or throw-on position as it relates to a predefined gap width b104_{target} and/or contact force by way of a force that, between the frame sections 128.1, 128.2; 128.3, 128.4, is directed toward each other and maintain these at a constant level, possibly against a force that is directed counter to the throwing-on direction by the powdered material 004 or the coated carrier substrate 006, with this relative position or contact force, with the exception of a deviating specification with respect to the relative position and/or contact force to be adhered to. This means that a drawing force can be introduced between the frame sections 128.1, 128.2; 128.3, 128.4 by the drive means 132; 133 that, for example, can be adjusted or controlled by open loop control or controlled by closed loop control in a position-based or force-based manner, which moves the frame sections 128.1, 128.2; 128.3, 128.4 or rollers 102; 103; 102′; 103′ to, or maintains these at, a desired gap width b104_{target} in the case of a position-based adjustment or a desired contact force in the case of a force-based adjustment, possibly counter to the opposing forces caused by the material 004 or the product strand 002. In contrast to applying a pure push force to one of the two rollers 102; 103; 102′; 103′ or frame sections 128.1; 128.2; 128.3; 128.4 from an outer side, this has the advantage that the contact force acts only on the relevant roller gap 104; 104′; 107; 107′ and does not perhaps, for example by a possibly resultant pushing of the second roller 103 against a further roller 103′; 106, additionally and uncontrolled apply a force to an adjacent further, for example second, gap 107; 107′, viewed in the adjustment direction. The at least one drive means 132; 133 or the adjustment device 141; 165 comprising the drive means 132; 133 engages with the two active sides or active ends thereof on the mutually adjacent rollers 102; 103; 102′; 103′ or frame sections 128.1; 128.2; 128.3; 128.4, that is, in particular, in such a way that, for adjusting the relevant gap 104; 104′; 107 between the adjacent rollers 102; 103; 102′; 103′, they apply adjustment forces that are directed toward each other to these or the frame sections 128.1; 128.2; 128.3; 128.4 thereof, that is, introduce a tensile force effectuating the movement and/or contact force between the two frame sections 128.1; 128.2; 128.3; 128.4, which provides the above-described advantage.

In the advantageous solution proposed here, thus one or more, for example aforementioned, adjustment devices 141 comprising a drive means 132; 133, between two or respective two adjacent rollers 102; 103; 102′; 103′ or frame sections 128.1; 128.2; 128.3; 128.4, engage with the respective active ends thereof, that is, the ends of the drive means 132; 133 or of the adjustment device 141 that can be varied, by activation, in terms of the distance with respect to one another and/or in the drawing force that is exerted between them, on the adjacent rollers 102; 103; 102′; 103′ or frame sections 128.1; 128.2; 128.3; 128.4, so that a drawing force effectuating a relative movement between the rollers 102; 103; 102′; 103′ or frame sections and/or a contact force between the rollers 102; 103; 102′; 103′ can be introduced for a, for example position-based or force-based, throwing-on by the same between the two adjacent rollers 102; 103; 102′; 103′ or frame sections, that is, so that the adjustment device 141 or the drive means 132; 133 pulls the two rollers 102; 103; 102′; 103′ or frame sections 128.1; 128.2; 128.3; 128.4 toward one another for a, for example position-based or force-based, throwing-on.

In the embodiments according to FIG. 18 to FIG. 22, a drive means 133 that can be operated or is operated in a force-based manner, in particular can be operated or is operated force-controlled by open loop control or force-controlled by closed loop control, and/or a drive means 133 designed as a cylinder-piston system 133 that can be acted on by pressurized fluid, in particular hydraulically, are preferably provided for the adjustment of both the first and the second gap 104; 104′; 107; 107′. Such a cylinder-piston system 133 is preferably designed or configured so as to be able to apply a force of at least 20 kN, preferably at least 50 kN, in the relevant roller gap 104; 104′; 107; 107′. Preferably, at least two such cylinder-piston systems 133 that are effective between two adjacent frame sections are provided on each frame side, wherein, for example, the above-described force or linear force can be applied by these collectively.

The rollers 102; 102′; 103; 103′; 106 can generally be mounted so as to be rotatable on a respective shaft that is rotationally fixed in the frame walls 131.1; 131.2; 131.3; 131.4 of the respective frame sections 128.1; 128.2; 128.3; 128.4 via corresponding bearings 151 or, advantageously, as is shown in FIG. 18 to FIG. 22 and FIG. 25, FIG. 26 and FIG. 28, by way of end-face roller journals in bearings 151 designed as radial bearings 151, wherein the bearings 151 in turn are provided or arranged in or on the relevant frame walls 131.1; 131.2; 131.3; 131.4. In both instances, the rollers 102; 102′; 103; 103′; 106 or the roller journals thereof or shafts, viewed in the axial direction, are effectively radially supported over a width b151 of the bearing 151, which is determined by one or more rows of bearing elements that support the roller journals or shafts against the relevant frame section 128.1; 128.2; 128.3, 128.4. In the case of the radial bearing 151 enabling a rotation, this can be one or more rows of roller bodies or sliding surfaces arranged in the circumferential direction. The effective support width b151 results from the distance between the two outer edges of the single bearing element row or the two outer bearing element rows.

In a particularly advantageous embodiment, for example with respect to minimal deformation, on two or respective two of the adjacent frame sections 128.1; 128.2; 128.3; 128.4 that can be varied in the distance with respect to one another and/or in the contact force against one another, an adjustment device 141; 165 engages with the two active ends thereof, the distance between which can be varied, on one of the two frame sections 128.1; 128.2; 128.3; 128.4 in such a way that the same plane G extending perpendicular to the axis of rotation R102; R103, R102′; R103′ of at least one of the rollers 102; 103; 102′; 103′; 106; 106′ mounted on the two adjacent frame sections 128.1; 128.2; 128.3; 128.4, in particular extending within the frame wall width, intersects at least the respective support width b151, viewed in the axial direction, of the rollers 102; 103; 102′; 103′; 106; 106′ mounted in the two frame sections 128.1; 128.2; 128.3; 128.4 as well as an engagement surface that is formed in the region of the active ends with the relevant respective frame section 128.1; 128.2; 128.3; 128.4, for example the cross-section of a compression and/or tension plate 143; 144 supported, at the end face of the adjustment device 141; 165, on the relevant frame section 128.1; 128.2; 128.3; 128.4 or attached thereto, in particular even a working cross-section, that is, the effective piston or cylinder inner cross-sectional surface, in the cylinder 166 of the drive means 133 formed, for example, by a cylinder-piston system 133. This ensures that the tensile stress engages in the alignment of the support and tilting in the bearing 151 caused by the tensile stress is avoided.

In a preferred embodiment, in all embodiments of the application units 101; 101′ or double application units 101; 101′ shown both in connection with the frame sections 128.1; 128.2; 128.3; 128.4 and in another embodiment of a single-piece or multi-piece frame 128, the rollers 102; 103; 102′; 103′; 106; 106′, at least in the operating position, are arranged with respect to one another in such a way that the axes of rotation R102; R103, R102′; R103′ thereof intersect the same connecting line in at least a radial alignment. Such an embodiment shall also be understood for arrangements comprising one or more rollers 102; 103; 102′; 103′, 106; 106′ that are slightly inclined with respect to one another in the described manner, within the above meaning of a “planar arrangement,” in which the rollers 102; 103; 102′; 103′, 106; 106′, at least along the same connecting line, are supported, preferably in a central region of the respective roller lengths.

For the force-based drive means 133 or positioning drives 133, the force that can be applied by the drive means 133 can preferably be adjusted, in particular controlled by open loop control or controlled by closed loop control. In the case of cylinder-piston systems 133 that can be operated with pressurized fluid, for example with compressed air or preferably with a pressurized liquid (for example oil under overpressure), in particular the pressure of the pressurized fluid provided by a pressure source can be set, in particular controlled by open loop control or controlled by closed loop control, at least in an adjustment range required for operation, for example, via a pressure control valve or a pump that can be controlled by open loop control or by closed loop control with respect to the pressure to be provided on the output side.

For the case of the second roller gap 107; 107′ provided or controlled by open loop control or closed loop control in a force-based manner and the first roller gap 104; 104′ adjusted or adjustable, controlled by open loop control or closed loop control in a position-based manner, at least the respective first roller 102; 102′ or the frame section 131.3; 131.4 thereof is not stationary within the scope of production operation, viewed in the adjustment direction, but is mounted so as to be movable or free at least within the adjustment range, for example, of at least ±5 μm. In this way, it is possible for the first roller 102; 102′ to move up in the event that the distance d104; d104′ between the first and second rollers 102; 103; 102′; 103′ fluctuates due to possibly minor differences in material thickness levels.

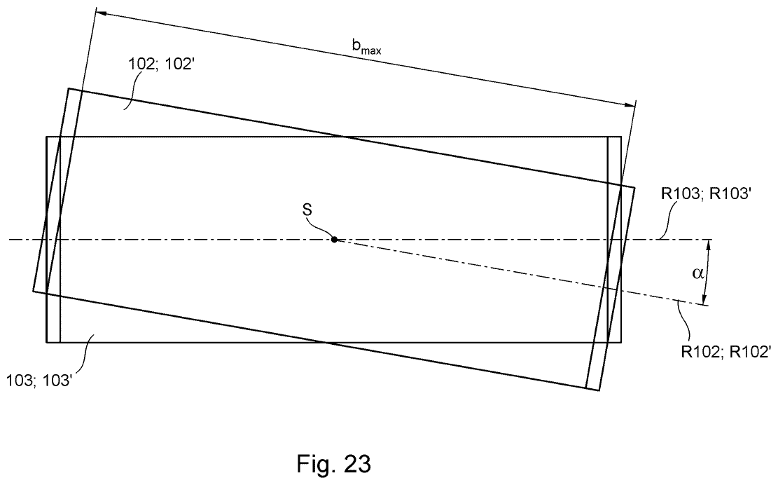

Generally independently of, but advantageously in conjunction with one of the above-described embodiments, variants, configurations, specific embodiments or designs of the application units 101; 101′ and/or coating devices 100; 100* and/or machine configurations and/or frames 128, the first and second rollers 102; 103; 102′; 103′ in a particularly advantageous embodiment are mounted, or can be mounted, so as to be inclined with respect to one another, that is not parallel, with the R102; R103, R102′; R103′ thereof, in general or in at least one operating situation (see, for example, sketch from FIG. 23). However, they preferably extend in two parallel planes.

If such a mounting is to take place in general and without any possibility for variation, the inclined arrangement can already be taken into consideration in the arrangement of the bearings 151 in a one-piece or multi-piece frame 128.1, 128.2, 128.3, 128.4.

The axes of rotation R102; R103; R102′; R103′, however, can preferably be inclined with respect to one another, that is, can be inclined out of a parallel position into a position with respect to one another or at differing angles of inclination «. For example, one of the rollers 102; 102′; 103; 103′, in particular the second roller 103, 103′, over the course of the orientation of the R102; R102′, R103; R103′ thereof, is stationary in space during operation, even if it may be movable parallel in space without changing the inclination, and the other of the rollers 102; 102′; 103; 103′, in particular the first roller 102; 102′, is mounted with the axis of rotation R102; R102′ being inclined with respect to the orientation of the R102; R102′, R103; R103′ and/or with respect to the course of the axis of rotation R102; R102′, R103; R103′ of the other roller 103; 103′; 102; 102′, in particular second rollers 103; 103′. The pivoting preferably takes place about an actual or imaginary pivot axis which, for example, lies in a plane encompassing the axes of rotation R102; R102′, R103; R103′ of the two rollers 102; 103; 102′; 103′ and/or preferably extends perpendicular to the axes of rotation R102; R103; R102′; R103′ of both the first and the second roller 102; 103; 102′; 103′ and/or intersects the axes of rotation R102; R103; R102′; R103′ thereof.

Such an inclinability can generally be directly implemented via a special design of the mount accommodating the inclinable roller 102; 102′; 103; 103′ in the frame 128. For example, a bearing 151, for example a bearing 151 encompassing an eccentric, can be provided, for example, on at least one side, preferably on both sides, by way of which a radial position of the relevant axis of rotation R102; R103, R102′; R103′ in the bearing 151 can be varied. As an alternative, a radially movable bearing can be provided on one side, or preferably on both sides, on the frame 128, the movement of which can be used to radially vary the relevant bearing points.

Preferably, the first and the second roller 102; 103; 102; 103′ of the same application unit 101; 101′, for example on the first and/or second application units 101; 101′, corresponding to, for example, an embodiment described above or below of the multi-piece frame 128, are mounted in or on differing frame sections 128.1; 128.2; 128.3; 128.4, wherein one of the two frame sections 128.1; 128.2; 128.3; 128.4, preferably the frame section 128.3; 128.4 carrying the first roller 102; 102′, overall, that is, including the assigned frame walls 131.1, 131.2, 131.3, 131.4, one or more crossbars 136; 137 and the roller 102; 103; 102′; 103′ mounted therein, can be pivoted about a pivot axis S that extends perpendicular to the axis of rotation R103; R103; R102′; R103′ and intersects the same on at least the maximum effective width of the roller 102; 103; 102′; 103′ (see, for example, FIG. 18 to FIG. 20 and FIG. 22 to FIG. 25).

In an advantageous embodiment, the pivotable frame section 128.1; 128.2; 128.3; 128.4 is mounted on at least two bearing points 153 that are spaced apart from one another on at least two circular arcs K extending in the circumferential direction about the pivot axis S, wherein they are located in a radius R_{S} on a circular arc K that extends about the pivot axis S and/or determines the position of the pivot axis (see, for example, FIG. 24). The bearing points 153 are, for example, formed by sliding bodies or preferably roller bodies 153, for example rollers, which are arranged in two bearing blocks 147 that are spaced apart from one another. The rollers can be rotated about an axis that is parallel to the pivot axis S. The radius R_{S} of the circular arc K is, for example, larger than half the width, in particular than the total maximum usable width, of the roller 102; 103; 102′; 103′ pivoted with the frame section 128.1; 128.2; 128.3; 128.4. In this way, a large adjustment path can be implemented for minute changes in the inclination.

The bearing blocks 147 are, for example, mounted on guides 138 extending perpendicular to the axes of rotation R102; R103, R102′; R103′ of the roller 102; 103; 102′; 103′ carried by the pivotable frame section 128.1; 128.2; 128.3; 128.4 and can be displaced thereon together with the frame section 128.1; 128.2; 128.3; 128.4 mounted thereon in a direction perpendicular to the axis of rotation R102; R103; R102′; R103′.

In a preferred embodiment, the bearing points 153, for supporting the pivotable frame section 128.1; 128.2; 128.3; 128.4, cooperate with the bearing surfaces 154 facing the bearing points 153, which are arranged in a lower region of the frame section 128.1; 128.2; 128.3; 128.4, in particular in the region of the lower end of the two relevant frame walls 131.1, 131.2, 131.3, 131.4 and/or, at least within an adjustment range for the pivoting movement, viewed in the circumferential direction of the circular arc K, comprise a surface that is supported on at least one bearing point 153 and has a circular arc-shaped curved profile at least within an adjustment range. The radius of curvature preferably corresponds to the aforementioned radius R_{S}.

While, generally, a pivoting can be effectuated manually, an in particular remotely actuatable drive means, by way of which the relevant frame section 128.1; 128.2; 128.3; 128.4 can be pivoted is preferred.

The pivoting or the angle of inclination α involves, for example, angles that range between 0.1° and 2.0°, in particular between 0.5° and 1.5°, preferably 1.0°. The adjustment range for the pivoting can then, for example, be a range of 0° to at least 1°, advantageously of 0° to at least 1.5°, or even of 0° to 2.0°, or possibly more.

What was said above with respect to the frame section 128.1; 128.2; 128.3; 128.4 that can be pivoted about the pivot axis S is to be applied to all described embodiments with respect to the frame section 128; 128.1; 128.2; 128.3; 128.4, provided that the frame section 128.1; 128.3 of the first or second roller 102; 103, in particular of the first roller 102, of a simple application unit 101, that is, an application unit provided for the one-sided application, or the frame section 128.1; 128.2; 128.3; 128.4 of the first or second roller 102; 103, in particular of the first roller 102, of both application units 101; 101′ of a double application unit 101; 101′, can be pivoted in the above-described manner and is advantageously designed with above-described means.

Regardless of whether the roller 102; 103; 102′; 103′ is pivoted together with or without the frame section 128.1; 128.2; 128.3; 128.4, the pivot axis S is preferably located in a plane encompassing the axes of rotation R102; R103; R102′; R103′ of the two adjacent rollers 102; 103; 102′; 103′ and/or extends perpendicular at least to the axis of rotation R102; R103; R102′; R103′ of the pivotable roller 102; 103; 102′; 103′, advantageously to the axes of rotation R102; R103; R102′; R103′ of both the first and the second roller 102; 103; 102′; 103′ and/or intersects at least the axis of rotation R102; R103; R102′; R103′ of the pivotable roller 102; 103; 102′; 103′, advantageously the axes of rotation R102; R103; R102′; R103′ of both the first and the second rollers 102; 103; 102′; 103′. Advantageously, the pivot axis S of the pivotable roller 102; 102′; 103; 103′ preferably intersects the axis of rotation R102; R103; R102′; R103′ of the pivotable roller 102; 103; 102′; 103′, advantageously the axes of rotation R102; R103; R102′; R103′ of both the first and the second rollers 102; 103; 102′; 103′, in the central region, that is, for example, no more than 15% of the usable length spaced apart from the center, or in particular at the level of the center of the maximum usable roller width. In the shown and preferred specific embodiment, the pivoting movement of the axis of rotation R102; R103, R102′; R103′ takes place in a plane extending perpendicular to the pivot axis S, without the plane moving in the direction of the pivot axis during the pivoting and/or without the position of the pivot axis in space changing. This allows a pivoting that is independent of the throwing-on and throwing-off to be achieved, and vice versa.

In an alternative embodiment of a positioning drive 109; 109′ to the above embodiment, by way of which the rollers 102; 102′; 103; 103′ or roller gaps 104; 104′; 107; 107′ to be adjusted, in particular of the relevant or respective first roller 102; 102′, and/or the gap width b104; b104′ between the first and second rollers 102; 103; 102′; 103′ can be adjusted in a position-based manner, for example is operated or operable in a position-controlled manner by open loop control or in a position-controlled manner by closed loop control, the positioning drive 109; 109′ adjusting the first and second rollers 102; 103 with respect to one another comprises one or more drive means 132 that are operated or operable in a position-controlled manner by open loop control or in a position-controlled manner by closed loop control, which, for example, can assume a defined and/or specifiable position on its own or by appropriate activation or control.

In a particularly advantageous embodiment shown here, the drive means 132, which is operated or can be operated in a position-controlled manner by open loop control or in a position-controlled manner by closed loop control, of the positioning drive 109 that can be adjusted in a displacement-based or position-based manner is formed by a drive means 132, the position of the output means of which, for example of a rotor or in particular a piston 167, is controlled by open loop control and/or by closed loop control or can be controlled by open loop control and/or by closed loop control via a manipulated or controlled variable and which can be actuated by a pressurized fluid, in particular hydraulically, in particular by a hydraulically actuated cylinder-piston system 132 which is controlled by open loop control and/or closed loop control or is controllable by open loop control and/or closed loop control with respect to the position of the piston 167, the piston position for short, in terms of a manipulated or controlled variable formed by the gap width b104 or by a variable correlating with the gap width b104 and/or representing the same, serving as an actuator (see, for example, FIG. 25 and FIG. 26). Generally, regardless of whether an external variable, such as, for example, a target gap width b104_{target} or another variable correlating therewith and/or representing the same, such as, for example, the piston position itself, is used as a target or command variable for the positioning of the piston 167, the piston 167 of the cylinder-piston system 132, viewed in the adjustment direction, can be varied in a defined manner with respect to the position thereof by being controlled by open loop control and/or controlled by closed loop control via the target or command variable, and can, in particular, be maintained in the position assumed as a result of the variation, for example, within the working zone regardless of a force action on the piston that, for example, varies during this process in the movement direction thereof, until, for example, a renewed variation is prompted deliberately on the input side by a new target value specification. The piston 167 can, but does not have to, be controllable by open loop control or closed loop control with respect to the absolute position thereof, but must at least be positionable in the position thereof in a defined manner by an associated open loop and/or closed loop control device 156 and maintainable in this position by appropriate activation or control. The cylinder-piston system 132 in particular has a double-acting design, that is, pressurized fluid can act on the piston 167 from both sides.

A variable correlating with the gap width b104 and/or representing the same can generally be any measured variable that describes the magnitude of the adjustment movement, a change in position of a measuring point or a distance that changes during the adjustment, such as, for example, the piston position, a distance between measurement points fixed on the roller or a moving point in the drive train.

In particular, the positioning drive 109, for the displacement-based or position-based adjustment of the gap 104, ultimately comprises as the actuator, that is, as the drive means 132, a hydraulic cylinder-piston system 132, which can be operated or is operated, in particular is controlled by open loop control or closed loop control, via a final control element, formed by a positioning means 164; 164*, in terms of a target or command variable formed by the gap width b104 or correlating therewith and/or representing the same.

The hydraulically actuated cylinder-piston system 132, which is controlled by open loop control and/or closed loop control with respect to the piston position in terms of the target or command variable, can generally be controlled or controllable by open loop control toward a target gap width b104_{target} in terms of a specified or specifiable gap width b104 or a variable representing the gap width b104 as part of an open loop control system S_{b} or, as part of a closed control loop R_{b}, can be controlled or controllable by closed loop control toward a target gap width b104_{target} in terms of a specified or specifiable gap width b104 or a variable representing the gap width b104 (see, for example, FIG. 26 to FIG. 29).

Preferably, the positioning means 164; 164*, serving as the final control element, together with the cylinder-piston system 132, serving as the actuator, including a sensor system 157 for detecting the gap width b104 or a variable correlating with the gap width b104 and/or representing the same, including the positioning means 164; 164* and including control means 171, for example, a controller 171 for short, are integral parts of a closed control loop R_{b}, by way of which the gap width b104, serving as a command variable, can be controlled so as to assume and maintain a gap width b104. The drive comprising the cylinder-piston system 132, the positioning means 164; 164* and the controller 171 forms, in the entirety thereof, for example, a hydraulic drive that, here, is in particular controlled or controllable by closed loop control with respect to a positioning or position, in particular a servo-hydraulic actuator or drive. The term control means 171 or controller 171 here, in addition to the controller circuit or logic itself, shall potentially also encompass the supply and amplifier stages, and the like, required for this purpose. The positioning means 164; 164*, together with the control means 171 acting thereon, can be summarized under term of a control device 156 and, for example, be shown partly simplified in the figures.

With open loop control, a defined piston position that is specified to the drive means 132, for example, via control means of an open loop control system S_{b} or a defined variation of the assumed piston position can, for example, be enabled in that an integrated position sensor system is provided in the cylinder-piston system 132 itself, by way of which the specification supplied via the open loop control system S_{b} can be implemented.

In the case of a hydraulically actuated cylinder-piston system 132 that is controlled by open loop control or closed loop control with respect to the piston position in terms of another, for example, external variable, for example in terms of the gap width b104, in terms of a layer thickness d003 or a grammage FG, this cylinder-piston system is integrated into a corresponding open loop control system S_{b}; S_{F}; S_{d}; S″_{d} or into a corresponding closed control loop R_{b}; R_{F}; R_{d}; R″_{d} with a corresponding external sensor system or an external measuring system. The specified target gap width b104_{target} or the piston position is then accordingly varied via the open loop control system S_{b}; S_{F}; S_{d}; S″_{d} or closed control loop R_{b}; R_{F}; R_{d}; R″_{d} relating to the external variable.

Regardless of whether the target gap width b104_{target} or a variable correlating therewith and/or representing the same is used as the target or command variable for positioning the piston 167, the drive means 132 operated or operable in a position-controlled manner by open loop control or closed loop control is preferably formed by the aforementioned hydraulically actuated or actuatable cylinder-piston system 132 comprising at least one cylinder 166, in which a piston 167 movable in the cylinder 166 fluidically separates at least two chambers 168; 169 from one another. The piston 167 acts on a piston rod 142 that is guided at the end face out of the cylinder 166 via a suitable gasket and has a one-piece design or can be extended in a tension-proof and compression-proof manner by one or more pull and/or push rods.

Regardless of whether the gap width b104 in the form of a target gap width b104_{target} or a variable representing the same and/or correlating therewith and/or representing the same is used as the target or command variable for the positioning of the piston 167, in the embodiment that is preferred here of a hydraulically actuated drive means 132, in particular cylinder-piston system 132, that is controlled by open loop control and/or closed loop control with respect to a piston position in terms of an aforementioned target or command variable, the chambers 168; 169 separated from one another by the piston 169 can be selectively acted on by an increased amount or a decreased amount of pressurized fluid via a respective pressurized medium line 158; 159 from a positioning means 164; 164*, in particular in a metered and/or defined manner, so that the piston position or positioning, depending on the inflow and outflow in the chambers 168; 169, can be displaced in a defined manner in the cylinder 166, and, with this, the piston rod 142 protruding from the cylinder 166 or the, possibly extended, active end thereof, wherein, for example, the cylinder 166 engages indirectly or directly on one of the rollers 102; 103 forming the first gap 104, for example on the first roller 102, and the piston rod 142, possibly via an extension, indirectly or directly engages on the other roller 103; 102 of the adjacent roller pair 102; 103, for example on the second roller 103, or vice versa. In doing so, the effective length or change in the effective length of the drive means 132, in particular of the cylinder-piston system 132, due to a change in position of the piston 167 in the cylinder 166 is important, and with this the change in distance between the points of engagement of the drive means 132 or of the adjustment device 141 comprising the same on the two rollers 102; 103 or the frame sections 128.1; 128.2; 128.3; 128.4 thereof.

If necessary, that is, if adjustment is required, additional pressurized fluid can selectively act on the respective chamber 168; 169 via the positioning means 164; 164*, wherein pressurized medium is withdrawn from the other chamber 169; 168 or is discharged therefrom by displacement corresponding to the volume to be released.

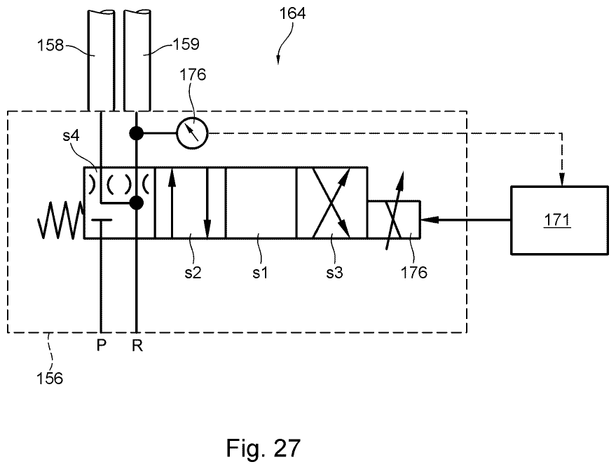

In an advantageous first embodiment (see, for example, FIG. 26 and FIG. 27), the positioning means 164 effective as a final control element can be formed by an adjustable or switchable valve 164, in particular multi-way valve 164, for example, directional valve 164 for short, by way of which, depending on the selected switching state s0; s1; s2; s3, additional pressurized fluid from a connected pressurized fluid source P acts on or can act on none of the chambers 168; 169 in a first switching state s1, for example a holding state s1, or on the one chamber in a second switching state s2, for example a first conducting state s2, or on the other chamber 168; 169 in a third switching state s3, for example a second conducting state s3, while preferably at the same time the other chamber 169; 168 is or can be accordingly relieved by a transfer into a reservoir R. Preferably, the compressed fluid, that is, hydraulic working fluid that is under overpressure, for example a hydraulic oil, can be fed from the reservoir R, which, for example, is at the ambient pressure level or at least at a lower pressure level compared to the working pressure level in the cylinder 166, to the compressed fluid source P, for example a compressed medium container, for example via a corresponding pump or a compressor. The first or holding switching state s1, which relates to a holding of the state that has been reached, shall also encompass an embodiment in which in both chambers 168; 169 the same, in particular minor and/or possibly adjustable flow is enabled, possibly so as to compensate for losses due to leaks, and thereby maintain the assumed piston position and/or the present pressure, despite leaks. In this respect, the two chambers 168; 169, when in the holding switching state s1, are not fluidically connected at all or possibly to the same, in particular low or reduced, extent to the compressed fluid source P. Since the holding switching state s1 is aimed at maintaining an equilibrium between the two chambers 168; 198 in such a way that the piston 167 moves neither to the one nor the other side, this can also be referred to as an equilibrium state here. In the holding state s1, in particular no or no significant pressure differential exists between the chambers 168; 169 so that the piston 167 rests in the assumed position.

In the second or third switching state s2; s3, a position of the piston 167, and thus the effective end connected to the piston 167, can be varied to a defined degree in the cylinder 166 by a deliberate and/or metered supply of the pressurized fluid into one of the chambers 168; 169, in particular while simultaneously discharging the pressurized fluid from the other chamber 169; 168. The distance between the effective ends of the cylinder-piston system 132, and thus, for example, the rollers 102; 103; 102′; 103′ or frame sections 128.1; 128.2; 128.3; 128.4 functionally connected thereto, can thus be varied in a defined manner, viewed in the adjustment direction.

In the case that is preferred here and described above of an adjustment device 141 engaging with the effective ends on or between the two adjacent rollers 102; 103; 102′; 103′ or the frame sections 128.1; 128.2; 128.3; 128.4 thereof, the effective length of the cylinder-piston system 132 is shortened with a metered addition to the chamber 169 located on the side of the piston rod 142, and the two rollers 102; 103; 102′; 103′ or frame sections 128.1; 128.2; 128.3; 128.4 are set toward one another via a pulling force and, for example with a metered addition to the chamber 169 facing away from the piston rod 142, the effective length is increased and the two rollers 102; 103; 102′; 103′ or frame sections 128.1; 128.2; 128.3; 128.4 are set away from one another via a pushing force.

For a case that is not shown here in which an adjustment device for a position-based or displacement-based adjustment is designed and arranged in such a way that the throwing-on takes place or can be effectuated by pushing one roller in the direction of the other roller, conversely with a metered addition to the chamber 169 located on the side of the piston rod 142, the one roller would be moved away from the other roller 102; 103; 102′; 103′ or the one frame section would be moved away from the other of the frame sections 128.1; 128.2; 128.3; 128.4 via a pulling force, and, for example, with a metered addition to the chamber 169 facing away from the piston rod 142, the one roller would be moved in the direction toward the other roller 102; 103; 102′; 103′ or the one frame section would be moved in the direction toward the other of the frame sections 128.1; 128.2; 128.3; 128.4.

As is shown in FIG. 27, for example, the directional valve 164, for example, in the form of a 4/4 way valve 164, can additionally have a fourth switching state s4, namely a switching state s4 in which both chambers 168; 169 are connected via a return to the reservoir R and are thereby, for example, depressurized. The directional valve 164 is preferably designed in such a way that the fourth switching state s4 at the same time represents a basic switching state s4 to which the directional valve 164 returns when the positioning drive 176 is inactive. In the case of such a fourth switching state s4, restricting devices, such as so-called pipe restrictors, which are only shown symbolically, can be provided in the line paths coming from the chambers 168; 169, in particular in the respective line path leading through the valve 164. With this, abrupt pressure relief can be avoided when the cylinder-piston system 132 is being depressurized, for example when the operation is ended.

Regardless of this or advantageously in addition to what is described above, in an advantageous embodiment the directional or multi-way valve 164, in at least one of the active switching states thereof, can be switched not just in a binary manner to be conducting or non-conducting, but is designed for at least for one, preferably for both of the conducting states s2; s3, in the manner of a proportional valve 164, in particular as a proportional directional valve 164, by way of which the fluid flow in the relevant switching state s2; s3 can be controlled by open loop control or closed loop control with respect to the flow rate and/or with respect to the fluid pressure that is present on the output side. In this advantageous embodiment, the directional valve 164 is preferably designed as a proportional directional valve 164, in the case of the aforementioned fourth switching state s4, for example, as a proportional 4/4 way valve 164, by way of which, in particular via the positioning drive 176, in addition to an aforementioned holding state S1, a second switching state s2 that can be varied in terms of the degree of the flow and/or output pressure, in particular a first conducting state s2 and/or a third switching state S3 that can be varied in terms of the degree of the flow and/or output pressure, in particular a second conducting state s3.

Regardless of the design as a directional valve 164 having only binary conducting states s2; s3 or as a proportional directional valve 164 having at least one conducting state s2; s3, preferably two conducting states s2; s3 that can be varied in terms of the opening degree, for example the flow and/or output pressure, the directional valve 164 or the positioning drive 176 thereof can be adjusted by the positioning drive 176, which can, for example, be formed by a motor or preferably by a controllable solenoid 176. The directional valve 164 is preferably activated or activatable as part of a closed control loop R_{b}; R_{F}; R_{d}; R″_{d} described below via a controller 171, or, possibly for the case of a displacement-based or position-based adjustment of the relevant gap 104, can be controlled via a relationship between the piston position and gap width b104 by an accordingly equipped control device and an inner closed control loop relating to the piston position.

Regardless of the specific embodiment of the aforementioned valve 164, the cylinder-piston-system 132, together with the directional valve 164 and the controller 171 acting on the directional valve 164, forms, for example, a so-called servo-hydraulic actuator 132, 164.

So as to be able to keep available for adjusting and maintaining a certain gap width b104 when compressing the powder 004; 004 to form the film 007, pressurized fluid having an overpressure of, for example, at least 100 bar, preferably at least 150 bar, in particular of at least 200 bar, is provided (where 1 bar=100 kPa) for the compressed air source P. This applies likewise to the drive means 133 of the first embodiment designed as a cylinder-piston system 133, in which it operates against a stop means 119. For the displacement-based adjustment, this, for example, ensures that a gap width b104 is maintained at a constant level, despite possibly large material streams to be compressed in the film-forming gap 104, and in the case of the force-based adjustment it provides the option of high compaction and/or strong compression with the carrier substrate 006 in the application gap 107.

In an alternative embodiment for the positioning means 164* effective as a final control element (see, for example, FIG. 28), this means is designed as a pump 164* that is driven by a motor, in particular servo motor, in particular reversibly, and can be controlled by open loop control and/or closed loop control in particular with respect to a defined, in particular volume-based, delivery volume, by way of which the pressurized fluid is pumped into the one or the other chamber 168; 169 or out of the respective other chamber 169; 168. Depending on the design of the cylinder-piston system 132, additional elements, such as equalizing tanks and/or valves, can be provided in the fluid circuit. The cylinder-piston system 132, together with the pump 164* driven by the servo motor and possibly other integral parts, such as the controller 171 acting on the pump 164*, forms, for example, a so-called servo-hydraulic actuator 132, 164*.

For the case of a hydraulically actuated drive means 132 that is controlled with respect to the gap width b104, a corresponding positioning command representing the desired gap width b104_{target} is directly supplied to the positioning means 164 on the input side, for example.

For all embodiments comprising a cylinder-piston system 132; 133 on which pressurized medium can act, advantageously an emergency shutdown is provided, in particular due to the high pressures that are kept available and for protection against excessive contact forces, comprising a pressure sensor 177 that is provided in the line path supplying the cylinder-piston system 132; 133 with pressurized fluid when the one or first roller is being set against the adjacent other or second roller 103; 103′; 102; 102′, and comprising a switching logic which is implemented in control means and has a signal connection to the pressure sensor 177 and which, due to a pressure in the line path rising above a threshold value when the one roller is being set against the adjacent other roller supplying line path, effectuates a depressurization of the pressurized medium supply of the cylinder-piston system 132; 133, for example when using an aforementioned directional valve 164 for the depressurized switching state s4, or a switch to an operating mode effectuating a shutdown, for example when using the aforementioned directional valve 164 for the switching state s2 effectuating the shutdown. The pressure sensor 177 can be provided in the line connection 159 or, as shown, in the valve-internal output-side line path. The switching logic can be integrated, for example in the form of a circuit or a software routine, into the control means 171 activating the directional valve 164.

In the preferred embodiment here of a hydraulically actuated drive means 132 that is controlled with respect to the gap width b104, an adjustment command from a controller 171 is supplied to the positioning means 164 or the positioning drive 176 used for adjusting the positioning means 164, regardless of the design thereof as a directional valve 164 or pump 164, on the input side, which compares a gap width b104 ascertained via the sensor system 157 to a desired or specified gap width b104_{target}, for example target gap width b104_{target}, and, depending on the deviation, outputs a corresponding adjustment command for increasing or decreasing the gap width b104_{target} to the positioning means 164 or the positioning drive thereof. Here and hereafter, the gap widths b104; b104_{target} to be compared shall also encompass the variable representing the respective gap width b104; b104_{target}.

The controller 171 indirectly or directly receives the ascertained gap width b104 from the sensor system 157 supplying the gap width b104 or a measure of the gap width 104, possibly via evaluation means 161 that are specifically configured for the sensor system 157 used. The sensor system 157 used and preferred here comprises two sensors 157.1; 157.2, for example, capacitively operating sensors 157.1; 157.2, which on a line of the shortest distance between the two rollers 102; 103 are each directed at the cylindrical roller surface in each case of one of the two rollers 102; 103 or on a cylindrical measuring surface co-rotating with the respective roller 102; 103 rotation-symmetrically about the axis of rotation R102; R103 thereof, for example, a so-called measuring collar. The measured value emitted by each of the sensors 157.1; 157.2 is a distance or a variable representing the distance, the sum of which relative to a reference value ascertained during a calibration measurement, for example, at a gap width of zero or a small calibration gauge, for example, following appropriate evaluation in the evaluation means 161, supplies the actual gap width b104 or the value of the variable representing the same.

In an advantageous embodiment, at least one of the aforementioned hydraulically actuated drive means 132 indirectly or directly engages on each frame side between the first and second rollers 102; 103, preferably, however, two or possibly even more such drive means 132.

It is most particularly advantageous when a linear adjustment path is provided for the adjustment of the respective movable rollers 102; 103; 102′; 103′; 106 or for the aforementioned case of a multi-piece frame 128 of the respective movable frame sections 128.1; 128.3; 128.4 and/or, for example despite the small thickness of the dry film 003; 003′ or product strand 002, an adjustment path having a possible adjustment range of several, for example at least 2 mm, in particular or even at least 4 mm. The latter enables a sufficiently large throw-off for maintenance purposes or malfunctions.

Even though the displacement-based or position-based positioning drive 109 is described in connection with the first gap 104 that is preferred for this purpose, what was described is to be applied accordingly to the case where the second gap 107 is also to be adjusted or adjustable in a displacement-based or position-based manner.

The positioning drive is also only described based on the reference signs without primes, and it is to be applied accordingly to a corresponding positioning drive 109′ having reference signs with primes when a second first gap 104′ is present.

Generally, the design of the respective positioning drive 109; 109′ engaging with the active ends between the rollers 102; 103; 102′; 103′ of a roller pair is to be applied in the first embodiment, that is, comprising a force-based positioning drive 133 and stop means 119, and in the second specific embodiment, that is, comprising one or more hydraulically actuated drive means 132 controlled by open loop control and/or closed loop control with respect to the piston position, to an arrangement of the rollers 102; 103; 102; 103′ in a single-piece frame 128 and/or to an engagement on respective bearings or bearing blocks mounted adjustably on side walls of a one-piece or multi-piece frame 128 and supporting the roller 102 to be adjusted. For example, a roller 102; 103; 106; 102′; 103′ to be adjusted can be rotatably accommodated with the roller journals thereof on both sides in a bearing or bearing block that is mounted on the frame 128, a frame part of a subframe so as to be linearly movable along an adjustment direction.

Such an arrangement of the positioning drive 109; 109′, however, is also preferably provided in the second embodiment of the positioning drive in conjunction with an aforementioned multi-piece frame 128 comprising multiple frame sections 128.1; 128.2; 128.3; 128.4, wherein what was described above regarding the design of the frame sections 128.1; 128.2; 128.3; 128.4 and/or regarding the configuration of the single or double application unit and/or regarding the pivotability of one of the rollers 102; 103, in particular of the roller 102, and/or the engagement in the plane G and/or regarding the design of the force-based positioning drive 111; 111′ is to be applied accordingly to the second roller gap 107, according to which preferably, in the manner described above with regard to the first specific embodiment, a force-based or combined positioning drive 111 comprising at least one drive means 133 that can be operated or is operated in a force-based manner, in particular can be operated or is operated force-controlled by open loop control or closed loop control, for example, one or preferably more cylinder-piston systems 133, and possibly an adjustable stop 119, is provided for adjusting the second gap 107 between a roller 103′; 107 that is effective a counter-pressure roller 103′; 107 and the first roller 102 or a further roller located therebetween.

In a preferred embodiment, the at least one drive means 132 or the adjustment device 165 comprising the drive means 132 also engages here with the two active sides or active ends thereof, as described above for the first specific embodiment, on the first and second rollers 102; 103; 102′; 103′ or on the frame sections 128.1; 128.2; 128.3; 128.4 thereof on the rollers 102; 103; 102′; 103′ or frame sections 128.1; 128.2; 128.3; 128.4, and more specifically in particular also in such a way that they, for the adjustment of the gap 104; 104′ between the first and second rollers 102; 103; 102′; 103′, apply adjustment forces that are directed toward one another to these or the frame sections 128.2; 128.3; 128.4 thereof, that is, introduce a pulling force between the frame sections 128.1; 128.2; 128.3; 128.4, which provides the above-described advantage that the force resulting during the position-based throwing-on only acts at the relevant first roller gap 104; 104′, and not perhaps additionally on the second gap 104; 104′, as is possible, for example, when applying a force to an outer roller 102; 102′ from the outside. In the solution proposed here, the respective drive means 132 or the adjustment device 165 comprising the drive means 132 in each case indirectly or directly engages with an effective end on one of the two rollers 102; 103; 102′; 103′ or on the frame sections 128.1; 128.2; 128.3; 128.4 thereof, and indirectly or directly engages with the other effective end on the other of the rollers 102; 103; 102′; 103′; or the frame sections 128.1; 128.2; 128.3; 128.4 thereof, and thus determine the relative position and/or the contact force applied between the rollers 102; 103; 102′; 103′.

The above-described principle of the adjustment devices 141 engaging between the mutually adjacent rollers 102; 103; 102′; 103′, in particular drawing devices 141, for example in the manner of tensioning devices 141, by which the rollers 102; 103; 102′; 103′ can be moved toward one another or acted upon by forces that are directed toward one another in the adjustment direction for the throwing-on or placement on one another, is, in particular both for the first and the second embodiment for the positioning drive 141; 165 or drive means 132; 133, of course also to be read on or applied to solutions in which the two rollers 102; 103; 102′; 103′ to be drawn toward one another are not indirectly mounted in relatively movable frame sections frame sections 128.1; 128.2; 128.3; 128.4, but in another manner at a frame 128, subframe or frame section 128.1; 128.2; 128.3; 128.4. For example, at least one of the two rollers 102; 103; 102′; 103′ to be drawn toward one another can be mounted in or at the relevant frame 128, subframe or frame section 128.1; 128.2; 128.3; 128.4 so as to be movable in the adjustment direction. The adjustable roller 102; 103; 102′; 103′ can advantageously be mounted in a linear bearing so as to be movable in the adjustment direction.

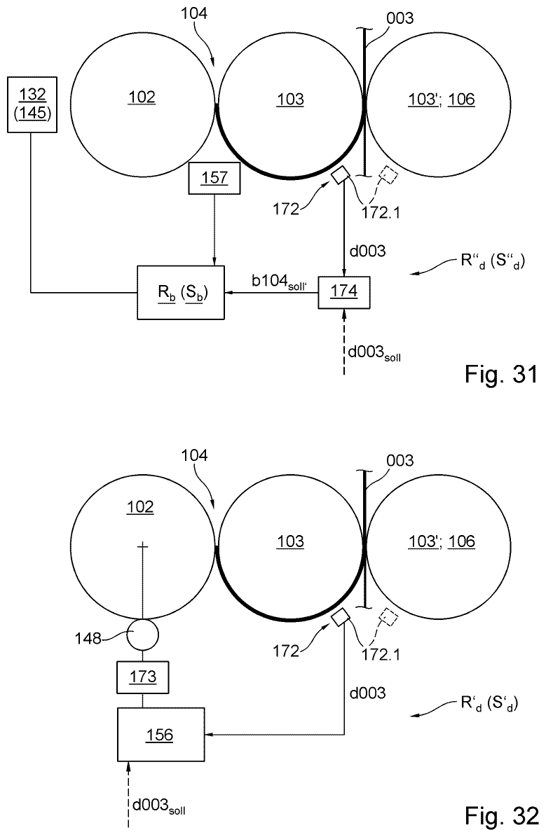

In an alternative, the hydraulically actuated cylinder-piston system 132 that is controlled by open loop control and/or closed loop control with respect to the piston position can be controlled by open loop control in terms of a specified or specifiable layer thickness d003 or a variable representing the layer thickness d003 as part of an open loop control system Sa or, for example, by integration into a closed control loop Ra comprising a sensor system 172 provided in the substrate path for determining the layer thickness d003, be controlled by closed loop control in terms of a specified or specifiable layer thickness d003 or the variable representing the layer thickness d003. (see, for example, FIG. 30 and FIG. 31). Such a sensor system 172 for determining the layer thickness d003 can, for example, comprise at least one, for example capacitively or inductively, preferably combined inductively and capacitively, operating sensor 172.1 and/or is, for example, provided for determining the layer thickness d003 of the dry film 003 that is formed on the second roller or a roller provided between the second roller and the counter-pressure roller 103; 103′; 106 and/or is directed at a circumferential region of the relevant roller 103 between the formation or reception and the transfer of the dry film 003. As is shown by way of example in FIG. 30, for example, the measured layer thickness d003 can be considered directly in the control device 156, and, if a deviation exists, the hydraulically actuated cylinder-piston system 132 can be varied via the positioning means 164 based on the comparison between a target thickness d003 target and the measured layer thickness d003. Or, as is shown by way of example in FIG. 31, for example, the measured layer thickness d003 can initially be compared to the target thickness d003_{target} in an external closed control loop by a controller 174, and, if a deviation exists, for example, based on a defined relationship, initially a varied value can be generated for the target gap width b104_{target}, which is supplied to and/or used as a basis for the above-described closed control loop R_{b} for controlling the gap width b104 as an interior closed control loop R_{b} for implementing the new target gap width b104_{target}.

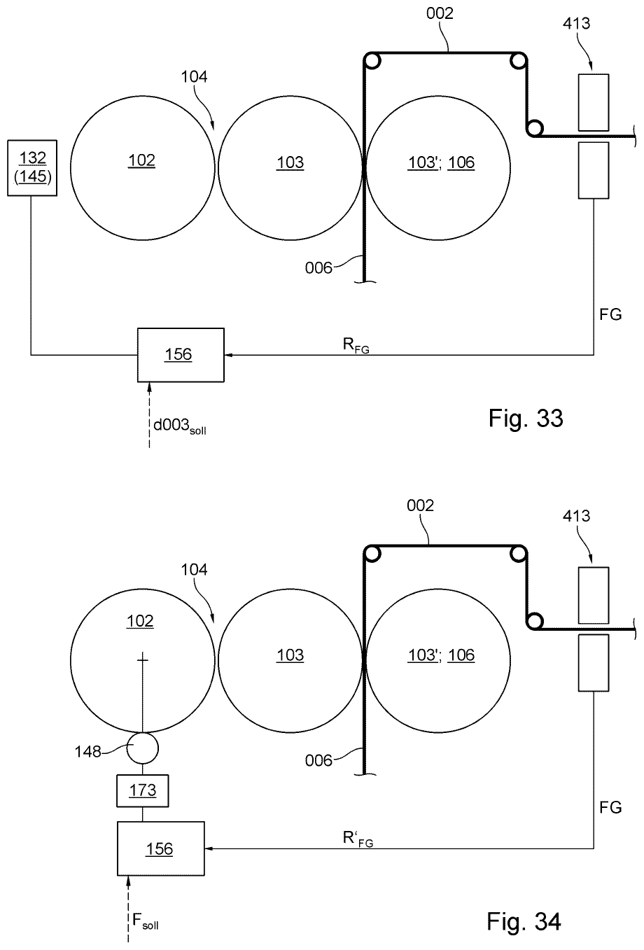

In another alternative to the open loop control or closed loop control, directed at the gap width b104, of the hydraulically actuated cylinder-piston system 132 that is controlled by open loop control and/or closed loop control with respect to the piston position, the hydraulically actuated cylinder-piston system 132 that is controlled by open loop control and/or closed loop control with respect to the piston position in terms of the aforementioned target or command variable can be controlled in terms of a specified or specifiable grammage FG or a variable representing the grammage FG, for example, by integration into a closed control loop R_{FG}, with a sensor system 413.1; 413.2, provided in the substrate path, for determining the grammage FG in terms of a specified or specifiable grammage FG or variable representing the grammage FG (see, for example, FIG. 33 and FIG. 34). What was described above also applies here to the embodiment with or without the underlying inner closed control loop R_{b} for controlling the gap width b104 and is to be employed accordingly.

Even though above and in the associated figures the embodiment comprising a hydraulically actuated drive means 132 is specifically only described and shown for a pair made up of a first and a second roller 102; 103 in conjunction with a roller 103′; 107 effective as a counter-pressure roller 103′; 107, this, of course, is to be applied accordingly to the second pair comprising a first and second roller 102′; 103 in the case of a double application unit 101; 101′.

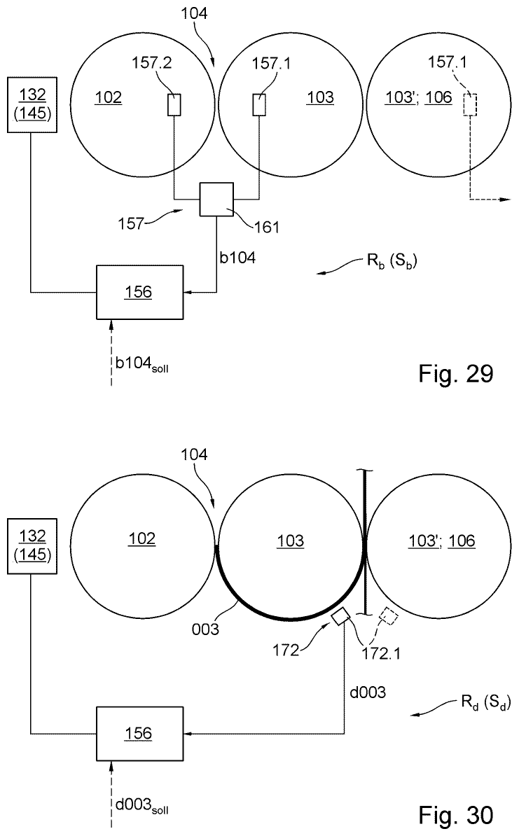

The aforementioned open loop control systems S_{b}; S_{d}; S″_{d}; S_{F} or closed control loops R_{b}; R_{d}; R″_{d}; R_{F} are to be applied to the first specific embodiment of the positioning drive 109; 109′ with the proviso that the relevant open loop control system S_{b}; S_{d}; S″_{d}; S_{F} or the relevant closed control loop R_{b}; R_{d}; R″_{d}; R_{F} acts on the positioning means 146, in particular on the servo motor 155 comprised by the positioning means 146 for adjusting the stop means 119, in particular stop 119, instead of on the hydraulically actuated cylinder-piston system 132 controlled by open loop control and/or closed loop control with respect to the piston position. These variants are identified in FIG. 29 to FIG. 31 and FIG. 33 by the reference numeral 146 for the positioning means 146 indicated in parentheses.

In a preferred embodiment, in all embodiments of the application units 101; 101′ or double application units 101; 101′, both those shown in connection with the frame sections 128.1; 128.2; 128.3; 128.4 and those designed in another manner with a one-piece or multi-piece frame, the rollers 102; 103; 102′; 103′; 106; 106′ provided in the application or double application unit 101; 101′; 101; 101′, at least in the operating position, are arranged with respect to one another in such a way that the axes of rotation R102; R103, R102′; R103′; R106 thereof intersect the same, here in particular horizontally extending, connecting line in at least a radial alignment along the axes of rotation R102; R103; R102′; R103′; R106. If one or more inclined rollers 102; 103; 102′; 102; 103′; 106; 106′ are present, this connecting line coincides, for example, with the respective pivot axis S. Without an inclined roller 102; 103; 102′; 103′; 106; 106′, the axes of rotation R102; R103, R102′; R103′; R106 are advantageously, as was previously described, for example, in an above-described variant embodiment, parallel and even located in the same, here in particular horizontally extending, plane.

For all above-described embodiments, variants, configurations, specific embodiments or designs, the positioning drive 109; 109′; 111; 111′ and/or the bearing mechanism 112; 112′; 113; 113′ comprised thereby at least of the rollers 103; 103′; 106; 106′ forming the second gap 107; 107′ are preferably designed to form, during normal operation, a gap width of at least 15 μm, advantageously of at least 30 μm, in particular of at least 50 μm, at the narrowest point and/or, in particular at least within boundaries defining the maximum adjustment path, to form a gap width arising between the two rollers 103; 103′; 106; 106′ via a product strand 002; 002′ to be formed and/or a contact pressure force or linear force caused by at least one positioning mechanism 112; 112′ and/or at least one positioning drive 109; 109′, and/or to set and/or apply, in the second gap 107; 107′ at least in the region of the width contributing to the film formation and/or for the film application, a linear force of, for example, at least 500 N/mm, advantageously at least 700 N/mm, preferably a linear force between 500 N/mm and 3000 N/mm, between the rollers 103; 103′; 106; 106′ forming the second gap 107; 107′, and/or to enable keeping a desired linear force constant, even if the dry film thickness fluctuates, by repositioning at least one of the two rollers 103; 106; 106; 103′, for example automatically or in a controlled manner. In contrast to a repositioning that is controlled via a closed control loop, automatic repositioning is, for example, a repositioning that occurs by the drive means, which can preferably be adjusted in a force-based manner, in particular is force-controlled by open loop control or can be controlled by closed loop control, or the force application thereof itself and without readjustment via an additional control loop.

For all above-described embodiments, variants, configurations, specific embodiments or designs, in a particularly advantageous refinement an extraction unit 123; 123′, by which potentially leaking gases or developing fumes can be extracted, is provided above the respective application unit 101; 101′ or the application units 101; 101′.

The rollers 102; 102′; 103; 103′; 106; 106′ of the above-described application units 101; 101′ are preferably designed with a width in the range of 400 mm to 800 mm, in particular of 500 mm to 700 mm which can be used for film formation and/or for application.

Generally independently of, but in particular advantageously in conjunction with one of the aforementioned embodiments, variants, configurations, specific embodiments or designs of the coating device 100; 100* and/or one of the designs and/or configurations described in more detail below for the machine, a subsequent procedure for forming the dry film, in particular for a subsequent application onto a carrier substrate 006 in, for example, an aforementioned application unit 101; 101′, in particular in conjunction with an aforementioned multi-piece design and/or the design of the positioning drives 109; 109′; 111; 111′, is most particularly advantageous.

As described above, for forming or generating the dry film 003; 003′ from a, for example above-described, powdered material 004 by way of the first roller 102; 102′ and the second roller 103; 103′ forming a roller gap 104; 104′ with the first roller 102; 102′ between the outer cylindrical surfaces thereof, powdered material 004; 004′ is supplied to the roller gap 104; 104′ via the region of the wedge-shaped space above the roller gap 104; 104′, and this material is conveyed through the roller gap 104; 104′ so as to form a dry film 003; 003′ to be further conveyed on the outer cylindrical surface of the second roller 103; 103′ when passing through the roller gap 104; 104′. The first roller 102; 102′ is drivable or driven at a first circumferential speed V(102; 102′) in the region of the outer cylindrical surface thereof, and the second roller 103; 103′ is drivable or driven at a second circumferential speed V103; 103′ in the region of the outer cylindrical surface thereof. A grammage FG, that is, a mass based on a unit area of the dry film 003; 003′, for example in milligrams per square centimeter (mg/cm²), of the dry film 003; 003′ formed by the roller gap 104; 104′ is varied by deliberately bringing about a variation of a ratio V(102; 102′): V(103; 103′) between the circumferential speed (V(102; 102′) of the first roller 102; 102′ in the region of the outer cylindrical surface thereof and the circumferential speed (V103; 103′) of the second roller 103; 103′ in the region of the outer cylindrical surface thereof, that is, for example, is deliberately adjusted.

The ratio V(102; 102′): V(103; 103′) is varied, for example, within a range from 1:3 to 1:6, advantageously at least within a range from 1:4 to 1:5. The varying of the ratio V(102; 102′): V(103; 103′) can be brought about here via a variation of the speed differential and vice versa, so that the aforementioned varying of the ratio V(102; 102′): V(103; 103′) can likewise be regarded as a varying of the speed differential and vice versa.

Particularly advantageously, a control loop, for example, a so-called closed loop, is provided, wherein during operation a control of the grammage FG or of a measure representing the grammage FG to a target value FG_{target} or to a value in a permitted range takes place by variation of the ratio between the circumferential speeds V(102; 102′; 103; 103′) as a function of an ascertained measurement value (see, for example, FIG. 32).

The variation of the ratio between the circumferential speeds V(102; 102′; 103; 103′) advantageously takes place at a fixed, but settable gap width b104. This can be set, for example, in an aforementioned position-based manner and/or to an aforementioned degree in the variable.

The variation of the ratio between the circumferential speeds V(102; 102′; 103; 103′) preferably takes place by a variation of the circumferential speed V(102; 102′) of the first roller 102; 102′, while the second roller 103; 103′ continues to be operated, for example, at the present, in particular stationary machine speed.

A variation of the circumferential speed V(102; 102′) of the first roller 102; 102′ takes place, for example, by applying an actuating signal effectuating a variation in the relative speed to an open-loop and/or closed-loop control means 173 controlling by open loop control or closed loop control the rotatory drive, in particular the drive means 148 of the first roller 102, wherein, in the preferred case of a first roller 102 driven by an individual motor, the final control element is by a drive controller 173 controlling by open loop control and/or closed loop control the drive motor 147 and the command variable is, for example, a changed value for the gear factor. In the case of a drive of the first roller 102 which is mechanically coupled via a gear, the open loop and/or closed loop control means 173 can be by a positioning drive of a gear stage adjustable with respect to the gear ratio and the control signal, for example, a control signal for adjusting the gear ratio.

The variation takes place, for example, along an, in particular linearly, falling relationship between a speed differential at the outer cylindrical surfaces or a variable characterizing the speed differential on the one hand and the grammage or the measure representing the grammage on the other hand. At least in the employed adjustment range, an, in particular negative, grade is advantageous, for example, at which, for example, a variation of the speed differential by 1% results in a change in the grammage that ranges, for example, from 1.0 to 1.5 mg/cm², in particular 1.1 to 1.3 mg/cm².

The measure for a current grammage can take place by a measurement at a point at the dry film 003; 003′ that has not yet been applied, the point being located downstream from the roller gap 104; 104′ in the transport path of the dry film 003; 003′, for example at the second roller 103; 103′, or at the dry film 003; 003′ that has already been applied to a carrier substrate 006, for example, at the product strand 002. This can take place, for example, in conjunction with or based on aforementioned density measurement methods, with a value for the grammage also being obtained in the process, or preferably via a measuring device 413 or sensor system 413.1, 413.2 described below, for example, and preferably an ultrasound-based measurement, which obtains a measure for the grammage FG, for example, by a comparison to results from a reference measurement or reference measurements.

Using such a procedure, minor fluctuations in the grammage can be corrected, without having to adjust rollers 102; 102′; 103; 103′; 106; 106 or frame sections 128.1; 128.2; 128.3; 128.4.

The procedure is to be applied accordingly to setting or regulating a volume-based density by variation of the ratio between the circumferential speeds V(102; 102′; 103; 103′).

The drive or drive motor 147 of the first roller, together with the open loop and/or closed loop control means 173 and the measuring device 413 or the sensor system 413.1, 413.2, forms a closed control loop R′FG for controlling the ratio between the circumferential speeds V(102; 102′; 103; 103′) based on an ascertained, in particular inline ascertained, grammage FG (see, for example, FIG. 34).

In an alternative to the described control of the ratio between the circumferential speeds V (102; 102′; 103; 103′) based on an ascertained grammage FG, it is also possible to utilize the layer thickness d003 ascertained by the aforementioned sensor system 172 on the input side, instead of the ascertained grammage. The drive or drive motor 147 of the first roller 102, together with the open loop and/or closed loop control means 173 and the sensor system 172 for ascertaining the layer thickness d003, forms a closed control loop R′_{d} for controlling the ratio between the circumferential speeds V(102; 102′; 103; 103′) based on an ascertained, in particular inline ascertained, layer thickness d003 of the formed dry film 003 (see, for example, FIG. 32).

A machine for producing, in particular in an inline process, a multi-layer product (see, for example, FIG. 3, FIG. 10, FIG. 15, FIG. 16 or FIG. 17), which on at least one side of a carrier substrate 006 comprises an above-described dry film 003; 003′ made of a powder mixture, preferably comprises a substrate infeed 200, by which the carrier substrate 006 can be fed to the machine on the input side, a first substrate path section 300, via which the carrier substrate 006 can be fed to an application stage 100; 100* for applying the dry film 003; 003′ to at least one side of the carrier substrate 006, and a second substrate path section 400, via which the carrier material 006 provided on at least one side with the dry film 003 can be fed to a product receiving system 500, by which the product can be combined into product bundles, for example into reels or piles.

In a particularly preferred embodiment, the application stage 100; 100* is designed in an above-described embodiment, design, configuration, specific embodiment or variant for the above-described device 100; 100*. All embodiments, designs, configurations, specific embodiments of the first group of exemplary embodiments are to be able to take the place of the application stage 100 shown by way of example in FIG. 3, and all of the second group are to be able to take the place of the application stage 100* shown by way of example in FIG. 10, FIG. 15 or FIG. 16. In the exemplary embodiments for the machine shown in FIG. 15 and FIG. 16, it is also possible for embodiments, designs, configurations, specific embodiments or variants of the first group to be used as variants for the application stage 100, that is, comprising separate application devices 101; 101′.

In an advantageous embodiment, the substrate infeed 200 is formed by a substrate unwinder 200, in particular a reel changer 200, preferably by a reel changer 200 comprising several reel spots and/or qualified for a non-stop reel change. Advantageously, it can comprise a substrate guide element 202 designed as a roller 202 that is positively driven by a motor, in particular a draw roller 202, and/or a substrate guide element 203 in the form of a dancer roller 203, which, for example, is spring-preloaded or deflected by way of a force transversely to the substrate path at a lever or a guide.

At the substrate unwinder 200, the carrier substrate web 006 is unwound and fed, at the unwinding location, on the input side, to the substrate path leading through the machine.

For the case of a draw roller 202 that is comprised by the substrate unwinder and, for example, structurally assigned thereto (see, by way of example, in FIG. 3 or FIG. 10, for example), this draw roller can be comprised by a drawing unit 207, in particular infeed unit 207, which, for example, in addition to the draw roller 202 comprises a drive means that drives the draw roller 202, in particular independently of other draw rollers, and can be controlled by closed loop or open loop control in terms of the speed, in particular a drive motor, for example in the form of a servo motor, and/or comprises pressure rollers that can be placed against the draw roller 202 to increase the friction. The roller 202 or the drive means, depending on the web tension conditions and/or web tension requirements that exist in front of and after the roller 202, can also be operable or operated as a generator or so as to block the forward feed of the carrier substrate web 006, for example so as to build or maintain a certain and/or desired web tension in the substrate path section 300 that follows and extends, for example, up to a next clamping or web feed point or in a part of the substrate path section 300 formed by a following substrate path segment.

For example, still structurally assigned to the substrate path in the reel unwinder 200 or already assigned to the first substrate path section 300, a substrate guide element 208; 307 can be formed as a measuring roller 208, for example a web tension measuring roller 208; 307 (shown by way of example for all embodiments in FIG. 16, for example) in the substrate path, by which, for example, the web tension or at least a variable representing the web tension can be ascertained so as to use the same, for example, for controlling the web tension, for example via the conveying speed of individual units 100; 100*, 600 or one or more web guide elements 202; 308; 401; 502, which are in particular positively driven by a motor.

The substrate infeed 200 designed as a reel changer 200 advantageously comprises a reel drive, which is driven mechanically independently of the remainder of the machine and/or by an individual motor, and/or a lifting device for supporting a reel loading- and/or reel unloading process.

Still located in the substrate path segment attributable to the substrate infeed 200 and/or in the following first substrate path 300, in an advantageous embodiment a device for the lateral web edge control 204 (shown by way of example for all embodiments in FIG. 15, for example), in particular a sensor system detecting a web edge and a control element effectuating a lateral offset of the carrier substrate, for example a turner bar pair that can be pivoted about an axis extending perpendicularly to the transport direction Ts, can be provided. In a particularly advantageous embodiment, the web edge controller 204 is combined with a gluing device 206, for example a gluing table 206.

Instead or in addition, in an advantageous embodiment a spreader, in particular a single-element or multi-element web guide element having a convexly extending outer cylindrical surface, is provided still in the substrate path segment of the substrate infeed 200 and/or in the first substrate path 300.

In an advantageous refinement, a one-piece or multi-piece pretreatment station 302, in particular a cleaning and/or deionizing station 302, is provided in the first substrate path 300, by way of which the carrier substrate 006 is or can be freed from superficial impurities, for example dust or cut-off residue, and/or electric charge carriers, on one side or both sides in a contactless or contacting method.

A measuring station 303, in particular comprising a sound-based or radiation-based measuring device 303, is provided in the first substrate path 300, in particular downstream from a possibly provided cleaning operation, by way of which the material thickness of the carrier material 006 can be checked for the thickness and/or homogeneity in the thickness and/or for impurities and, for example in the event of impermissible deviations from a target specification, an optical and/or an acoustic warning signal and/or an error signal is transmitted to a machine controller and/or a control console.

For all embodiments of the machine, in an advantageous embodiment a substrate guide element 208; 307 can be designed as a measuring roller 307 (shown by way of example for all embodiments in FIG. 15 and FIG. 16, for example) in a substrate path segment that is structurally assigned to the reel changer 200 and/or in a substrate path section of the first substrate path 300 following the same, by which, for example, the web tension can be ascertained so as to use it, for example, for controlling the web tension, for example, via the conveying speed of individual units 100; 100*; 600 or of one or more web guide elements 202; 308; 401; 502 which are, in particular, positively driven by a motor. It is possible for only one of the two measuring rollers 208; 307 to be provided or advantageously for both measuring rollers 208; 307 to be provided, wherein in the latter case, for example, the downstream measuring roller 307 is used for ascertaining purposes and/or for control, as described below, of the web tension in the substrate path segment arranged upstream from the first or only application point.

In an advantageous refinement, for example a pretreatment station 304 designed as an application station 304 is provided in the first substrate path 300, by which a binder and/or a primer can be applied to one side or both sides of the carrier material 006. In this case, a dryer, which is not shown, for example a hot air or radiation dryer, can preferably be provided directly downstream from the application station 304.

In a particularly preferred embodiment, generally considered alone, but advantageously in conjunction with one or more of the other variant embodiments of the machine, a thermal pretreatment station 306, in particular a temperature control station 306, for example an infrared radiation source 306, can be provided in the substrate path immediately upstream from the application stage 100; 100*, that is, for example, downstream from the last substrate guide element 301; 307 cooperating with the carrier substrate web 006, by which the carrier material 006 can preferably be heated to above the ambient temperature, in particular to above 60° C., preferably to at least 80° C. This can, for example, be of particular advantage for activating a cohesion-supporting or cohesion-inducing agent 007; 007′ that is provided on or applied to the carrier substrate 006. Generally independently thereof, but advantageously in conjunction with such a temperature control station 306, a sensor 311 for ascertaining the temperature of the carrier substrate web 006, for example a temperature sensor 311, in particular a temperature sensor 311 operating in a contactless and/or radiation-based manner, can be provided. The sensor 311, for example as a temperature sensor 311, together with the possibly provided temperature control station 306, can be an integral part of a control loop for controlling the temperature of the carrier substrate web 006.

Instead of a draw roller 202 attributable to, or a drawing unit 207 attributable to, the substrate unwinder 200, or possibly in addition thereto, a draw roller 308 or a drawing unit 309 can be provided in the substrate path section 300 that follows the substrate unwinder 200 and/or leads to the point of the first or only dry film application, that is, to the first or only laminating gap 107; 107′. If only one draw roller 202; 308 or only one drawing unit 207; 309 is provided in the substrate path between where the unwinding from the reel 201 takes place and where the entry into the first or only laminating gap 107; 107′ takes place, such a draw roller 202; 308 or such a drawing unit 207; 309 can generally structurally be assignable or assigned to the substrate unwinder 200, a substrate path section 300 extending between the substrate unwinder 200, in particular where the unwinding takes place, and the application stage 100; 100*, in particular the first or only application point, or can structurally be assignable or assigned also to the application stage 100; 100* on the input side. What is essential here is that such a draw roller 202; 308 or such a drawing unit 207; 309 is arranged upstream from the first application point, that is, the first or only laminating gap 107; 107′, in the substrate path, for example so as to build or maintain a certain and/or desired web tension in the following substrate path section or in a part of the substrate path section formed by a following substrate path segment. Corresponding to the drawing unit 207 that was already described above, the drawing unit, for example in addition to the draw roller 308, comprises a drive means that drives the draw roller 308, in particular independently of other draw rollers, and that can be controlled by closed loop or open loop control in terms of the speed, for example in the form of a servo drive motor, and/or pressure rollers that can be placed against the draw roller 308 to increase the friction. Depending on the web tension conditions and/or web tension requirements that exist in front of and after the roller 308, the roller 308 or the drive means can also be operable or operated as a generator or so as to block the forward feed of the carrier substrate web 006, for example so as to build or maintain a certain and/or desired web tension in the substrate path section that follows and extends, for example, up to a next clamping or web feed point or in a part of the substrate path section formed by a following substrate path segment.

In an advantageous embodiment, an above-described calender 600 or an above-described calendering unit 600 comprising two rollers 601; 602, in particular calendering rollers 601; 602, forming a gap, for example calendering gap between each other, is provided in the second substrate path 400, in particular in the substrate path immediately downstream from the application stage 100; 100*. This, for example, has the advantage that, if the desired density is not produced during the dry film application, an end product 001, or an intermediate product 002 that only still has to be cut, can nonetheless be produced with the desired density in the active material layer 003; 003′.

In an alternative embodiment, which was previously mentioned above but is not shown in the figures, having its advantage, for example, in the independence of the processes and the optimization thereof, and thus in the quality and/or lower susceptibility to disruptions, for example in an installation or a system comprising multiple machines, a first above-described machine for coating a carrier substrate 006, in particular an above-described carrier substrate web 006, with a dry film 003; 003′, which is made of powdered material 004; 004′, is provided, which in the substrate path preferably comprises a coating device 100; 100* in one of the above-described embodiments, and a separate, second machine for compacting the dry film 003; 003′ by means of at least one calendering unit 600; 600′ that is provided in the substrate path of the second machine, These machines can generally be provided in different locations, but are preferably provided, for example in the same building, in a facility or machine arrangement for producing a multi-layer product 001 having a dry film that is applied to a carrier substrate, in particular for producing an electrode strand 002 or of electrode units 001. In this case, a product strand 002 that has not yet been post-compacted, which is referred to here as a pre-product, is combined on the output side of the machine for coating in the product receiving system 500, which is in particular designed as a product winder 500, into a roll 501 of pre-product, and this roll 501 is fed subsequently or at a later time to the second machine on the input side, in particular to a roll unwinder that is provided on the input side of this machine. The product strand 002 made of the pre-product is unwound there, guided through a calendering unit 600; 600′ arranged in the substrate path, and wound on the output side to form a product roll 501, serving as the fully compacted product strand 001, or is laid out after cross-cutting, which may be provided downstream from the calendering unit 600.

Regardless of whether an above-described calendering process takes place inline in the same machine, in which the dry film 003; 003′ is applied to the carrier substrate 006, or whether a calendering takes place in another, second machine comprising, for example, a calendering unit 600; 600*, separately from the application, the calendering unit 600; 600* comprises two rollers 601; 601*; 602; 602*, for example calendering rollers 601; 601*; 602; 602*, of which, for example, at least one, preferably both, can be heated, in particular can be heated in such a way that the outer cylindrical surfaces thereof, for example, at an ambient temperature of 25° C., can be brought to at least 80° C., advantageously to at least 100° C., preferably to at least 120, and/or between which a compression with a preferably adjustable linear force of at least 500 N/mm, advantageously at least 700 N/mm, in particular at least 1000 N/mm, preferably up to at least 2000 N/mm, or in particular a linear force between 500 N/mm and 3000 N/mm, can be applied. The product strand 002 coated at least on one side can be guided through the calendering gap for the purpose of further compacting the dry film 003; 003′, using pressure and/or an increased temperature in relation to the ambient temperature. The calendering rollers 601; 601*; 602; 602*, for example, have a diameter of at least 400 mm, in particular at least 500 mm, preferably at least 550 mm, and/or, for example, have a usable width of, for example, at least 400 mm, in particular at least 500 mm, preferably at least 550 mm. For producing the aforementioned products 001; 002, a concentricity per roller 601; 601*; 602; 602* having a maximum deviation of no more than ±2 m, preferably of no more than ±1 mm, is particularly advantageous.

Generally independently of, but advantageously in conjunction with one or more of the other variant embodiments of the machine, in a particularly advantageous embodiment a cooling unit 402, for example comprising one or more partially wrapped temperature-controlled cooling rollers 402.1; 402.2, is provided in the second substrate path 400 downstream from the application stage 100; 100*, and if a calendering unit 600 is provided, downstream therefrom, by which a product strand 002 that is guided through can be cooled, for example, by at least 20° C., in particular by at least 50° C.

Generally independently of, but advantageously in conjunction with one or more of the other variant embodiments of the machine, in an advantageous refinement an inspection device 403; 403.1; 403.2, which is in particular based on an optical and/or acoustic measurement, for example comprising one sensor 403.1 that is directed toward one side and one sensor 403.2 that is directed toward the other side, is provided in the second substrate path 400, by which the product surface can be checked for defects or imperfections, for example for the completeness of the surface and/or thickness of the applied dry film 003; 003′. As is shown in FIG. 15, for example, the inspection device 403; 403.1; 403.2 can be provided in the substrate path downstream from the calendering unit 600 or, as is shown in FIG. 16, for example, in the substrate path downstream from the application stage 100; 100′, but upstream from the calendering unit 600. In the first case, defects caused by the calendering process can be recognized, however, in the second case, defects that may be caused in the application stage 100; 100′ are determined as early as possible. The inspection device 403 can preferably comprise a camera, for example a line camera, on each side, preferably serving as the sensors 403.1; 403.2, by which the respective surface is recorded or optically scanned, and defective or missing spots are evaluated by way of a downstream evaluation unit.

Generally independently of, but advantageously also together with other variant embodiments of the machine, in particular, however, in conjunction with an inspection device 403; 403.1; 403.2 provided at the substrate path, a device for defect marking 412 is provided in an advantageous refinement, which can be formed, for example, by a printing device, for example an ink jet print head, or an injection device, wherein the latter, for example, can introduce a physical marking means, for example a so-called marking flag or a marking label, into or apply the same to the carrier substrate web 006.

For all embodiments of the machine, in an advantageous embodiment at least one substrate guide element 409 can be designed as a measuring roller 409 in the second substrate path 400, by which, for example, the web tension can be ascertained so as to use it, for example, for controlling the web tension, for example, via the relative conveying speed of individual units 100; 100*; 600 or of one or more web guide elements 202; 308; 401; 502 which are, in particular, positively driven by a motor. Preferably, at least one substrate guide element 409 is designed as a measuring roller 409 at least in the substrate path segment of the second substrate path section 400 which is arranged downstream from the application stage 100; 100*, in particular the point of the last or only application, and arranged upstream from a possibly provided calendering unit 600, in particular the point of a possibly occurring calendering process, in particular preferably, however, both in the described substrate path segment and in the substrate path segment arranged downstream from the calendering unit 600 that is provided in an advantageous embodiment. Instead of or in addition, a substrate guide element 507, which is structurally assigned to the product winder 500, can be designed as a measuring roller 507 that is arranged downstream from the calendering unit 600 in the substrate path.

So as to be able to ensure that the substrate moves optimally through the application stage 100; 100*, in an advantageous embodiment a substrate guide element 401, which is designed as a draw roller 401 that is positively driven by a motor, is provided in the second substrate path 400, preferably immediately downstream from the application stage 100; 100*, but upstream from a possibly provided calendering unit 600. This draw roller can be comprised by a drawing unit 411, which, for example in addition to the draw roller 401 itself, comprises a drive means that drives the draw roller 401, in particular independently of other draw rollers, and that can be controlled by closed loop or open loop control in terms of the speed, for example in the form of a servo drive motor, and/or pressure rollers that can be placed against the draw roller 401 to increase the friction. Depending on the web tension conditions and/or web tension requirements present upstream and downstream from the roller 401, the roller 401 or the drive means can generally also be operable or operated as a generator or so as to block the forward feed of the carrier substrate web 006, however here is operated or operable so as to build and/or maintain a web tension on the upstream substrate path segment by way of a motor, that is, so as to convey the carrier substrate web 006 in the transport direction Ts or with a lead compared to, for example, the speed at a next draw roller 202; 301 upstream and/or the circumferential speed of the last or only laminating roller 107; 107′ or of the pair of laminating rollers 107; 107′.

As an alternative or in addition, in a preferred embodiment a web tension equalizing and/or control device 406 (for example, shown by way of example for all embodiments in FIG. 15), comprising, for example, a dancer roller 407, which is spring-preloaded transversely to the substrate path or deflected by a force, for example, at a lever or a guide, is provided in the second substrate path 400 downstream from the application stage 100; 100*, possibly between the application stage 100; 100* and a calendering unit 600 provided in an advantageous embodiment, by which, for example, fluctuations in the web tension can be equalized and/or the conveying speed of an upstream or downstream subassembly 100; 100*; 600 or of one or more in particular motor-driven web guide elements 202; 308; 401; 502 can be controlled, in particular via the movement of the dancer roller 407.

A machine shown by way of example in FIG. 17, which, for example, is designed without a calendering subassembly 600 arranged downstream from the application stage 100, 100* in the substrate path, can, with the exception of the calendering subassembly 600, optionally be provided with multiple or all of the devices shown with respect to FIG. 15 or FIG. 16 and/or substrate guide elements 202; 203; 208; 307; 308; 401; 404; 409; 502; 503. For example, an aforementioned dancer roller 203 and/or at least one aforementioned draw roller 308 and/or at least one aforementioned web tension measuring roller 307 and/or an aforementioned temperature control station 306 are provided in the first substrate path section 300, and an aforementioned web tension measuring roller 409 and/or a cooling device 402, in particular including at least one cooling unit 402.1; 402.2, at least one aforementioned draw roller 401 and/or at least one aforementioned inspection device 403 for detecting defects and/or imperfections and/or a measuring station 408 for ascertaining the product strand thickness and/or a device for defect marking 412 and/or at least one dancer roller 503 are provided in the second substrate path section 400. Furthermore, a cleaning station 414 for removing loose particles and residue from the surface, which in FIG. 17, for example, can also advantageously be provided by way of example for the remaining exemplary embodiments, and/or a measuring device 413 for determining the grammage FG, which in FIG. 18, for example, can also advantageously be provided by way of example for the remaining exemplary embodiments, can be provided in the second substrate path section 400.

The measuring device 413 for determining the grammage FG is preferably based on an ultrasound-based measuring system 413.1, 413.2 or sensor system 413.1, 413.2. Preferably, an ultrasonic transmitter 413.1 is provided at the substrate path on a first strand side, by which ultrasonic waves can be applied to the product strand 002, and a receiver 413.2 is provided on the same or preferably the other side of the substrate path, by which, in the case of the same side, reflected ultrasonic waves and, in the case of the other side, transmitted ultrasonic waves can be detected. In both instances, a variable correlating with the grammage and/or representing the same and, with appropriate calibration, a value for the grammage can be determined via the transmission and/or reflection behavior. In an advantageous embodiment, the sensor system 413.1; 413.2 is designed to determine a value for the grammage continuously or at multiple points across the width, that is, transversely to the substrate path, in the direction of the width over a length that, for example, corresponds to at least half the substrate strand width, and, for example, is located symmetrically to the substrate path center. For example, viewed transversely to the transport direction, for example across a width that corresponds at least to the length of half the strand width of the product strand 002, a plurality of individual ultrasonic transmitters 413.1 and/or receivers 413.2 are provided next to one another or an extended ultrasonic transmitter 413.1 and/or receiver 413.2, designed to have the appropriate width, is provided. In an advantageous refinement, in each case one diverting roller around which the product strand 002 is at least slightly wrapped is provided in the substrate path upstream and downstream from the measuring point acted on by the ultrasonic transmitter 413.1. So as to obtain defined conditions, the distance in the substrate path between the measuring point and the respective diverting roller in each case, for example, corresponds to no more than twice the strand width, preferably no more than the strand width.

The measuring device 413 or the measuring system 413.1; 413.2 comprised thereby can, as described above, supply the measurement value ascertained for the grammage as an integral part of the aforementioned closed control loop R′FG for controlling the grammage FG via a variation of the ratio of the circumferential speeds V(102; 102′; 103; 103′) or of the aforementioned closed control loop R_{FG} for controlling the grammage FG via a variation of the gap width adjustment.

For all of the embodiments and variants of the machine described here, one embodiment is particularly advantageous in which a measuring station 408 for ascertaining the product strand thickness, in particular the total thickness, is provided in the substrate path arranged downstream from the application stage 100; 100*, and if a calendering unit 600; 600 is provided in the substrate path, downstream from a single or last calendering unit 600; 600, prior to the combination into the product bundle 501 in the product receiving system (for example, shown by way of example for all embodiments in FIG. 15, FIG. 16 and FIG. 17).

Instead of or in addition to the above-described cooling unit 402 in the second substrate path section 400, such a or a further cooling unit 402; 504 can also be provided in the substrate path segment attributable to the product receiving system 500 or at the frame thereof. Such a cooling unit 504, can, for example, be formed by a substrate guide element 504 designed as a cooling roller 504. As an alternative, such a cooling unit 504 attributable to the second substrate path section 400 or structurally to the product receiving system 500 can also be formed by one or more consecutively partially wrapped temperature-controlled cooling rollers 504.1; 504.2.

In a refinement, for example downstream from the possibly provided cooling unit 504, sensor 508 for ascertaining the temperature of the product 002, in particular of the product strand 002, can be in the substrate path downstream from the possibly provided calendering unit 600, however at the latest upstream from the delivery, for example upstream from a winding operation in the product winder 500. The sensor 508, for example as a temperature sensor 508, is in particular designed to be a contactless and/or radiation-based operating temperature sensor 311 and/or can, together with the possibly provided cooling unit 504, be an integral part of a control loop for controlling the temperature.

In an advantageous embodiment, the product receiving system 500 is designed as a product winder 500, in particular in the form of a reel changer 500.

The product winder 500 is preferably qualified for a non-stop reel change and/or comprises an above-described substrate guide element 502 designed as a draw roller 502 that is positively driven by a motor and/or a substrate guide element 503 in the form of a dancer roller 503, which, for example, is spring-preloaded transversely to the substrate path or deflected by a force at a lever or a guide.

So as to be able to ensure that the substrate moves optimally between the possibly provided calendering unit 600 and where the winding on the product winder 500 takes place, in an advantageous embodiment a substrate guide element 401; 502 designed as a draw roller 401; 502 that is positively driven by a motor can be provided in the second substrate path 400 or in a substrate path segment attributable to the product winder 500. This draw roller can be comprised by a drawing unit 411; 506, which, for example in the addition to the draw roller 401; 502, comprises a drive means that drives the draw roller 401; 502, in particular independently of other draw rollers, and that can be controlled by closed loop or open loop control in terms of the speed, for example in the form of a servo drive motor, and/or pressure rollers that can be placed against the draw roller 401; 502 to increase the friction.

In a particularly advantageous embodiment of a machine comprising, for example, a calendering unit 600, in particular for the stable and trouble-free inline continuous operation, at least one positively driven draw roller 202; 308; 401; 502 and/or at least one measuring roller 208; 307; 409 for ascertaining a web tension are provided both in a first substrate path segment, which is located between the unwinding location from the substrate reel 201 in the substrate unwinder 200 and the entry into the only or first laminating gap 107; 107′ of the application stage 100; 100*, and in a second substrate path segment, which is located between the exit location of the carrier substrate web, which by then has been provided with the dry film 003; 003′ at least on one side, out of the only or downstream last laminating gap 107; 107′ of the application stage 100; 100* and, for the embodiment comprising a calendering unit 600; 600*, the entry into the calendering gap between the two calendering rollers 601; 602. In an advantageous refinement for the embodiment comprising the calendering subassembly 600; 600*, a positively driven draw roller 502 and/or a measuring roller 409; 507 for ascertaining a web tension are also provided in a third substrate path segment, which is located between the exit location of the carrier substrate web 006, which has been provided with the dry film 003; 003′ at least on one side, out of the calendering gap and the winding location onto the product roll 501 in the product winder 500.

Preferably a web tension control device, which is not shown here, is provided, which on the input side are connected in each case to the or a measuring roller 208; 307; 409 provided in the first as well as the or a measuring roller provided in the second above-described substrate path segment and, on the output side are connected in each case to a drive controller, controlling the roller drives, of the or a draw roller 202; 308; 401 provided in the first as well as the or a draw roller provided in the second above-described substrate path segment, and which in particular comprises data processing means and/or electronic circuit means, which are equipped to build and/or to maintain a respective specified web tension and/or a web tension difference specified for the two substrate path segments by appropriate activation of the drive controller of the drive of one or more of the draw rollers 202; 308; 401 in each of the two substrate path segments. In a refinement, the web tension control device, on the input side, can additionally be connected in each case to the or a measuring roller 409; 507 provided in the third above-described substrate path segment and, on the output side, to a drive controller, controlling the drive of the relevant draw roller 502, of the or a draw roller 502 provided in the third above-described substrate path segment and, for example, can likewise be controlled by the same with respect to a specified web tension and/or a specified web tension difference relative to the upstream substrate path segment.

Generally speaking, in particular also for an embodiment of the machine without a calendering unit downstream from the application stage 100; 100*, what was said above regarding the draw rollers 202; 308; 401; 502 and measuring rollers 208; 307; 409, regarding the signal connections and regarding the web tension control device, is to be transferred or applied to an embodiment comprising at least one measuring roller and/or at least one draw roller 208; 307; 202; 308 in the first substrate path segment between where the unwinding takes place and the point of the initial application by the application stage 100; 100*, and at least one measuring roller and/or at least one draw roller 409; 507; 401; 502 in a substrate path segment between where the only or last point of the dry film application by the application stage 100; 100* is left and where the winding in the reel winder 500 takes place.

Fluctuations in the web tension, for example, can be equalized and/or compensated by an above-described dancer roller 203; 407; 503 and a control loop comprising the same, and, for example, integrated in an above-described web tension control device, and/or a conveying speed of an upstream or downstream unit 100; 100*; 600 or of one or more, in particular motor-driven, web guide elements 202; 308; 401; 502, such as the drive of an upstream substrate unwinder 200 or downstream substrate winder 500 or an upstream or downstream draw roller 202; 308; 401; 502 can be controlled, in particular via the movement of the dancer roller 407. The dancer roller is spring-preloaded transversely to the substrate path, for example at a guide or at a lever, in particular pneumatically or elastically preloaded with a force against the effective direction of the web tension of the substrate web 006 wrapping around the roller in a loop-like manner (or of the product strand 002).

An above-described draw roller 203; 308; 401; 502 comprises, for example, a drive motor that can be controlled by closed loop or open loop control in terms of the speed, in particular a servo motor, and/or cooperates with one or more pressing elements, for example pressure rollers, for example for improving the conveying behavior, and/or can, depending on the position in the substrate path, for example for generating or maintaining an upstream web tension, be operated as a motor or, for example for generating or maintaining a downstream web tension, be operated as a generator, for example with braking action, and/or is comprised by a control loop, for example as a control element, which controls the web tension, and for example, is integrated into an above-described web tension control device.

As an alternative to the embodiment of the machine comprising a product receiving system 500 designed as a roll winder 500, in a particularly advantageous embodiment a cross-cutting device can be provided in the second substrate path 400 or at the input of the product receiving system 500, by which a product strand 002 produced in the machine can already be cross-cut into product sections 001. The product receiving system 500 is designed, for example, as a stack former, in particular as a multi-stack former consecutively forming multiple stacks.

In an above-described machine and/or device 100; 100*, for example, a web-format carrier substrate 006 is provided continuously, and preferably on both sides, with a dry film 003; 003′ having a smaller width in relation to the carrier substrate width, so that an uncoated edge of the carrier substrate remains on both sides.

Although the disclosure herein has been described in language specific to examples of structural features and/or methodological acts, it is to be understood that the subject matter defined in the appended claims is not necessarily limited to the specific features or acts described in the examples. Rather, the specific features and acts are disclosed merely as example forms of implementing the claims.

1-23. (canceled)

24. A device (100; 100*) for coating a carrier substrate (006) with a powdered material (004), comprising at least one first application unit (101; 101′), which comprises a first roller (102; 102′) and a second roller (103) forming, in the nip between the outer cylindrical surfaces thereof, a first roller gap (104; 104′) used for forming the film, through which powdered material (004) can be conveyed so as to form a first dry film (003), and comprising a roller (103′; 106) that is effective as a counter-pressure roller (103′; 106), which, together with the second roller (103) or a further roller following directly or indirectly downstream from the second roller (103), viewed in the direction of the material stream, forms a second roller gap (107), with a substrate path that leads through the second roller gap (107) being provided, on which, during operation, a carrier substrate web (106) to be coated can be guided and have the dry film (106) formed in the first roller gap (104) applied thereto on a first side, characterized in that at least one drawing device (141; 165) comprising a drive means (132; 133) is provided on each frame side for adjusting the roller gap (104; 107) between the adjacent first and second rollers (102; 103; 102′; 103′) arranged so as to be movable relative to one another, by way of which the two rollers (102; 103; 102′; 103′) can be moved toward one another in the adjustment direction or be tensioned, and can be moved away from one another again or at least be relaxed again; that the drawing device (141; 165) comprising the drive means (132; 133) engage with the two active ends thereof on the first and second rollers (102; 103; 102′; 103′) so as to apply adjustment forces that are directed toward one another to the first and second rollers (102; 103; 102′; 103′) for adjusting the gap (104; 104′) between the same; and that the first gap (104) between the first and second rollers (102; 103; 102′; 103′) can be adjusted by the drawing device (141; 165) in a position-based manner, that is, toward a constant and/or defined gap width (b1904).

25. The device according to claim 24, characterized in that the drive means (132; 133) is designed as a cylinder-piston system (132; 133) that can be acted on by pressurized fluid.

26. The device according to claim 25, characterized in that the cylinder-piston system (132; 133) is supplied or can be supplied with pressurized fluid via a positioning means (164; 164*) that is fluidically connected to the cylinder-piston system (132; 133) from a pressurized fluid source (P) that, on the input side, is connected to the positioning means (164; 164*), the pressurized fluid providing and/or being able to provide a pressure of at least 100 bar or 10 MPa.

27. The device according to claim 25, characterized in that means for emergency shutdown are provided, which comprise a pressure sensor (177) that is provided in the first line path supplying the cylinder-piston system (132; 133) with pressurized fluid when the one or first roller (102; 103; 102′; 103′) is being set against the adjacent other or second roller (102; 103; 102′; 103′), and a switching logic which is implemented in control means and has a signal connection to the pressure sensor and which, due to a pressure in the first line path rising above a threshold value when the one roller (102; 103; 102′; 103′) is being set against the adjacent other roller (102; 103; 102′; 103′), effectuates a depressurization of the pressurized medium supply of the cylinder-piston system (132; 133) or a switch to an operating mode effectuating a shutdown.

28. The device according to claim 24, characterized in that the drawing device (141; 165) for the position-based adjustment of the first gap (104; 104′) comprises a positioning drive (111; 111′) that is operated or can be operated in a force-based manner and includes a cylinder-piston system (133) that can be acted on by a pressurized fluid, serving as the drive means (133), and a positioning mechanism (112; 112′; 113; 113′), in the adjustment path of which a positionable stop (119) can be introduced for limiting the position.

29. The device according to claim 28, characterized in that an adjustment path, at least toward the relevant side, is delimited by the stop (119) that can be adjusted by positioning and/or drive means (146), which defines the end position and against which the component to be adjusted in terms of the position is set or can be set by means of a drive means (132; 133).

30. The device according to claim 28, characterized in that the positionable stop (119) is designed as a stop (119) based on a screw thread or as a stop means (119) based on a wedge gear.

31. The device according to claim 24, characterized in that the drawing device (141; 165), for the position-based adjustment of the first gap (104; 104′), comprises, as the drive means (132), a drive means (132) that can be controlled by closed loop control with respect to a position of the output-side output means thereof and/or a hydraulic drive (132, 164, 171) that is controlled or can be controlled by closed loop control with respect to a positioning or a position and includes a cylinder-piston system (132) that can be acted on by a pressurized fluid.

32. The device according to claim 24, characterized in that the drawing device (141), for setting and/or keeping constant the gap width (b104) of the first gap (104), comprises a double-acting hydraulic cylinder-piston system (132) that can be controlled or is controlled by closed loop control via a directional valve (164).

33. The device according to claim 32, characterized in that the directional valve (164), serving as a final control element, together with the cylinder-piston system (132), serving as an actuator, including a sensor system (157) for detecting a gap width (b104) or a variable correlating with the gap width (b104) and/or representing the same, and including a controller (171) controlling the final control element based on a result provided by the sensor system (157), are integral parts of a closed control loop (R_{b}), by way of which the gap width (b104) can be controlled or is controlled so as to assume and/or maintain a target gap width (b104_{target}) or a target variable accordingly correlating therewith and/or representing the same.

34. The device according to claim 24, characterized in that each of the rollers (102; 103; 106) forming the gap (104; 107) between one another is mounted on both sides in frame walls (131.1; 131.2; 131.3; 131.4) of differing frame sections (128.1; 128.2; 128.3; 128.4), and that each of the drawing devices (141; 165) engages on the frame walls (131.1; 131.2; 131.3; 131.4) of the two rollers (102; 103; 106) forming the relevant gap (104; 107) between one another.

35. The device according to claim 34, characterized in that the frame section (128.1) carrying the second or further roller (103) of the first application unit (101) is mounted so as to be fixed in space or fixed to the frame, and the frame sections (128.3; 128.2) carrying the first roller (102) and the counter-pressure roller (106) are mounted so as to be adjustable in terms of the distance with respect to the second or further roller (103) that is arranged so as to be fixed in space or fixed to the frame.

36. The device according to claim 34, characterized in that the adjustably mounted frame sections (128.3; 128.2) are mounted so as to be movable on linear guides (112; 112′).

37. The device according to claim 24, characterized in that the roller (103′) that is effective as a counter-pressure roller (103′), serving as a laminating roller (103′), is at the same time designed as part of a second application unit (101′) that is located on the other side of the substrate path and that comprises a first roller (102′) of the second application unit (101′) which, together with the laminating roller (103′) effective as a counter-pressure roller (103′) or with a further roller of the second application unit (101′) located therebetween, forms a first roller gap (104; 104′) of the second application unit (101′) through which powdered material (004′) can be conveyed so as to form a second dry film (003), which, in the second roller gap (107), can be applied to the second side of the carrier substrate (106), which during operation is guided via the transport path through the second gap (107), via the laminating roller (103′) of the second application unit (101′).

38. The device according to claim 37, characterized in that at least one drawing device (141, 165) comprising a drive means (132; 133) directly or indirectly engages on both sides between the two rollers (102′; 103′) forming the first gap (104′) of the second application unit (101′), by way of which the two rollers (102; 103; 106) involved in the relevant gap (104; 107) can be moved toward one another and/or have forces that are directed toward one another applied thereto.

39. The device according to claim 38, characterized in that the first gap (104′) between the first and second rollers (102; 103; 102′; 103′) of the second application unit (101′) can be adjusted by the drawing device (141; 165) in a position-based manner, that is, toward a constant and/or defined gap width (b1904).

40. The device according to claim 39, characterized in that:
the drawing device (141; 165), for the position-based adjustment of the first gap (104; 104′), comprises, as the drive means (132), a drive means (132) that can be controlled by closed loop control with respect to a position of the output-side output means thereof and/or a hydraulic drive (132, 164, 171) that is controlled or can be controlled by closed loop control with respect to a positioning or a position and includes a cylinder-piston system (132) that can be acted on by a pressurized fluid; or
the drawing device (141; 165) for the position-based adjustment of the first gap (104; 104′) comprises a positioning drive (111; 111′) that is operated or can be operated in a force-based manner and includes a cylinder-piston system (133) that can be acted on by a pressurized fluid, serving as the drive means (133), and a positioning mechanism (112; 112′; 113; 113′), in the adjustment path of which a positionable stop (119) can be introduced for limiting the position.

41. The device according to claim 38, characterized in that each of the rollers (102′; 103′) forming the first gap (104′) of the second application unit (101′) between one another is mounted on both sides in frame walls (131.1; 131.2; 131.3; 131.4) of two differing frame sections (128.2; 128; 4), and that each of the drawing devices (141; 165) engages on the frame walls (131.2; 131.4) of the two rollers (102′; 103′) forming the relevant gap (104′) between one another.

42. The device according to claim 41, characterized in that the frame section (128.4) carrying the first roller (102′) of the second application unit (101′) is mounted so as to be variable in terms of the distance with respect to the second roller (103′) of the second application unit (103′).

43. The device according to claim 24, characterized in that a linear adjustment path is provided for the adjustment in the adjustment direction and/or a bearing mechanism (112; 112′; 113; 113′) formed by linear bearings (112; 112′; 113; 113′) is provided.

44. The device according to claim 24, characterized in that the second gap (107; 107′) between the counter-pressure roller (106; 106′; 103′; 103) and the second or the interposed further roller (103; 103′) of the first application unit (101; 101′) can be adjusted by at least one drawing device (141; 165) that is effective between these two rollers (103; 103′; 106) and comprises a drive means (132, 133) based on a force-based positioning drive (111; 111′), that is, can be set to a constant and/or defined contact or linear force, the two rollers (102; 103; 102′; 103′) being movable toward one another in the adjustment direction or being tensionable and being movable away from one another again or at least being relaxable again by the drawing device (141; 165).

45. The device according to claim 44, characterized in that the drawing device (141; 165), for the force-based adjustment of the second gap (107′), comprises a cylinder-piston system (133) that is adjustable in terms of the pressure as the drive means (133).

46. The device according to claim 24, characterized in that the first roller (102; 102′) of the same application unit (101; 101′) or a frame section (128.1; 128.2; 128.3; 128.4) carrying the first roller (102; 102′) is arranged with respect to the second roller (103; 103′) so as be pivoted or pivotable about a pivot axis(S) that extends perpendicular to the axis of rotation (R102; R103; R102; R103′) of the first and/or second rollers (102; 103; 102′; 103′) and/or intersects the axis of rotation (R102; R103; R102; R103′) of the first roller (102; 103; 102′; 103′) and/or of the second roller (102; 103; 102′; 103′).

47. The device according to claim 24, characterized in that, in each case between two adjacent rollers (102; 103; 102′; 103′), one or more drawing devices (141; 165) comprising a drive means (132; 133) engage, with the respective active ends thereof, on the adjacent rollers (102; 103; 102′; 103′) in such a way that a drawing force effectuating a relative movement between the rollers (102; 103; 102′; 103′) and/or a contact force between the rollers (102; 103; 102′; 103′) can be introduced by these between the two adjacent rollers (102; 103; 102′; 103′), that is, that the as drawing devices (141; 165) comprising the drive means (132; 133) pulls the two rollers (102; 103; 102′; 103′) toward one another for a throw-on.

48. The device according to claim 24, characterized in that each of the rollers (102; 103; 106) forming the respective gap (104; 107) between one another is mounted on both sides in frame walls (131.1; 131.2; 131.3; 131.4) of differing frame sections (128.1; 128.2; 128.3; 128.4), and that each of the drawing devices (141; 165) engages on the frame walls (131.1; 131.2; 131.3; 131.4) of the two rollers (102; 103; 106) forming the relevant gap (104; 107) between one another.

49. The device according to claim 34, characterized in that each of the frame sections (128.1; 128.2; 128.3; 128.4) comprises two frame walls (131.1; 131.2; 131.3; 131.4), which are rigidly, even though possibly detachably, connected to one another via one or more cross-connections (136; 137).

50. The device according to claim 34 characterized in that, in each case between two adjacent frame sections (128.1; 128.2; 128.3; 128.4), one or more drawing devices (141; 165) comprising a drive means (132; 133) engage, with the respective active ends thereof, on the adjacent frame sections (128.1; 128.2; 128.3; 128.4) in such a way that a drawing force effectuating a relative movement between the rollers (102; 103; 102′; 103′) or frame sections (128.1; 128.2; 128.3; 128.4) and/or a contact force between the rollers (102; 103; 102′; 103′) or frame sections (128.1; 128.2; 128.3; 128.4) can be introduced by these between the two adjacent frame sections (128.1; 128.2; 128.3; 128.4), that is, that the drawing devices (141; 165) comprising the drive means (132; 133) pulls the two rollers (102; 103; 102′; 103′) or frame sections (128.1; 128.2; 128.3; 128.4) toward one another for a throw-on.

51. The device according to claim 34, characterized in that the mutually adjacent frame sections (128.1; 128.2; 128.3; 128.4) arranged so as to be movable relative to one another can be moved toward one another in the adjustment direction and can be moved away from one another again or at least be relaxed again by at least one adjustment device (141; 165) that comprises a drive means (132; 132′; 133; 133′) and is designed as a drawing device (141; 165) on each frame side or by two or at least two drawing devices (141) on each frame side.

52. The device according to claim 34, characterized in that, on each of the two adjacent frame sections (128.1; 128.2; 128.3; 128.4) that can be varied in terms of the distance with respect to one another and/or in the contact force with respect to one another, the adjustment device (141; 165) engages with the two active ends thereof, the distance between which can be varied, on a respective one of the two frame sections (128.1; 128.2; 128.3; 128.4); and the same plane (G) extending perpendicular to the axis of rotation (R102; R103, R102′; R103′) of at least one of the rollers (102; 103; 102′; 103′; 106; 106′) mounted on the two adjacent frame sections (128.1; 128.2; 128.3; 128.4) intersects at least the respective effective support width (b151), viewed in the axial direction, of the rollers (102; 103; 102′; 103′; 106; 106′) mounted in the two frame sections (128.1; 128.2; 128.3; 128.4) and an engagement surface that is formed in the region of the active ends with the relevant respective frame section (128.1; 128.2; 128.3; 128.4).
